(19) United States
(12) Patent Application Publication
(10) Pub. No.: US 2026/0134291 A1
(43) Pub. Date: May 14, 2026

(54) SYSTEMS AND METHODS FOR ECO-SYSTEM AWARE RELATIONAL INTELLIGENCE WITH MATERIAL COMPONENTS-BASED BIAS SHAPING

(71) Applicant: Christine Meinders, Altadena, CA (US)

(72) Inventor: Christine Meinders, Altadena, CA (US)

(21) Appl. No.: 19/387,597

(22) Filed: Nov. 12, 2025

Related U.S. Application Data
(60) Provisional application No. 63/719,634, filed on Nov. 12, 2024.

(51) Int. Cl. G06N 3/096; G06F 9/50; G06F 11/3668; G06F 18/15; G06F 18/21; G06F 18/22; G06N 3/0495; G06N 5/022; H04L 9/00

(52) U.S. Cl. CPC G06N 3/096; G06F 9/5044; G06F 11/3684; G06F 18/15; G06F 18/217; G06F 18/22; G06N 3/0495; G06N 5/022; H04L 9/50

(57) ABSTRACT

Systems and methods for ecosystem aware relational intelligence with material components-based bias shaping in artificial intelligence systems are provided. The systems and methods identify biases arising from hardware implementations including sensor characteristics, computational architectures, and physical constraints. The approach detects hardware-specific biases through comparison with reference profiles, then applies targeted compensation strategies including sensor calibration, corrective transformations, and adaptive processing techniques. The system maintains comprehensive audit records of bias detection and mitigation operations, enabling verification of effectiveness across different hardware environments. This approach enables more consistent AI behavior across heterogeneous hardware implementations while addressing bias introduced by physical components and computational limitations.

### PRIORITY CLAIM AND CROSS-REFERENCE TO RELATED APPLICATIONS

The present application claims priority to U.S. Provisional Application No. 63/719,634, entitled “Systems and Methods for Responding to Bias in Artificial Intelligence Systems,” filed on Nov. 12, 2024 by inventor Christine Meinders, which is incorporated herein by reference.

The present application is also related to co-pending U.S. patent application Ser. No. 17/234,752, entitled “Tool for Designing Artificial Intelligence Systems,” filed on Apr. 19, 2021 by inventor Christine Meinders, co-pending U.S. patent application Ser. No. 16/382,016, entitled “Tool for Designing Artificial Intelligence Systems,” filed on Apr. 11, 2019 by inventor Christine Meinders, which claims priority to U.S. Provisional Application No. 62/656,278, entitled “Artificial Intelligent Design Tool,” filed on Apr. 11, 2018, by inventor Christine Meinders. These applications are incorporated herein by reference, and are not admitted to be prior art with respect to the present disclosure by their mention in the cross-reference section.

### TECHNICAL FIELD

The present disclosure relates generally to systems and methods for determining system behavior in AI systems.

### BACKGROUND

The following description includes information that may be useful in understanding the present disclosure. It is not an admission that any of the information provided herein is prior art or relevant to the presently claimed disclosure, or that any publication specifically or implicitly referenced is prior art.

Conventional artificial intelligence (AI) systems often suffer from severe biases in how the systems are constructed. The systems are trained on datasets, and the datasets can have inherent limitations in the data provided. For example, conventional face recognition software protocols might be trained on primarily Caucasian faces and have trouble recognizing other races. In another example, conventional voice recognition systems (often seen in smart assistants) were predominantly trained with primarily male voices. These limitations of the datasets training the AI systems correspond to the creation of systems that cannot adequately scale to a wide audience. Even if a user wanted to create a system which was exposed to a wider range of training data, conventional users typically lack the ability and resources to identify and use appropriate training data. Therefore, conventional AI systems become brittle when encountering more complicated, real world situations with unexpected circumstances. This is a detriment to the usage of an AI system as humans can adapt to these unexpected circumstances, but conventional AI systems struggle greatly with input that deviates from the standard input. These limitations of conventional datasets primarily go unidentified because AI systems are deployed without discussion of the data training the AI system. Sensors can also record biased data, publicly available datasets may reflect social and cultural biases, and training techniques may be colored by the preconceptions of their designers. Because of this, current AI models can be less effective or desirable for certain populations and tasks.

Current methods of mitigating bias in AI models first require identifying the bias and its source. This is often done by human overseers, who can only respond to bias retroactively. Human oversight also may not be accurate in many cases, may suffer from limited capacity, and may also be subject to the same biases present throughout society. Furthermore, mitigating the biases identified often requires the AI models to be retrained, which can be expensive and computationally intensive. Therefore, there is a need for systems and methods for responding to bias in AI models and implementing these responses efficiently.

Prior art systems are hardware-aware systems that have a single ecosystem consideration: hardware. The prior art systems do not consider, for example, biological systems, community values, economic constraints, software limitations, etc. One such system is TensorFlow Lite that optimizes for mobile hardware only. These traditional “Hardware-Aware” systems detect only hardware capabilities (CPU, GPU, memory). Another problem with these prior art systems is that when bias is detected, that bias is either eliminated or ignores.

### SUMMARY

There exist approaches to mitigating bias in AI systems that rely on human oversight and model retraining. Such approaches are expensive and require a lot of time, limiting flexibility and harm reduction. Described herein are systems and methods that respond to bias in AI systems in a more efficient and flexible way.

The systems, methods, and apparatuses disclosed herein address various categories of hardware induced bias through comprehensive detection and mitigation approaches.

Sensor-specific bias includes biases arising from inherent limitations of hardware sensors, such as microphones unable to record certain frequencies or cameras with spectral sensitivities that affect color reproduction. Computational architecture bias includes biases emerging from the processing capabilities and limitations of different hardware platforms, including memory constraints, processing power variations, and architecture-specific optimizations. Physical constraint bias includes biases introduced by physical limitations of devices, such as power consumption requirements, form factors, and environmental operating conditions. Cross-device consistency bias includes biases that emerge when AI systems must function across heterogeneous hardware environments with varying capabilities and characteristics.

The disclosed system implements a comprehensive framework that detects hardware induced biases through calibration procedures, comparative analysis, and hardware profiling. The systems and methods may then respond to the biases through targeted compensation mechanisms, adaptive processing techniques, and hardware-aware optimization strategies.

The various examples of the present disclosure are directed towards artificial intelligence methods for receiving and analyzing data. In a first embodiment of the present disclosure, a method provides for receiving input, at an interface on a computing device. The input includes a dataset, an analysis for the dataset, and an output medium. The method then provides for selecting, based on the received input, at least one algorithm from a plurality of algorithms. The method then provides for processing, via the computing device, the received input with the at least one algorithm to yield an output. The output is provided at the interface on the computing device.

In some examples, selecting at least one algorithm includes determining whether the received input corresponds to requirements associated with each algorithm in the plurality of algorithms. The method then provides for selecting algorithms of the plurality of algorithms, based on determining that the received input corresponds to requirements associated with the selected algorithms.

In some examples, the input includes a format for the output, a supplementary dataset, a type of the dataset, and/or input consideration variables.

In some examples, the at least one algorithm includes an artificial intelligence model. The artificial intelligence model can be selected from a plurality of artificial intelligence approaches, including: an artificial narrow intelligence approach, a non-symbolic artificial intelligence approach, a symbolic artificial intelligence approach, a hybrid symbolic and non-symbolic artificial intelligence approach, and a statistical artificial intelligence approach.

In some examples, the at least one algorithm includes a machine learning model. The machine learning model can be selected from a plurality of machine learning models, including: a decision tree, a Bayesian network, an artificial neural network, a support vector machine, a convolutional neural networks, and a capsule network. In some examples, the machine learning model was trained on the received input. In some examples, the machine learning model was trained, via the computing device, on a subset of a database of artificial intelligence systems. The subset can include artificial intelligence systems with datasets comprising metadata corresponding to metadata of the received dataset and/or the output medium. In some examples, the output includes an indication of whether the at least one algorithm successfully processed the received input.

In some examples, the method includes additional steps. The additional steps can provide for determining, via the computing device, whether the output comprises at least one bias in a plurality of biases. For example, the present disclosure identifies bias characteristics across multiple categories. Based on determining that the output comprises certain bias characteristics, the method provides for identifying a portion of the received input which corresponds to the determined bias characteristics. The method then provides for displaying the identified portion of the received input at the interface on the computing device.

In some examples, the method provides for shaping the identified bias characteristics by modifying the identified portion of the received input to yield updated input. The method then provides for retrieving, via the computing device, supplementary input data in a database of artificial intelligence systems. The supplementary input data corresponds to the identified portion of the received input and enables adjustment of the bias characteristics according to contextual requirements. The method then provides for displaying the supplementary input data at the interface on the computing device

In some examples, the second-output can be a revision of the first output.

In some examples, identifying the portion of the received input corresponding to the determined bias includes processing metadata associated with each of the received input. The metadata can include AI tagging (AI contextual attributes), or identification of biases in the plurality of biases corresponding to each of the received input.

In a second embodiment of the present disclosure, a method provides for receiving input, at an interface on a computing device. The input includes a dataset, an analysis for the dataset, an output medium, and/or a processed output. The processed output includes an artificial intelligence system based on the dataset, the analysis for the dataset, and the output medium. The method provides for determining, via the computing device, whether metadata associated with the received input comprises at least one bias in a plurality of biases. The method then provides for identifying a portion of the received input corresponding to the at least one bias. The method then provides for displaying, at the interface on the computing device, the identified portion and the at least one bias.

In some examples, the method provides for retrieving, via the computing device, supplementary input data from a database of artificial intelligence systems. The supplementary input data corresponds to the identified portion of the received input and does not comprise the at least one bias. The method then provides for displaying the supplementary input data at the interface on the computing device.

In some examples, the method provides for receiving a request, via the interface for the computing device, to process a second selection of input data. The second selection of input data includes the received input with the supplementary input data in place of the identified portion. The method then provides for processing, via the computing device, the second selection of input data to yield an output. The method then provides for displaying the output at the interface on the computing device.

A third embodiment of the present disclosure provides for a non-transitory computer-readable medium. The non-transitory computer-readable medium includes embedded computer-readable code. The code, when loaded on a computing device, causes the computing device to perform a series of steps. The steps include receiving input, at an interface on the computing device. The input includes a dataset, an analysis for the dataset, and/or an output medium. The steps then provide for selecting, based on the received input, at least one algorithm from a plurality of algorithms. The steps then provide for processing, via the computing device, the received input with the at least one algorithm to yield an output. The steps then provide for displaying the output at the interface on the computing device. In some examples, the steps provide for determining, via the computing device, whether the output comprises at least one bias in a plurality of biases. The steps then provide for identifying a portion of the received input corresponding to the determined bias, based on determining that the output comprises at least one bias. The steps then provide for displaying the identified portion of the received input at the interface on the computing device.

In some examples, the steps provide for removing the identified portion from the received input to yield updated input. The steps then provide for retrieving, via the computing device, supplementary input data in a database of artificial intelligence systems. The supplementary input data corresponds to the identified portion of the received input and does not comprise the at least one bias. The steps then provide for displaying the supplementary input data at the interface on the computing device.

In some examples, the steps provide for receiving a request, via the interface on the computing device, to process a second selection of input data. The second selection of input data includes the received input with the supplementary input data in place of the identified portion. The steps then provide for processing, via the computing device, the second selection of input data with the at least one algorithm to yield a second output. The second output is displayed at the interface on the computing device.

In some examples, identifying the portion of the received input corresponding to the determined bias further includes processing metadata associated with each of the received input. The metadata includes identification of biases in the plurality of biases corresponding to each of the received input.

Embodiments of the present disclosure are directed to an ecosystem-aware architecture. An ecosystem-aware architecture is a system that considers multiple simultaneous ecosystems (e.g., Hardware, Software, Agent, Community, Economic) with holistic optimization across all, determined by material components. As one example, a privacy frame affects Hardware (encryption), Software (UI), Agent (trust), Community (governance), and Economic (value). The ecosystem-aware architecture enables distribution anywhere: local, cloud, quantum, bio-inspired.

The hardware ecosystem includes physical computational resources, such as processors, memory, storage, sensors, network interfaces, and devices. As an example, the privacy frame may determine hardware encryption requirements, sensor permissions, and storage policies.

The software ecosystem includes, for example, code, algorithms, interfaces, APIs, protocols, data structures and the like. As an example, the privacy frame may shape the software ecosystem with minimal data collection UI, encrypted storage, audit logs.

The agent ecosystem includes entities that act and perceive, such as humans, AI systems, robots, biological organisms, environmental systems, and hybrid combinations. In one embodiment, the Agent ecosystem includes a user (human), an AI assistant (machine), and a smartphone (embodied).

The community ecosystem includes collective human organizations such as governance structures, shared values, social norms, cultural practices, democratic processes, and the like. As an example, the community ecosystem may vote on bias shaping (87% approval), governs frame policies, validates scanner findings.

The economic ecosystem includes value exchange, such as currency, compensation models, marketplaces, revenue distribution, economic incentives and the like. As an example, the economic ecosystem may include a community-determined revenue share (e.g., default 50% to contributors vs platform 100%).

Embodiments of the present disclosure are directed to living intelligence networks. Living intelligence networks include intelligence that is relational and adaptive. The living intelligence network may, in some embodiments, be modeled after biological systems (mycelial networks). For example, like mycelium sharing nutrients across forest, the system shares knowledge via signatures across community. In one embodiment, in the living intelligence network, the intelligence emerges from relationships between frames, as opposed to hierarchies. In one embodiment, the living intelligence network is a multi-agent network, including human, machine, and biological entities. The living intelligence network may evolve, grow, adapt, die, and/or regenerate continuously.

In some embodiments, the living intelligence network includes living modules, which are frames that act as interpretive containers carrying context, values, and meaning that can evolve. For example, the privacy frame may be a living module because it changes behavior based on context, learns from usage, evolves with regulations.

In some embodiments, the living intelligence network includes living patterns, which are recurring structures that emerge from and shape system behavior. These patterns are learned, not programmed and may evolve over time. As one example, a “consent-first” pattern may emerge from community practice and become a material component that shapes future interactions.

Embodiments of the present disclosure are also directed to bias characteristic shaping. Bias characteristic shaping is a methodology for revealing, shaping, and validating bias intentionally. In some embodiments, the tools used for bias characteristic shaping include a scanner (reveals patterns), a sculptor (enables shaping), and community (validates decisions). The scanner tool reveals existing patterns and bias characteristics in data, models, and systems. First step in bias characteristic shaping. For example, the scanner analyzes the model, reveals underrepresentation of rural communities, feeds the findings to the sculptor tool. The sculptor tool enables intentional shaping of bias characteristics based on the scanner tool findings and community decisions. For example, the community may decides to increase indigenous representation; the sculptor shapes the model accordingly. As another example, the scanner may reveal underrepresentation, and the sculptor may increase visibility, and the community may approve a change that is then applied by the system. In these embodiments, bias may be used as intentional design material as opposed to an error to eliminate.

Embodiments of the present disclosure are directed to frames and frame shifts. Frames may be used to apply perspectives and coordinate providing perspective. In some embodiments, frames are interpretive containers supporting diverse user-defined categories, including, for example, Material, Social, Functional, Technical, Guardrails, Biological, Epistemological, Temporal, Spatial, Economic, Affective, Security, Accessibility, and Creative frame types. The frames may include extensibility to enable communities to create additional categories as needed: material, social, functional, technical, guardrails, biological, epistemological, etc. The frames may be distributed across all ecosystems of the multi-ecosystem architecture. The frames may be used to generate guardrails and policies.

Frame shifts may be used to adapt frames based on ecosystem context. Frame shifts may be distributed, responsive transformation. As an example, a privacy frame may shift from “local only” to “cloud with encryption” when moving from edge to cloud ecosystem.

Embodiments of the present disclosure are directed to Embodied Knowledge Units (EKUs). EKUs are context-carrying knowledge artifacts that travel with data/content, maintaining provenance, metadata, consent status, and meaning as data moves through systems. As an example, research data may carry an EKU with: consent status, collection method, community approval, usage restrictions. EKUs are modular knowledge agents with multi-source integration that can be used to carry bias characteristics and enable distributed intelligence.

Embodiments of the present disclosure are directed to living signatures, which are compressed pattern representations (e.g., 100:1 ratio) that enable fast checking and transformation, used for identity, validation, pattern matching. As an example, a user values compressed 10 MB->100 KB signature validates privacy compliance without exposing full data. The fast checking uses material components-determined thresholds. Fast checking enables real-time bias detection and shaping. In some embodiments, the fast checking results in 50× speed improvement

Embodiments of the present disclosure are directed to living patterns, which are recurring structures that emerge from and shape system behavior. These patterns are learned as opposed to programmed and evolve over time. As an example, a “consent-first” pattern emerges from community practice, which becomes a material component, and then shapes future interactions. Living patterns are abstract, reusable solutions that generate new components, evolve through use and act as a template for system growth.

Embodiments of the present disclosure are directed to bidirectional components. The components generate and are generated by each other, resulting in a recursive, regenerative architecture that generates itself through use.

Embodiments of the present disclosure are directed to values and governance. Embodiments of the system use three-tier values (P/Q/T) including personal values (P-Tier), community/relational values (Q-Tier), and organizational/universal values (T-Tier). The P-Tier (Personal) includes individual values, personal preferences; the Q-Tier (Community/Relational) includes shared values, community norms; and, the T-Tier (Organizational/Universal) includes platform principles, constitutional values. In one embodiment, the values have hierarchical constraint. For example, T constrains Q which constrains P. The values may follow a configurable lifecycle (i.e., not fixed), continuously evolve through use, use community-governed evolution, and be entity-defined states (not platform-defined).

Embodiments of the present disclosure are directed to sympoietic governance. In sympoietic governance, the system is collectively-producing (PRIMARY governance model) with no single controller, emergent decision-making and a “making-with” philosophy. In embodiment, the system uses five living systems governance models: 1. Autopoietic (self-creating); 2. Sympoietic (collectively-producing) PRIMARY; 3. Participatory (ongoing involvement); 4. Distributed (decentralized); and, 5. Allopoietic (external value production). In one embodiment, the system architecture includes the following entity types: 1. Individual (humans); 2. Organization (companies, institutions); 3. Community (groups, collectives); 4. AI System (machine agents); and, 5. Biological (plants, animals, ecosystems). In one embodiment, the system includes the following four tracks: 1. CREATE: Making original contributions; 2.CONTRIBUTE: Responding to calls, filling gaps; 3. CULTIVATE: 7-dimensional growth (configurable); and 4. WONDER: Making meaning from mystery. In one embodiment, the system includes universal onboarding (5 Input Modalities): 1. Write (text input); 2. Upload (document upload); 3. Record (audio recording); 4. Extract (web extraction); 5. Speak (real-time voice). In embodiment, the system includes the following engagement mechanisms (call types): 1. Data Calls: Request data, generate frames; 2. Frame Calls: Request frameworks, collaborative creation; 3. Signature Calls: Request/validate patterns; and 4. Model Calls: Comprehensive partnerships.

Embodiments of the present disclosure are directed to living consent. In one embodiment, living consent is frame-based authorization (as opposed to project-by-project). Living consent is automatic consent enforcement. In one embodiment, the living consistent is a pre-consent data wallet. In one embodiment, there are multiple privacy tiers (e.g., anonymous, credited, community visible).

Embodiments of the present disclosure are directed to gap detection. Gap detection is universal across five dimensions: data, knowledge, frameworks, patterns, capacity. In some embodiments, gap detection is cross-scale detection (individual community organization AI biological). Gap detection may include temporal analysis (longitudinal tracking). Gap detection may also include multi-stakeholder perspectives.

Aspects of the disclosure relate to an ecosystem based approach to intelligent systems. In aspects of the disclosure, the ecosystems include: (1) Hardware; (2) Software, (3) Agent/Embodied, (4) Community, and (5) Economic. Any computing or intelligence system operates within these five dimensions. These five categories comprehensively capture possible system contexts.

The system's behavior is determined by material components rather than hardcoded parameters. Material components are data structures contributed by users, communities, and agents that define how the system processes information, makes decisions, and coordinates actions. Unlike conventional AI systems where developers hardcode parameters (e.g., privacy_weight=0.3), the disclosed system allows communities to control behavior through their contributions.

The five types of material components are: (1) Frames—interpretive containers that define how information should be understood in specific contexts; (2) Values—hierarchical priorities organized in P/Q/T tiers that determine decision-making; (3) Patterns—recurring structures detected from use that become templates for future matching; (4) Signatures compressed representations (100:1 ratio) that enable validation without exposing underlying data; and (5) Embodied Knowledge Units (EKUs)—portable knowledge structures containing content, context, consent, and provenance.

Material components determine system behavior across all five ecosystems. For example, when a user creates a “Privacy Frame” with P-tier (non-negotiable) priority, this material component determines: hardware encryption methods (hardware ecosystem), interface design choices (software ecosystem), opportunity filtering (agent ecosystem), validation requirements (community ecosystem), and compensation calculations (economic ecosystem). The same material component flows through all five ecosystems, creating coordinated behavior without requiring separate configuration in each ecosystem.

This approach inverts the conventional power structure. In prior art systems, platforms control behavior by modifying code. In the disclosed system, communities control behavior by contributing material components. The system adapts continuously as material components evolve, without requiring expensive retraining cycles or platform-pushed updates.

Advantages of the present disclosure include, for example, context-appropriate bias by design, the ability to work with any tools/systems/AI models, universal adapter pattern, material components that persist regardless of tools used, and consent is frame-based, not project-by-project. Another advantage is using bias as design material. One advantage is that the system is proactive—it identifies desired characteristics up front and can shape bias before deployment, not after. Another advantage is that community may be involved at the start of the design and not as a response to harm. By involving community, the community defines patterns, validates shaped characteristics, determines revenue share and has sovereignty over design decisions. Another advantage of the eco-system based approach is that there may be different bias characteristics for different ecosystems that can be effectively managed. For example, a healthcare community may have different patterns than a finance community. The system also allows local values to incorporate different patterns than global defaults.

The present disclosure refers to various machine learning or artificial intelligence algorithms or models. Any machine learning or artificial intelligence algorithm, as known in the art, can be used to perform various steps of the present disclosure, as would be readily apparent to one skilled in the art.

In some examples, the at least one algorithm (discussed above) is created from a learning algorithm. The present disclosure uses “algorithms” and “models” interchangeably. The disclosed tool allows users to define the type of artificial intelligence or artificial life they are designing within. Conventionally, users only design with artificial narrow intelligence and artificial life, but the present disclosure provide examples of artificial narrow intelligence and artificial super intelligence to reference additional approaches to AI. The AI tool also includes symbolic, non-symbolic and statistical systems.

The present disclosure refers to various systems and medium. Any system and/or output medium can be used by the disclosed AI tool, as would be readily contemplated by one skilled in the art.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The accompanying drawings exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows an exemplary methodology for creating an AI system, according to an embodiment of the present disclosure.

FIGS. 2A-2G demonstrate exemplary input selections for an AI interface, according to various embodiments of the present disclosure.

FIG. 3 shows an exemplary methodology for identifying a bias in a created AI system, according to an embodiment of the present disclosure.

FIG. 4 shows an exemplary methodology for identifying a bias in an externally created AI system, according to an embodiment of the present disclosure.

FIG. 5 shows an exemplary methodology for removing a bias in a created AI system, according to an embodiment of the present disclosure.

FIGS. 6A-6B show an exemplary methodology for a user to build an AI system, according to an embodiment of the present disclosure.

FIG. 7 shows an exemplary system for building and/or evaluating an AI system, according to an embodiment of the present disclosure.

FIG. 8 shows an exemplary comparison of how AI data specific to one medium is used in a variety of mediums, according to an embodiment of the present disclosure.

FIGS. 9A-9C show exemplary input selections in an AI interface, according to an embodiment of the present disclosure.

FIG. 10 illustrates a conceptual map of a collaborative software tool, according to an embodiment of the present disclosure.

FIG. 11 illustrates fundaments of the collaborative software tool in use, according to an embodiment of the present disclosure.

FIG. 12 illustrates a process of designing social technologies using the tool, according to an embodiment of the present disclosure.

FIG. 13 illustrates a system map, according to an embodiment of the present disclosure.

FIG. 14 illustrates an exemplary project representation, according to an embodiment of the present disclosure.

FIG. 15 illustrates an exemplary user interface screen of the login page, according to an embodiment of the present disclosure.

FIG. 16 illustrates an exemplary user interface of a section where users can select whether to remake (transform), create (encode), deconstruct (decode) or contribute to a social technology project, according to an embodiment of the present disclosure.

FIG. 17 illustrates an exemplary user interface where the project creator is asked if they will enter as an individual or as a group, according to an embodiment of the present disclosure.

FIG. 18 illustrates an exemplary user interface illustrating a discover section of the tool, according to an embodiment of the present disclosure.

FIG. 19 is an exemplary user interface section of the tool where the user or group identifies the intended audience of the project, according to an embodiment of the present disclosure.

FIG. 20A illustrates an exemplary screen shot relating to the frames section of the tool showing aspects of frames, traces and consent, according to an embodiment of the present disclosure.

FIG. 20B illustrates an exemplary screen shot relating to the frames section of the tool, according to an embodiment of the present disclosure.

FIG. 20C illustrates an exemplary screen shot relating to the frames section of the tool and aspects of flagging and rating, according to an embodiment of the present disclosure.

FIG. 20D illustrates an exemplary screen shot relating to the frames section of the tool and aspects of content, according to an embodiment of the present disclosure.

FIG. 20E and F illustrate exemplary screen shots relating to the frames section of the tool, according to an embodiment of the present disclosure.

FIGS. 20G-20M illustrates exemplary screen shots relating to the frames section of the tool, according to an embodiment of the present disclosure.

FIGS. 21A-H illustrate exemplary user interfaces relating to the blueprint section, according to embodiments of the present disclosure.

FIG. 22 illustrates an exemplary use of the tool to shift an existing frame or recommend a new frame, according to an embodiment of the present disclosure.

FIGS. 23A and 23B illustrate an example of the scaffolding section of the tool, according to embodiments of the present disclosure.

FIGS. 24A-F are exemplary user interfaces relating to the data implementation section of the tool, according to embodiments of the present disclosure.

FIGS. 24G-J are exemplary user interfaces relating to the model implementation section of the tool, according to embodiments of the present disclosure.

FIG. 25 illustrates an example of the activation (testing) section of the tool, according to an embodiment of the present disclosure.

FIGS. 26A-E illustrate alternative variations of the audit section of the tool, according to embodiments of the present disclosure.

FIGS. 27A-D are exemplary user interfaces that illustrate a project page with data collection sections, frame collection sections and voting sections, according to embodiments of the present disclosure.

FIG. 28 is an exemplary user interface that illustrates card selection states within the tool, according to an embodiment of the present disclosure.

FIG. 29 illustrates an example of adding an image or other content to a blank or new card, according to an embodiment of the present disclosure.

FIG. 30 is a block diagram of the interrelation between concepts used in the system, according to an embodiment of the present disclosure.

FIG. 31 is a flow diagram showing bias characteristic shaping, according to an embodiment of the present disclosure.

FIG. 32 is a flow diagram showing an auditing and verification process, according to an embodiment of the present disclosure.

FIG. 33 is a flow diagram showing hardware-specific bias characteristic shaping, according to an embodiment of the present disclosure.

FIG. 34 is a block diagram showing bias detection and adjustment, according to an embodiment of the present disclosure.

FIG. 35 is a schematic diagram showing AI tagging, according to an embodiment of the present disclosure.

FIG. 36 is a schematic diagram showing exemplary system domains, according to an embodiment of the present disclosure.

FIG. 37 is a schematic diagram showing exemplary system inputs, according to an embodiment of the present disclosure.

FIG. 38 is a block diagram of interrelations between concepts used in the system, according to an embodiment of the present disclosure

FIG. 39 is a block diagram of a material components hub of the system, according to an embodiment of the present disclosure.

FIG. 40 is a block diagram of a discovery process of the system, according to an embodiment of the present disclosure.

FIG. 41 is a block diagram of an adaptive assembly framework, according to an embodiment of the present disclosure.

FIG. 42 is a block diagram of a holistic optimization engine, according to an embodiment of the present disclosure.

FIG. 43 is a block diagram of a cross-ecosystem coordination framework in an example healthcare setting, according to an embodiment of the present disclosure.

### DETAILED DESCRIPTION

Various embodiments of the present disclosure will now be described. The following description provides specific details for a thorough understanding and enabling description of these examples. One skilled in the relevant art will understand, however, that the embodiments may be practiced without many of these details. Likewise, one skilled in the relevant art will also understand that the embodiments can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description section.

While this specification contains many specific implementation details, these should not be construed as limitations on the scope of any embodiments or of what may be claimed, but rather as descriptions of features specific to particular implementations of particular embodiments. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

AI systems, interfaces and experiences are becoming a foundational part of the re-search, design and development of products and experiences. The technical requirements of AI thinking can be challenging for those without programming experience. Therefore, the present disclosure provides an AI design tool for individuals to understand and engage in, not only the user experience of AI, but design for the systems and culture of AI. Additionally, this tool will use a deep learning architecture to find relationships from user-uploaded data.

The disclosed design tool provides a place for AI design thinking and creation that helps design teams, researchers, and developers start to make a space for inclusive AI design thinking. Accordingly, one embodiment of the present disclosure provides for an electronic tool for standardizing the AI design process; this tool helps users understand the different types and technical inputs for designing AI (algorithms, systems, agents, projects, experiences) and stresses the importance of culture and assumptions embedded in the design process.

This AI Design Tool helps designers, researchers, and developers build AI systems from technical and conceptual perspectives. The exemplary AI design tool provides for at least three modes, including (1) a design/prototyping mode, (2) a cultural probe mode, and (3) a playful exploration mode. The design/prototyping mode provides a technically accurate design, while still incorporating prompts for culture, bias and transparency. Some examples of the design/prototyping mode provide for localization and varying levels of connectivity, according to user preferences. The cultural probe mode looks at the cultural and social considerations/biases in AI systems that were already created (either by the AI design tool or by another, external system). The cultural probe mode therefore helps researchers identify bias characteristics in an existing system, shape those bias characteristics to better serve specific communities, and design further AI systems for transparency and opportunities for localization. The playful exploration mode allows users to build a new AI system that is primarily for learning purposes and does not need to include technically-perfect constructs.

Therefore, the disclosed AI design tool provides a variety of benefits to overcome the limitations of conventional AI systems. For example, the disclosed AI design tool can be used by users to learn about AI systems generally. In another example, the tool can identify and correct problematic assumption implicit in conventional AI products. In another example, the tool can provide ease of access to construct new AI systems without the biases of conventional systems.

The systems, methods, and apparatuses disclosed herein are generally grouped into four categories: 1) system architecture; 2) hardware-induced bias detection; 3) hardware-specific bias response; and 4) system auditing. Though the categories are discussed individually, it should be noted that systems and methods from one category can be combined, or used in concert with, those in other categories.

A system for responding to bias in an artificial intelligence (AI) model comprises storage storing an intermediate representation of the trained AI model, memory storing instructions, and one or more processors configured to execute the instructions and perform operations. The storage, memory, and one or more processors can be disposed within the same device, or they can be disposed on multiple devices connected by a wired or wireless network. For example, the trained AI model may be stored on storage coupled to a device that is connected to the cloud, and the one or more processors and the memory could be coupled to the storage via this cloud network.

The intermediate representation of the trained AI model is a representation of source code, weights, and other aspects of the trained AI model that comprises data structures, microcode, or other executable artifacts created by a compiler, interpreter, or virtual machine. The source code can be written in any form of programming language, including compiled or interpreted languages, declarative or procedural languages, and it can be deployed in any form, including as a standalone program or as a module, component, subroutine, object, or other unit suitable for use in a computing environment.

In some examples, the AI model includes an artificial intelligence model. The artificial intelligence model can be selected from a plurality of artificial intelligence approaches, including: an artificial narrow intelligence approach, a non-symbolic artificial intelligence approach, a symbolic artificial intelligence approach, a hybrid symbolic and non-symbolic artificial intelligence approach, and a statistical artificial intelligence approach.

In some examples, the AI model includes a machine learning model. The machine learning model can be selected from a plurality of machine learning models, including: a decision tree, a Bayesian network, an artificial neural network, a support vector machine, a convolutional neural networks, and a capsule network. In some examples, the machine learning model was trained on the received input. In some examples, the machine learning model was trained, via the computing device, on a subset of a database of artificial intelligence systems. The subset can include artificial intelligence systems with datasets comprising metadata corresponding to metadata of the received dataset and/or the output medium.

The one or more processors include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory can be supplemented by, or incorporated in, special purpose logic circuitry. Other examples of processors include AI hardware devices, such as tensor processing units (TPUs), neural processing units (NPUs), and AI-oriented application specific integrated circuits (ASICs).

The system implements a comprehensive framework for detecting biases that emerge from hardware implementations of artificial intelligence systems. This framework addresses biases arising from sensor characteristics, computational architectures, and physical constraints through multiple detection mechanisms.

Bias can be present in various portions of a trained AI model. A dataset can contain biased information, training methods can be biased, and outputs can be biased, depending on the configuration of the trained AI model. Other types and sources of bias are also possible. Detecting these biases may include using an AI system to identify these biases in a dataset used to train the trained AI model. For example, the AI system may receive input data representing the data used to train the trained AI data. This input data may be the dataset itself, or it may include metadata associated with the dataset. The metadata can include AI tagging (AI contextual attributes), frames/EKUs or Embodied Knowledge Units (EKUs) representing a framing of the AI dataset, and/or indications of bias previously detected or notated in the dataset. The dataset may also have been annotated by human overseers as containing bias.

The system can detect biases introduced by hardware sensors through specialized analysis modules that evaluate sensor characteristics against reference profiles and identify potential sources of bias. The system may associate one or more bias characteristics with the identified bias. The bias characteristics can be data that indicate a type of bias, qualities of the bias, severity of the bias, or other information associated with the identified bias. The bias characteristics can also be identifier data that indicate specific biases identified by the system. Bias characteristics can be used by any part of the system to manipulate and shape biases present in the AI system.

The system may implement a hardware bias detector that can analyze data associated with hardware devices in one or more computing systems. The hardware bias detector can receive the specifications and other metadata of connected hardware devices to build reference profiles for each device. Based on these reference profiles, the expected values and thresholds of data associated with these devices and sensors can be generated.

The system can also combine this analysis with a hardware capability assessment that determines the capabilities of devices and sensors connected to the system. For example, the processing power, memory capacity, sensor constraints, and power constraints of connected devices can be found. Other capability assessments can also be performed by the system.

The system can perform a hardware-software interaction analysis. This analysis finds how hardware and software components interact to identify potential sources of bias, including how intermediate representations are compiled and optimized for specific hardware.

Based on these data and hardware assessment, the AI system may determine the presence of bias in the dataset. Bias can include cultural, social, racial, or other prejudicial biases. Bias may also include non-societal forms of bias, such as poor data quality. Bias can also include bias introduced by hardware limitations and computational architecture. For example, biased skin-tone measurements introduced by the limited spectrum captured by a camera device can be identified. Identified bias can be detected preemptively, prior to deployment of the trained AI model. This allows for the creation of an adaptable, context-aware model before bias can affect the output of the trained AI model.

The AI system can further pinpoint and display specific portions of data that contribute to identified bias, allowing for a transparent assessment of bias sources. These portions of data can be portions of the dataset, sources of biased data, or specific data points. This direct identification of biased portions in the dataset allows for targeted responses to bias, ensuring that only relevant data is adjusted, enhancing computational efficiency. These biased portions can be annotated for easy identification by the system, and they can be displayed for identification by a user or human overseer of the system.

In some embodiments of the present disclosure, the system can also identify sources of bias in the intermediate representation of the trained AI model. This may be done through the analysis of an AI system trained to detect bias in the intermediate representation of an AI model. This AI system can be trained on publicly available codebases, on previous versions of the trained AI model, or on other data representative of bias that can be identified in the intermediate representations of AI models. The AI system can also identify bias in the intermediate representation by comparing the output of the trained AI model to data about the intermediate representation.

Like the process described above, the AI system can also identify portions of the intermediate representation that contribute to bias. These portions can be specific portions of compiled code, bytecode, virtual machine code, function calls, or other aspects of the intermediate representation. These identified portions can be annotated or otherwise notated for the system, and they can be displayed for a user or human overseers.

In another embodiment of the present disclosure, the system can identify sources of bias in the output of the trained AI model. This may be done through the analysis of an AI system trained to identify bias in the output of an AI model. The AI system can be trained with datasets containing examples of AI bias in outputs, prior outputs of the trained AI model, and/or data representing the expected unbiased results of the trained AI model.

Also, similarly to above, the AI system can identify portions of the output of the AI model that contain or contribute to bias. These portions can be outputted data, numerical values, code, generated text, or other output from the trained AI model.

In some embodiments of the present disclosure, the AI system may be configured to identify bias through a combination of the methods described above, and bias may be identified as coming from any combination of the input, intermediate representation, and output of the trained AI model.

In some embodiments of the present disclosure, the system is “Ecosystem-Aware.” Ecosystem-aware means the system detects, responds to, and optimizes across multiple ecosystems types simultaneously, enabling holistic system behavior that adapts to complete context rather than isolated dimensions. In an ecosystem aware system, the system considers hardware (edge device), software (OS constraints), agent (user context), community (group norms), economic (cost constraints), all at once. It provides complete context awareness. In one specific example, it can be used with biological systems. These traditional systems make optimization decisions based on incomplete context. A model might be optimized for hardware performance but violate community values or exceed economic constraints. An ecosystem-aware architecture, on the other hand, ensures all relevant contexts are considered simultaneously.

In some embodiments, the ecosystem aware system includes five ecosystem types. These ecosystems may be fixed components of the architecture (cannot be changed). The five ecosystems include hardware, software, agent, community and economic ecosystems.

The hardware ecosystem is directed to physical computing infrastructure from edge devices to quantum systems. Examples of physical computing infrastructure include IoT devices, smartphones, embedded systems (e.g., Jetson Nano at CVS), laptops, servers, on-premise data centers, cloud (e.g., AWS, GCP, Azure distributed computing), quantum processors, quantum-classical hybrid systems, neuromorphic computing, DNA computing, biological processors, and the like. Examples of features that may be detected by the system include hardware capabilities (CPU, GPU, TPU, QPU), memory and storage capacity, network connectivity and bandwidth, power constraints and thermal limits, physical location and distribution, and the like. Optimization considerations may include computational efficiency, energy consumption, response latency, reliability and fault tolerance, and cost per computation.

The software ecosystem includes operating systems, frameworks, APIs, and software platforms that enable system functionality. Exemplary operating systems include Linux, Windows, macOS, iOS, Android; exemplary frameworks include TensorFlow, PyTorch, React, Node. js, exemplary APIs include RESTful, GraphQL, WebSocket, gRPC. The software ecosystem may consider interoperability, such as cross-platform compatibility, standard protocols. The software ecosystem may also consider open source (e.g., community-maintained libraries and tools). Exemplary features that may be detected in the software ecosystem include the available software stack, framework versions and compatibility, API accessibility and rate limits, license constraints, and update frequency and stability. Optimization considerations in the software ecosystem include, for example, compatibility across platforms, development velocity, maintenance burden, security and privacy features, and vendor lock-in avoidance.

The Agent/Embodied ecosystem includes entities that act, perceive, and embody intelligence-human, machine, biological, environmental, and hybrid. The agent/embodied ecosystem includes, for example, humans (e.g., individual users, community members, researchers), machine (e.g., AI systems, robots, autonomous agents), biological (e.g., plants, animals, microorganisms, ecosystems), environmental (e.g., natural systems such as forests, watersheds, climate patterns) and hybrids (e.g., human-AI collaboration, cyborg systems, human-nature partnerships). Exemplary features detected in the agent/embodied ecosystem include entity type and capabilities, available input/output modalities, cognitive/processing constraints, physical embodiment characteristics, and environmental embedding. Exemplary optimization considerations in the agent/embodied ecosystem include accessibility for all entity types, multi-modal interaction design, cognitive load management, physical capability matching, and cross-species communication.

The community ecosystem includes values, governance structures, knowledge systems, and ways of knowing that shape collective behavior. The values are, for example, shared principles, ethical frameworks, community norms; the knowledge systems are, for example, epistemologies, ways of knowing, wisdom traditions; governance structures are, for example, decision-making structures, authority patterns, coordination mechanisms; ways of knowing are, for example, scientific, indigenous, experiential, spiritual, artistic; cultural contexts are, for example, language, symbolism, meaning-making practices. Exemplary features detected by the community system include community value frameworks (P/Q/T tiers), governance models in use, cultural lens requirements, epistemological diversity, and knowledge validation methods. Exemplary optimization characteristics in the community ecosystem include value alignment across scales, cultural sensitivity and appropriateness, multiple epistemologies respected, democratic participation enabled, and community sovereignty preserved.

The economic ecosystem includes value creation, compensation systems, resource distribution, and economic models. Compensation includes, for example, cash, gift cards, tokens, equity, attribution; value distribution includes, for example, revenue sharing, royalties, ownership; community benefit includes, for example, collective value capture, commons management; resource allocation includes, for example, computational cost, human time, attention; economic models include, for example, marketplace, commons, gift economy, hybrid. Exemplary features detected by the economic ecosystem include available compensation methods, cost constraints and budgets, revenue sharing requirements, resource scarcity and abundance, and economic fairness criteria. Exemplary optimization considerations include fair compensation for contributions, sustainable economic models, community benefit maximization, resource efficiency, and economic transparency.

The ecosystem-aware architecture may work using a combination of tools including a discovery protocol, adaptive assembly, holistic optimization, and cross-ecosystem coordination. The discovery protocol is a system process for detecting available ecosystems and their capabilities. The adaptive assembly is a system process for distributing components appropriately across discovered eco systems. Holistic optimization is a system optimization across all ecosystems simultaneously, not in silos. The system can track optimization quality across all ecosystems. Cross-ecosystem coordination are system mechanisms for coordinating behavior across ecosystem boundaries, including bias characteristic shaping. Coordination mechanisms include 1. Frame Shifts (Primary Coordination Mechanism); 2. Living Intelligence Networks; and, 3. Bidirectional Signatures. Cross-ecosystem bias shaping is able to work across all ecosystems simultaneously.

By considering multiple ecosystems simultaneously, significant advantages are achieved. For example, biological systems can be included as full participants. Traditional hardware-aware systems cannot include biological entities. Ecosystem-aware architecture enables plants, animals, and ecosystems to participate. As another example, community values can be central to decisions. As another example, economic sustainability is required for designs. As another example, software interoperability is prioritized. Another advantage is complete context awareness: system makes better decisions because it considers complete context. Another advantage is true distributed systems: can distribute across radically different environments.

The disclosed system implements ecosystem-aware architecture that recognizes, adapts to, and simultaneously optimizes across five distinct ecosystem types: hardware, software, agent, community, and economic. This capability represents a fundamental advancement over prior art systems that address at most two ecosystem types (typically hardware and software deployment environments).
Hardware Ecosystem: Physical devices and sensors including mobile devices, edge computing systems, payment kiosks, wearables, IoT sensors, bio-inspired hardware systems, and quantum-classical hybrid systems. The system detects hardware capabilities and constraints (power, bandwidth, memory, processing capacity) and adapts component deployment accordingly. Material components determine hardware-level decisions such as encryption methods, data routing, and resource allocation.
Software Ecosystem: Cloud services, on-premise systems, microservices, APIs, and distributed computing environments. The system coordinates across heterogeneous software platforms, providing cross-platform compatibility layers and material components-determined optimization strategies. Software ecosystem recognition enables deployment across diverse platforms (web, mobile, desktop, embedded) with consistent behavior.
Agent Ecosystem: Individual humans, AI agents (including multi-model orchestration), organizational entities, community collectives, and biological entities capable of cross-species communication. The system recognizes that different agent types have unique frames, values, patterns, and signatures. Material components determine agent interaction protocols, coordination mechanisms, and authority structures. This ecosystem recognition enables the system to adapt behavior based on who is participating, not just what hardware or software is involved.
Community Ecosystem: Governance structures, collaborative creation frameworks, distributed authorship systems, validation mechanisms, and equity-weighted decision-making protocols.

The system implements sympoietic (collectively-producing) governance where communities control system evolution through democratic validation (e.g., 87% approval thresholds).

Material components determine governance protocols, decision-making processes, and validation requirements. Community ecosystem recognition enables collective control over system behavior rather than platform-imposed rules.
Economic Ecosystem: Revenue sharing models (with community-determined default rates such as 70% community share), multi-modal compensation systems (compensating for data, frames, patterns, and signatures), contribution-based value distribution, economic transparency mechanisms, and token economy integration. Material components determine compensation rates, value calculations, and distribution formulas. Economic ecosystem recognition enables fair value distribution based on contributions rather than platform-imposed fees.

Prior art AI systems operate within the hardware ecosystem (choosing deployment hardware) and software ecosystem (executing within software platforms) but do not recognize agent diversity, community governance structures, or economic relationships. Conventional systems treat all users identically (no agent ecosystem recognition), provide no governance mechanisms (no community ecosystem), and impose fixed platform fees (no economic ecosystem).

The disclosed system's simultaneous recognition of and optimization across all ecosystems enables capabilities impossible in prior art, including: agent-specific adaptation, community-controlled governance, fair economic distribution, holistic optimization considering hardware constraints AND community values AND economic fairness simultaneously, and coordinated evolution across all ecosystem types through material components-determined behavior.

Now that the five ecosystem types have been introduced, we explain in detail how material components determine system behavior across these ecosystems. This mechanism is central to the disclosed invention and distinguishes it fundamentally from prior art approaches using hardcoded parameters.

Material components control bias characteristics by defining the interpretive framework through which the system processes information. When a community contributes a “Patient Safety Frame” with specific priorities, this material component shapes how the system weighs competing considerations, filters opportunities, and makes recommendations. The bias characteristics emerge from the material components themselves rather than being hardcoded by developers.

For example, a hospital's “Patient Safety Frame” might prioritize: (1) minimizing risk of adverse events (P-tier), (2) respecting patient autonomy (Q-tier), and (3) optimizing resource efficiency (T-tier). These priorities, expressed as material components, determine how the system behaves when matching research opportunities with patients. The system is intentionally biased toward patient safety (P-tier priority) while remaining flexible on resource efficiency (T-tier). This bias is transparent, intentional, and community-controlled.

In contrast, prior art systems would hardcode: ‘safety_weight=0.8, autonomy_weight=0.6, efficiency_weight=0.3’. These parameters are invisible to users, cannot be adjusted by communities, and require platform updates to change. The disclosed system's material components approach enables communities to control bias characteristics through their contributions rather than requesting feature changes from platforms.

Material components determine behavior in hardware and software ecosystems through environment-specific adaptation. In the hardware ecosystem, a “Privacy Frame” with P-tier priority determines: encryption method selection (AES-256 required, not optional), data routing decisions (local processing preferred over cloud), memory allocation (secure enclaves required), and communication protocols (TLS 1.3 minimum). The same Privacy Frame determines software ecosystem behavior: UI design (consent controls prominent), feature availability (tracking disabled by default), API access (authentication required), and data persistence (automatic expiration).

The material component (Privacy Frame) flows through both ecosystems, creating coordinated behavior. Prior art systems would require separate configuration: hardware settings AND software settings, managed independently. The disclosed system achieves coordination through material components that determine behavior across ecosystem boundaries.

In the agent ecosystem, material components enable agent-specific adaptation. An individual user's “Research Frame” (Q-tier) permits research data sharing with compensation, while an Indigenous community's “Cultural Protocols Frame” (P-tier) prohibits certain research applications entirely. The system recognizes these different agent types and their material components, adapting behavior accordingly. The same research opportunity that appears to individual users (Research Frame allows) never appears to community members (Cultural Protocols Frame blocks).

In the community ecosystem, material components determine governance protocols. A research community's “Methodological Rigor Frame” sets validation thresholds (87% peer approval required), review processes (blind review), and appeal mechanisms. These governance material components determine how the community collectively controls system behavior. Prior art systems impose platform-wide rules; the disclosed system enables community-specific governance through material components.

Material components determine economic behavior through contribution-based value calculation. When a user contributes a “Synchronicity Frame” that enables pattern detection benefiting medical research, this material component determines: (1) data contribution compensation ($50 for raw data), (2) frame intelligence compensation ($20 for frame that enabled analysis), and (3) pattern contribution compensation (share of research value created). The economic value flows from the material component's contribution, not from platform-imposed fees.

Economic ecosystem material components enable community-determined rates. The default 70% community/30% platform split is itself a material component that communities can vote to adjust (e.g., 80/20 for certain research applications, 60/40 for commercial uses). Prior art systems impose fixed platform fees (Apple's 30% is non-negotiable); the disclosed system enables economic sovereignty through material components.

Material components enable community sovereignty by inverting the power structure. In prior art systems, users request features from platforms. In the disclosed system, communities control behavior by contributing material components. When a community wants AI biased toward environmental sustainability, they contribute “Sustainability Frames” that determine system behavior. The platform doesn't need to modify code; the material components themselves determine behavior.

This inversion is fundamental. Platform power comes from controlling code; community power comes from controlling material components. As material components accumulate, community control strengthens. The system becomes increasingly shaped by community values rather than platform decisions.

Prior art systems use hardcoded parameters set by developers: ‘privacy_weight=0.3’, ‘threshold=0.75’. These parameters are: (1) invisible to users, (2) unchangeable by communities, (3) require platform updates to modify, (4) same for all users, and (5) controlled entirely by platform.

The disclosed system's material components are: (1) visible and transparent, (2) contributed and controlled by communities, (3) evolve continuously without platform updates, (4) unique to each user/community, and (5) controlled by those who contribute them. This constitutes a fundamental architectural difference, not an incremental improvement. The paradigm shifts from platform control to community sovereignty.

The system may also utilize frames/EKUs/EKUs to help categorize and identify hardware-induced bias. Frames/EKUs/EKUs can be applied to the AI system holistically or in-part. The frames/EKUs may represent current thinking about a technology or social subject from a certain perspective. They may also represent shifts in the way that the technology or parts of the technology are seen or understood. EKUs are containers that may function bidirectionally with frames/EKUs and identified bias characteristics. For example, EKUs may become frames/EKUs, become a part of frames/EKUs, or may generate frames/EKUs themselves. They serve as a broader concept encompassing frames/EKUs, and may represent a thinking or perspective on any subject from any perspective. EKUs may be generated by bias characteristics detected in the artificial intelligence model, or they may generate bias characteristics themselves. EKUs may also be modified and configured by bias characteristics. In some example embodiments, frames/EKUs may generate EKUs. Frames/EKUs/EKUs can also represent the views of developers or users of the AI system about a technological or social subject. A frame/EKU can therefore represent a plurality of biases present in the system, AI system, or hardware associated with the system. Frames/EKUs/EKUs can be added or taken away from the AI system, portions of the system, or the hardware devices.

Frames/EKUs/EKUs may include data indicative of social views about technologies and social subjects. Frames/EKUs/EKUs may also include information related to social views of hardware and hardware limitations.

By analyzing the frames/EKUs/EKUs in conjunction with other data, the system can identify hardware-induced bias. The system may also use the frames/EKUs/EKUs to categorize the identified bias and the bias response.

The relational intelligence architecture disclosed herein operates as a living intelligence system, wherein intelligence emerges from dynamic relationships between entities rather than from individual components alone. Similar to biological living systems such as mycelial networks, where intelligence emerges from the network of relationships between fungal threads, the disclosed system generates adaptive intelligence through the relationships between entities across biological, technological, and social domains. This living intelligence architecture distinguishes from conventional static AI systems where intelligence is fixed within pre-programmed models.

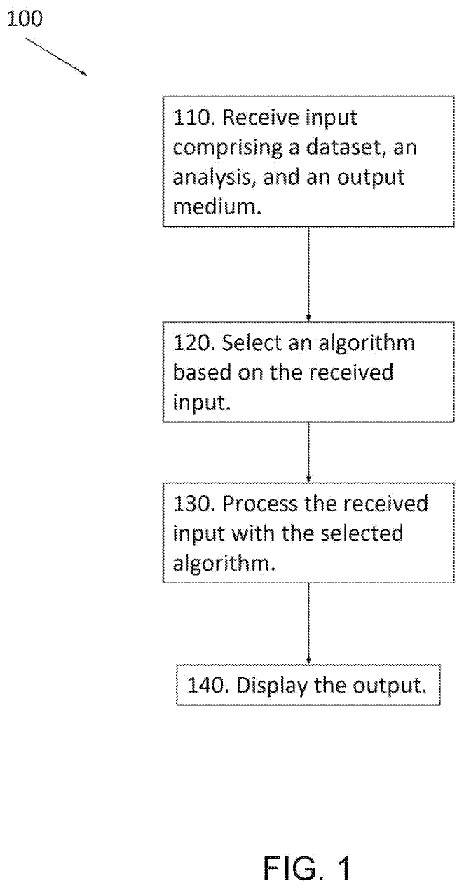

FIG. 1 shows a methodology 100 for creating an AI system using the disclosed AI design tool. The disclosed AI tool (in any embodiment of the present disclosure) can be an artificial intelligence tool or a computing device configured to perform artificial intelligence. In some embodiments, the AI design tool may utilize adaptive assembly to create an AI system.

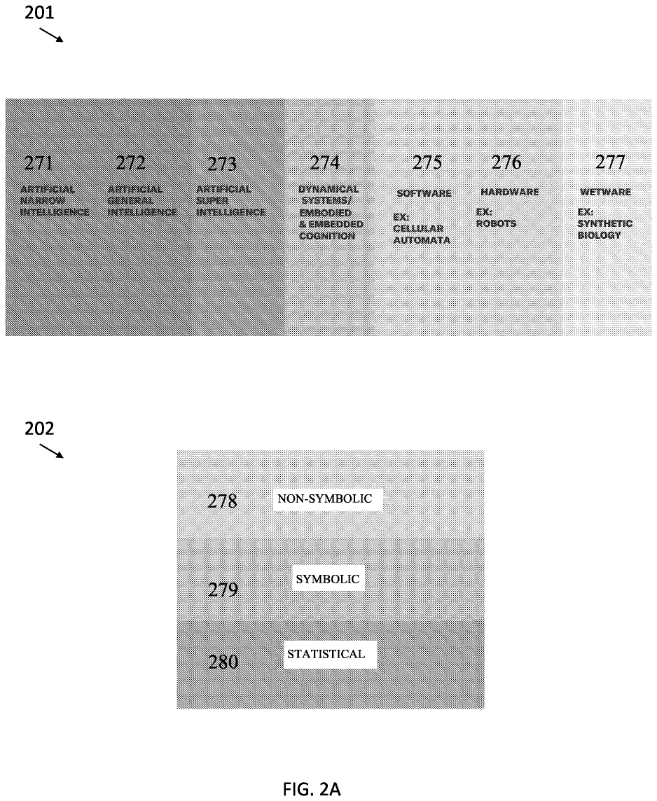

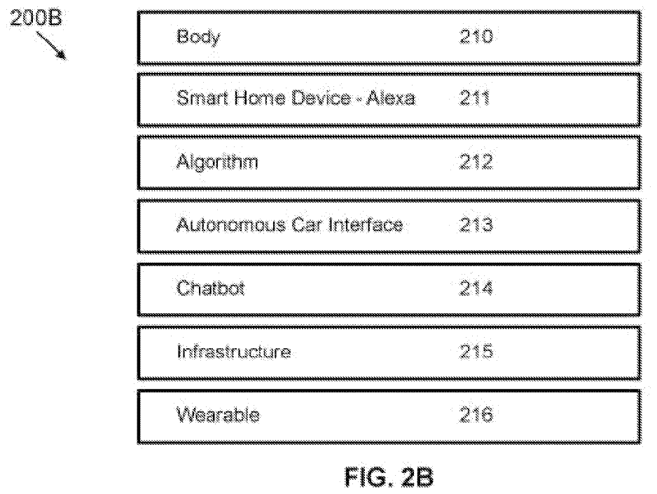

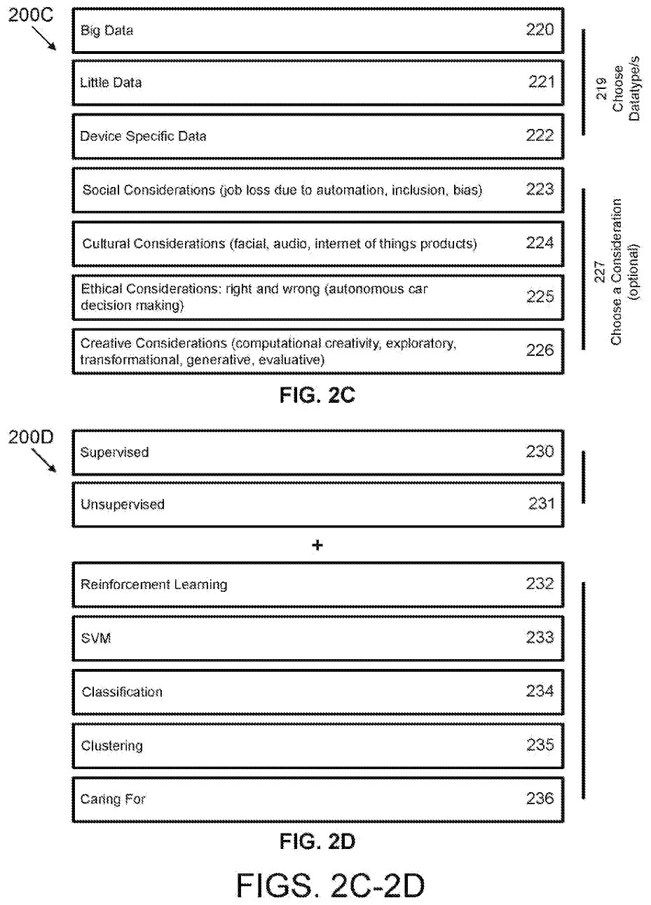

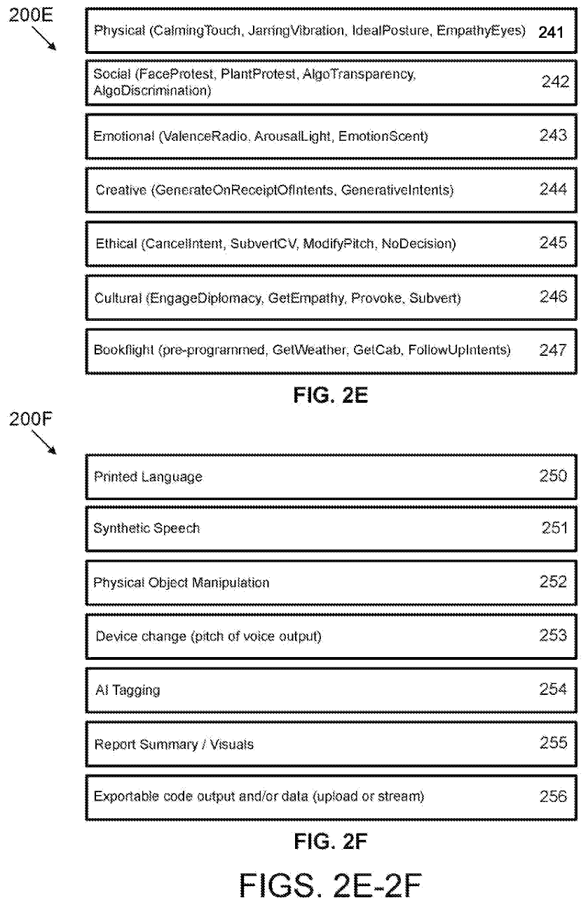

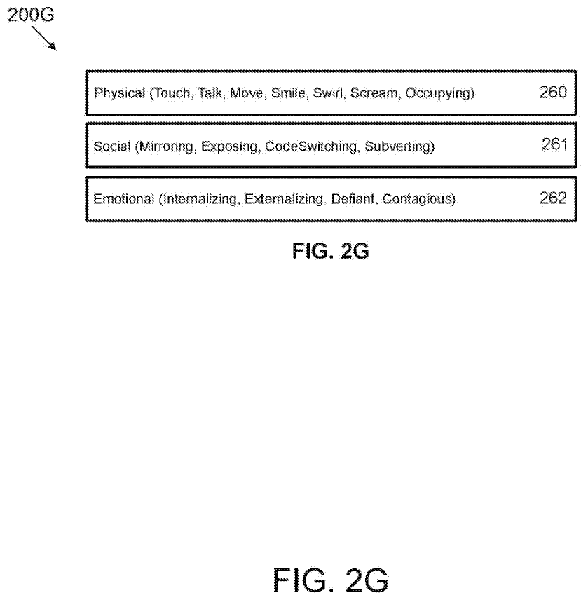

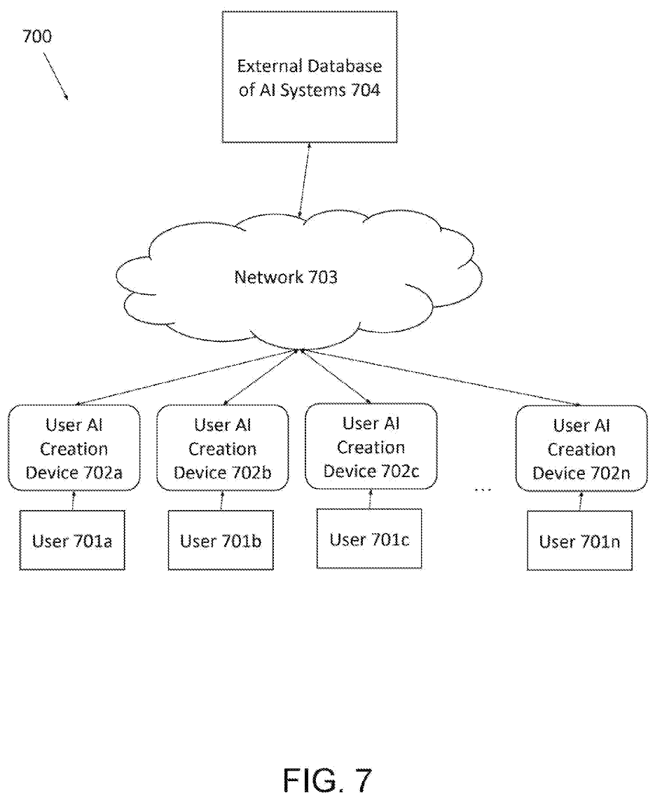

Methodology 100 begins at step 110 by receiving input. The input can be received at an interface for an artificial intelligence tool on a computing device (as discussed further with respect to FIG. 7). The input includes a dataset, an analysis for the dataset, and an output medium. In some examples, the input can include additional selections from a user related to the type of analysis, additional datasets, and acceptable output mediums (as discussed further with respect to FIGS. 2A-2H). In some examples, the input further includes a format for the output, a supplementary dataset, a type of the dataset, metadata corresponding to the dataset, and input consideration variables.

In some examples of step 110, a user “tags” the input dataset as including certain biases. For example, the user identifies the input dataset as being trained on only men, or only people of a particular race/ethnicity. In another example, the user identifies the analysis to be used on the database as created by only creators located in the Western Hemisphere.

In some examples of step 110, the tool prompts a user to choose whether to disclose or not disclose the uploaded data.

In some examples of step 110, the received input includes APIs, real time sensor information, existing data sets, or creating a new dataset.

At step 120, methodology 100 provides for selecting an algorithm and/or model based on the received input. In some examples, more than one algorithm can be selected. The algorithm can be selected from a plurality of algorithms stored at the artificial intelligence tool.

The methodology 100 can provide for any artificial intelligence approach, including an artificial narrow intelligence approach, an artificial general intelligence approach, an artificial intelligence super approach, a non-symbolic artificial intelligence approach, a symbolic artificial intelligence approach, a hybrid symbolic and non-symbolic artificial intelligence approach, a statistical artificial intelligence approach, and/or any other AI approach as known in the art.

For example, the machine learning model, as discussed further below, including any of: a decision tree, a Bayesian network, an artificial neural network, a support vector machine, a convolutional neural networks, and a capsule network.

In some examples, an algorithm provided by a selected machine learning model was trained on the received input. In some examples, the artificial intelligence tool comprises a database of pre-existing AI systems and datasets. The selected machine learning model was trained on a subset of these pre-existing AI systems and datasets, and can have been trained only on AI systems and datasets which have metadata corresponding to metadata of the input dataset and the output medium.

In some examples of step 120, the artificial intelligence tool determines whether the received input corresponds to requirements associated with each algorithm in the plurality of algorithms. For example, if the user wishes to build an AI system with a binary classifier as the output medium, the artificial intelligence tool will select a machine learning algorithm with a binary classifier. The artificial intelligence tool can verify that the dataset can be classified as a binary output.

Some examples of step 120 further include pre-processing the data. For example, the artificial intelligence tool identifies variables in the input dataset; these variables can correspond to variables that will be used by the selected algorithm.

In some examples of step 120, the algorithm is selected by an artificial intelligence process.

At step 130, methodology 100 provides for processing the received input with the selected algorithm. This yields an output. The output can be an AI system which is displayable on the output medium and is trained by the input dataset. In some examples of step 130, methodology 100 additionally provides an indication of whether the selected algorithm successfully processed the received input.

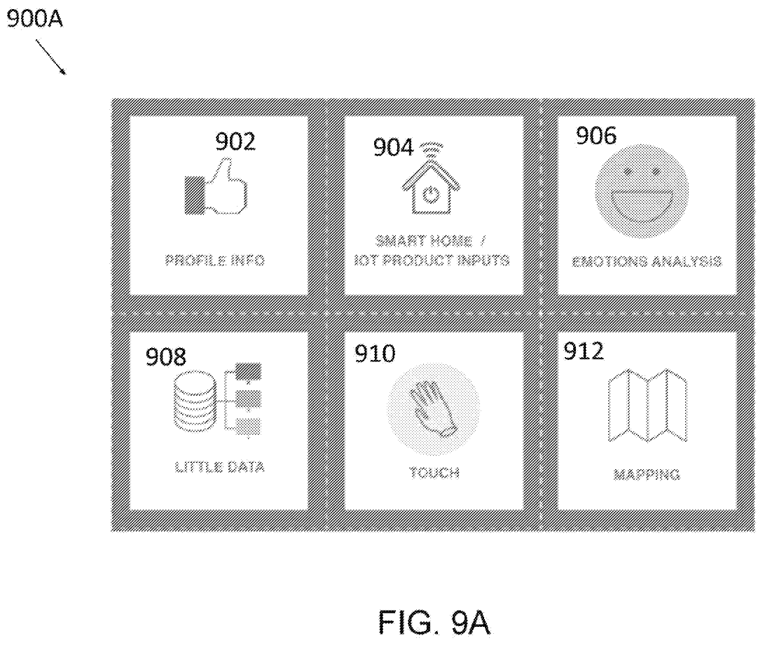

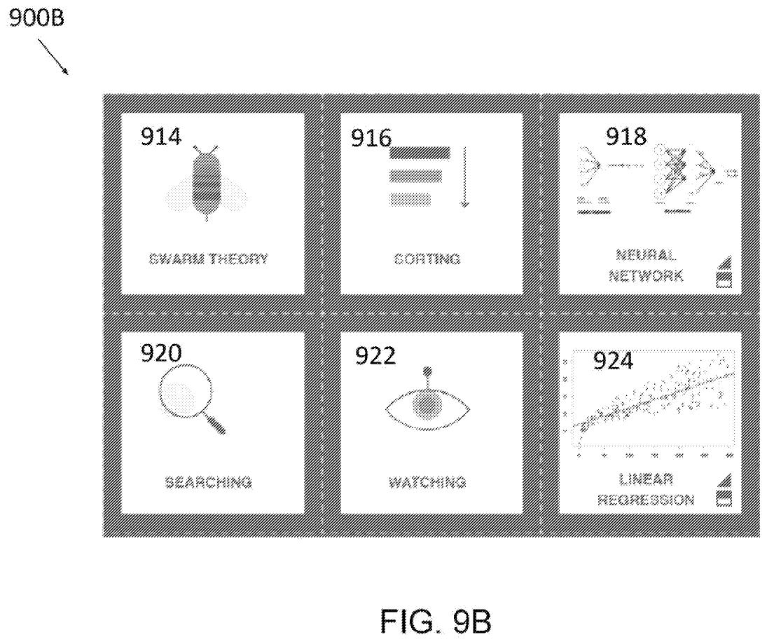

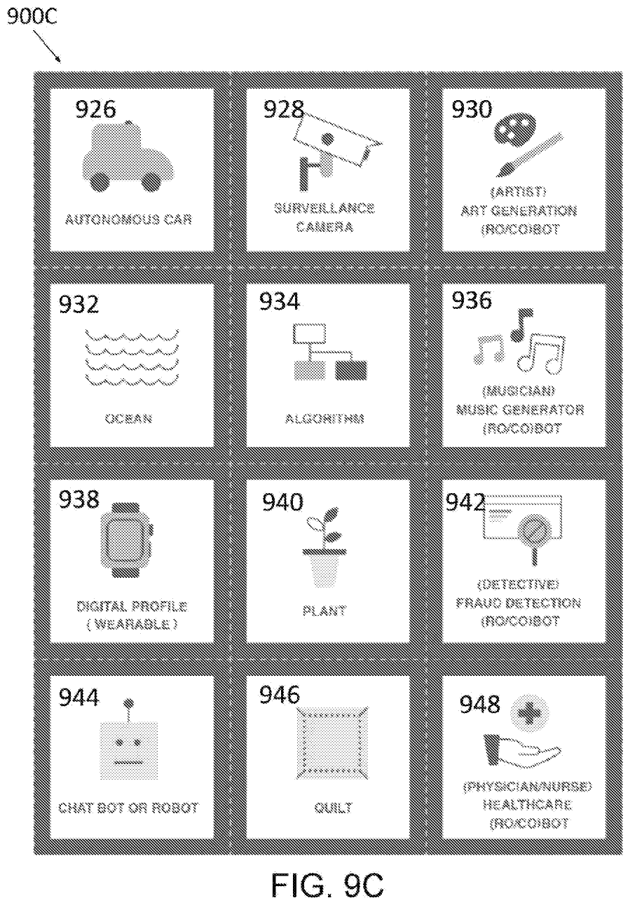

At step 140, methodology 140 provides for displaying the output. For example, the output can be displayed in the output medium. The output can be an AI system. The output medium can be any of the output formats discussed below with respect to screen 200F of FIG. 2F or screen 900C of FIG. 9C.

In some examples of step 140, the output is provided, and not displayed. For example, the system can provide for haptic feedback, tactile output, and/or auditory output. Any other sensory output or XR output can also be provided for by the AI tool. In some examples of step 140, the output is experience in real life, augmented reality, virtual reality, or any other emerging reality.

FIGS. 2A-2H demonstrate exemplary input selections for an AI interface, according to various embodiments of the present disclosure.

FIG. 2A shows an interface selection screen 201 and screen 202. Screen 201 prompts a user to select between an artificial narrow intelligence 271, an artificial general intelligence 272, an artificial super intelligence 273, a dynamical systems/embodied and embedded cognition 274, a software (e.g., cellular automata) 275, a hardware 276 (e.g., robots), and a wetware 277 (e.g., synthetic biology). If a user chooses artificial narrow intelligence 271, they are prompted to go to screen 202. In screen 202, a user can be prompted to select a symbolic, a non symbolic, or a statistical AI. The selection options of FIG. 2A enable a user to tailor the AI system that the disclosed artificial intelligence tool will build according to design needs of the user.

FIG. 2B shows an interface selection screen 200B which prompts the user to select an existing application, algorithm or hardware device. For example, a user chooses one of: a body 210, a smart home device (e.g., Alexa) 211, an algorithm 212, an autonomous car interface 212, a chatbot 214, an infrastructure 215, and a wearable 216. Therefore, the disclosed AI design tool provides an interface to integrate with, and modify, existing AI materials. Although a select number of existing AI materials are shown in screen 200B, the present disclosure contemplates any AI material that can be included on an exemplary screen 200B.

FIG. 2C shows an interface selection screen 200C which prompts the user to select an input. For example, the input can be a dataset 219 (e.g., big data 220, little data 221, or device

specific data 222) and a consideration 227 (e.g., a social consideration 223, a cultural consideration 224, an ethical consideration 225, or a creative consideration 226). Social considerations 223 include, for example, job loss probability of an industry due to automation of a task, inclusion of a particular societal group or demographic, and bias towards or against a particular societal group or demographic. Cultural considerations 224 include, for example, facial/expression data, audio data, and internet of things products. Cultural considerations further include determining how emotion and feelings vary across cultures (or how various social preferences are location and cultural specific). Ethical considerations 225 include any determinations that must be made on a right or wrong (e.g., binary) basis. For example, ethical considerations 225 should be used for designing an AI system that produces autonomous car decision making. Creative considerations 226 include the user's desire for computational creativity, exploratory learning of AI development, a user's intention to transform particular data, a generational criterion, or an evaluative criterion. Therefore, selection screen 200C provides a variety of datatype and potential considerations to choose from when a user is building an AI system. Upon receiving datatype(s) and a consideration, the artificial intelligence tool can eventually evaluate whether the final, created AI system achieves the selected consideration 227. FIG. 2D shows an interface selection screen 200D which prompts the user to select a type of learning algorithm. For example, learning algorithm can be a supervised algorithm 230 or an unsupervised algorithm 231. The user makes a second selection, including reinforcement learning 232, a support vector machine 233, a classifier 234, a clustering technique 235, and a caring-for algorithm 236.

An exemplary caring-for algorithm 236 provides automated plant watering (e.g., ensuring that the plant had the correct nutrients in the soil, was watered routinely and with the right amount.) Additional caring-for algorithms 236 can be provided for personnel or other system tasks.

FIG. 2E shows an interface selection screen 200E which prompts a user to select an intent for the AI system. For example, the intent can be a physical intent 241, a social intent 242, an emotional intent 243, a creative intent 244, an ethical intent 245, a cultural intent 246, or a personal assistant intent 247.

A physical intent 241 corresponds to an AI system which is configured to provide some physical response to a user. For example, a physical response can include haptic feedback such as a jarring vibration and an emoji visual.

A social intent 242 corresponds to an AI system which is configured to facilitate political or socio-political activism. For example, an exemplary AI system with a social intent can facilitate participation in political rallies.

An emotional intent 243 can correspond to an AI system which is responsive to a user's emotions. Emotional intent 243 can be problematic if a user does not know who designed the emotions database and model, and from which cultural perspective; additionally, a user can prefer to opt in or consent to the utilization of an emotionally responsive AI. For example, an exemplary AI system with an emotional intent 243 provides sounds according to a user's mood, light changes according to a user's mood, and scent generation based on a user's mood.

A creative intent 244 corresponds to an AI system which does not need to correspond directly to algorithm accuracy, and can be used for user learning.

An ethical intent 24 corresponds to an AI system which must take into account ethical considerations.

A cultural intent 246 corresponds to an AI system which must take into account cultural norms of different societal groups.

A smart assistant intent 247 corresponds to an AI system which is configured to provide assistant to a user. For example, an AI system with a smart assistant intent 247 assists a user with travel arrangements (e.g. booking flights, seeing the weaver, booking a cab).

FIG. 2F shows an interface selection screen 200F with exemplary output formats. For example, the output formats can include printed language 250, synthetic speech 251, physical object manipulation 252, a device change 253, AI tagging (AI contextual attributes) 254, a report summary 255, and exportable code output or data production 256.

Interface selection screen 200F prompts a selection of a specific/material/form for the construct AI system. Printed language 250 can include modifying language, or producing culturally/socially specific language. Synthetic speech 251 can include when users communicate or the system communicates (e.g. a synthetic speech system). In some examples, synthetic speech 251 modifies how language is personalized to users, in a transparent way. For example, a user can opt in to choosing specific type of speech. or producing culturally/socially specific language. Physical object manipulation 252 can include manipulating objects in the real or virtual worlds. Device change 253 can include pitch changing software. AI tagging (AI contextual attributes) 254 can include tagging input data, output data, or a model. Exportable code output or data production 256 can include an existing product that the user may export or link out to alternative databases or models.

FIG. 2G shows an interface selection screen 200G with exemplary behaviors. For example, interface selection screen 200G corresponds to a sociocultural design tool. Exemplary behaviors include, for example, physical behaviors 260, social behaviors 261, and emotional behaviors 262. A physical behavior 260 corresponds to an AI system which is configured to provide physical feedback to a user. The physical behavior 260 of the AI system can include, for example, physical touch, talking, movement of devices controlled by the AI system, and smiling emojis. A social behavior 261 corresponds to an AI system which is configured to provide social feedback to a user. The social behavior 261 of the AI system can include, for example, mirroring a user's behavior, identifying particular aspects of a user's behavior, or subverting particular actions of a user. An emotional behavior 262 corresponds to an AI system which is configured to provide emotional feedback to a user. The emotional behavior 262 of the AI system can include, for example, identifying that a user is internalizing certain feelings, that a user is externalizing certain feelings, and that a user is acting defiant.

In some examples of the disclosed AI design tool, a user can make more than one selections on any of screens 200A-200G. Although particular options are shown in each of screens 200A-200G, the present disclosure contemplates each of the screens 200A-200G can include any selections as known in the art.

In other examples of FIGS. 2A-2G, an exemplary interface screen provides a text box. A user can enter text related to a prompt; the disclosed tool can analyze the text with any algorithm discussed herein to provide additional learning for the disclosed tool or additional data for any aspect of the disclosed tool.

In other examples of the disclosed AI design tool, the artificial intelligence tool prompts the user for particular selections based on the user's previous input. For example, if the user makes selections in accordance with building an interface for Alexa, the artificial intelligence tool prompts the user to choose social considerations 223 on FIG. 2C and emotional intent on FIG. 2E.

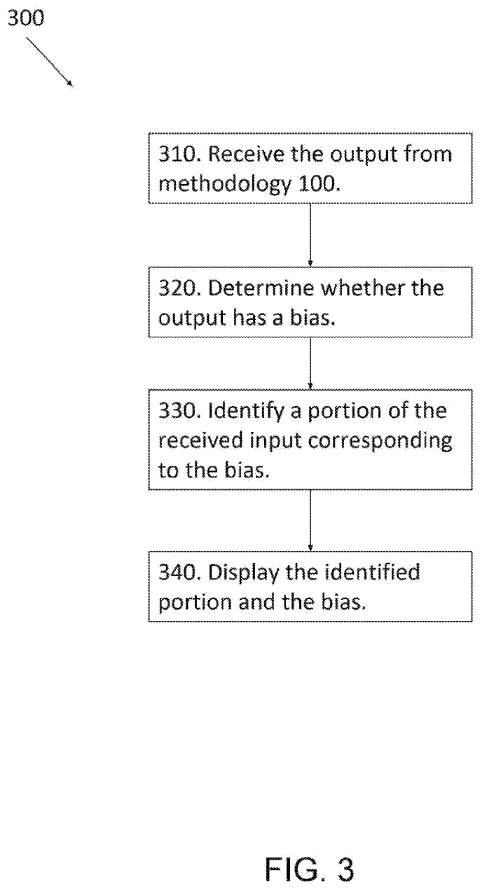

In some examples, the artificial intelligence tool collects usage data of user selections on screens 200A-200G over a plurality of usage instances. The artificial intelligence tool learns patterns of the user according to the user selections (learning, for example, via a machine learning model as discussed further below). The artificial intelligence tool thereby identifies inherent biases of the user according to the user selections. The artificial intelligence tool can then prompt the user on the various screens 200A-200G. FIG. 3 shows an exemplary methodology 300 for identifying bias characteristics in a created AI system. For example, the created AI system can be the output displayed at step 140 of FIG. 1. Methodology 300 begins at step 310 by receiving an output. At step 320, methodology 300 provides for determining whether the output has bias characteristics. For example, the artificial intelligence tool can identify bias characteristics in a plurality of bias categories (e.g., social biases, cultural biases, gender biases, racial biases, and interaction biases created through usage over time). In some examples of step 320, the artificial intelligence tool retrieves metadata or tagging of the input dataset to determine whether there are inherent limitations of the input dataset (e.g., was the dataset trained on only people of a particular race, gender, world-view, geography, or any other limitation as known in the art).

In some examples of step 320, the methodology 300 identifies specific bias characteristics. For example, the user can select bias categories that the artificial intelligence tool should identify. In other examples, the methodology 300 provides for suggesting what bias characteristics are likely, even if no specific bias is identified.

If a bias is not identified at step 320, methodology 300 can provide for displaying, at step 340, that no bias was identified.

If bias characteristics is identified at step 320, methodology 300 proceeds to step 330 and identifies a portions of the received input corresponding to the bias characteristics. In some examples of step 330, the artificial intelligence tool can provide for processing metadata associated with each of the received input. The metadata can include identification of biases corresponding to each of the received input. Step 330 can identify the portion of the input dataset which has the bias identified at step 320.

At step 340, methodology 300 provides for displaying the identified portion and the bias characteristics. For example, the identified portion and the bias characteristics can be displayed at an interface display at a user's computing device.

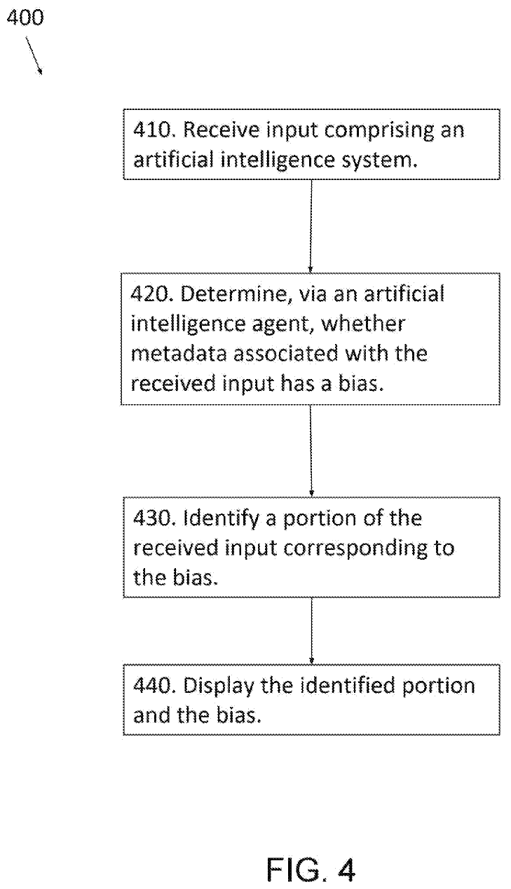

FIG. 4 shows an exemplary methodology 400 for identifying bias characteristics in an externally created AI system. Methodology 400 receives an artificial intelligence system as the input dataset at 410. Step 410 can additionally, or alternatively, receive a dataset, an analysis for the dataset, an output medium, an algorithm/model, and a processed output. The processed output can be an artificial intelligence system based on the dataset, the analysis for the dataset, and the output medium. At step 420, methodology 400 provides for determining, via the disclosed artificial intelligence tool, whether metadata associated with the received input from step 410 has bias characteristics.

Methodology 400 provides similar bias characteristic identification and display (steps 430 and 44) as steps 330 and 340 of methodology 300 of FIG. 3. Therefore, methodology 400 provides a method for analyzing existing artificial intelligence systems and identifying whether the existing system contains hidden limitations or biases. The disclosed AI tool provides for deconstructing problematic approaches to the design and development of conventional AI systems, while designing for new knowledge systems.

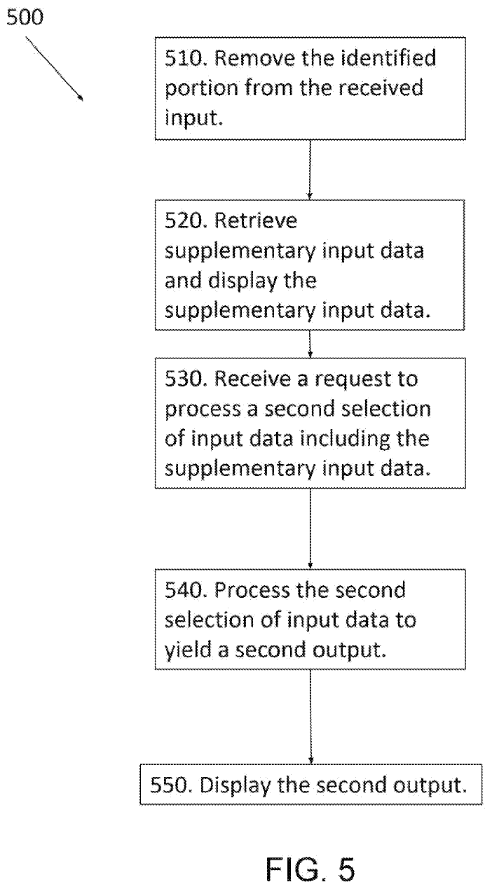

FIG. 5 shows an exemplary methodology 500 for shaping bias characteristics in a created AI system. Methodology 500 begins at step 510 with adjusting an identified portion from a received input. For example, the disclosed tool can provide for adjusting a portion of the data from the received input corresponding to identified bias characteristics. The identified portion can be identified according to steps 330 and 430 of FIGS. 3 and 4, respectively.

Methodology 500 then proceeds to step 520 which provides for retrieving supplementary input data. The supplementary input data can be any of the input data discussed above with respect to step 110 of FIG. 1. In some examples of step 520, the disclosed tool can retrieve supplementary input data from a database of AI systems. The supplementary input data corresponds to the identified portion of the received input and enables shaping of the bias characteristics according to contextual requirements.

In an example of steps 510 and 520, the disclosed tool identifies that a facial recognition AI system comprises a dataset of Caucasian faces with little other racial diversity. Therefore, the disclosed tool retrieves a dataset of faces comprising a greater amount of racial diversity. In another example, the disclosed tool retrieves an AI facial recognition system, which was trained on a dataset of faces with greater levels of racial diversity than the original AI facial recognition system.

Methodology 500 then proceeds to step 530 which provides for receiving a request to process a second selection of input data including the supplementary input data (retrieved at step 520). For example, the user can select the supplementary input data at a user interface (for example, the interface screens as discussed with respect to FIGS. 2A-2G).

Methodology 500 can then proceed to process the second selection of input data to yield a second output (step 540) and display the second output (step 550). Steps 540 and 550 of methodology 500 can correspond to steps 130 and 140 of methodology 100, as discussed above with respect to FIG. 1.

Therefore, FIG. 5 shows an exemplary methodology 500 which provides for shaping bias characteristics in created AI systems.

In an exemplary implementation according to the disclosed methodologies, the disclosed design tool identifies that an artificial intelligence voice recognition system was trained by white male voices (and no other types of voices). Such an artificial intelligence voice recognition system might prioritize enunciation, choose a loud voice over a soft voice, etc. The disclosed design tool can identify and provide these bias characteristics to a user. In some examples, the disclosed design tool can suggest adjustments to shape the bias characteristics of the artificial intelligence voice recognition system; for example, adjusting the data set to include women, or artificially decreasing the volume and modifying the enunciation.

In another exemplary implementation according to the disclosed methodology, a user can use a neural network to analyze a dataset via the disclosed AI tool. The user then switches to a classification algorithm. The tool can provide for displaying the output from the neural network compared against the output from the classification algorithm. In some examples, the tool can identify the changes and determine which algorithm provided a more accurate output.

Referring now to FIG. 7, the present disclosure provides a system 700. System 700 includes a plurality of users 701a, 701b, 701c . . . 701n; a plurality of user AI creation devices 702a, 702b, 702c . . . 701n; a network 703; and an external database 704. The plurality of users 701a, 701b, 701c . . . 701n each have an associated user AI creation devices 702a, 702b, 702c . . . 701n. The user AI creation devices 702a, 702b, 702c . . . 701n can include a software application running the disclosed AI tool, according to any of the embodiments discussed herein. In some examples, as shown in FIG. 7, the users 701a, 701b, 701c . . . 701n are connected to a network 703. By the network 703, the external computing device can facilitate information exchange between the plurality of user AI creation devices 702a, 702b, 702c . . . 701n and the users 701a, 701b, 701c . . . 701n. For example, when user 701a uploads a new database, any other of the users 701b, 701c . . . 701n can access the database via the network 703. In some examples, the database is uploaded to the external computing device 704.

In other examples of FIG. 7 (not shown), the users 701a, 701b, 701c . . . 701n can choose for their associated user AI creation devices 702a, 702b, 702c . . . 701n to be disconnected from the network 703.

In other examples of FIG. 7, the users 701a, 701b, 701c . . . 701n selectively choose which information/data is shared by their associated user AI creation devices 702a, 702b, 702c . . . 701n with the network 703.

Referring now to FIG. 9, additional interface screens are shown for an exemplary embodiment of the disclosed AI tool. For example, in screen 900A, the disclosed AI tool prompts the user to select profile info 902; smart home and/or internet of things product inputs 904; emotions analysis 906; little data 908; touch 910; and mapping data 912. In screen 900B, the disclosed AI tool prompts the user to select an analysis algorithm, including any of a swarm theory 914, a sorting algorithm 916, a neural network 918, a searching algorithm 920, a watching algorithm 922, and a linear regression analysis 924. In screen 900C, the disclosed AI tool prompts the user to select an output. The output can include any system or medium that the user intends to interact with the product provided by the AI tool. For example, screen 900C shows an autonomous car 926, a surveillance camera 928, an art generation product 930, an ocean product 932, an algorithm 934, a music generator 936, a digital profile or wearable device 938, a plant growth model 940, a fraud detection product 942, a chatbot or robot 944, a quilting design product 946, and an artificial intelligence healthcare product 948.

Although exemplary selections are shown in FIGS. 9A-9C, the present disclosure contemplates any selections (including multiple selections) can be provided to a user, as known in the art. For example, although particular algorithms are shown on screen 900B, any machine learning or artificial intelligence algorithm, as known in the art, can be used in the various embodiments of the present disclosure. Likewise, any artificial general intelligence (AGI) systems may be used in the various embodiments of the present disclosure. In another example, although particular systems and medium are shown in screen 900C, the present disclosure contemplates that any system and/or output medium can be used by the disclosed AI tool, according to the various embodiments of the present disclosure.

### Implementations

The disclosed AI tool can be an in-browser generator and/or a software application, which can be used in Virtual Reality, XR, Augmented Reality and/or real life. The present disclosure also contemplates that the disclosed AI tool can be operated in any form as known in the art. In other examples, it could be any computer program running on any computing device

### Exemplary Design Mode

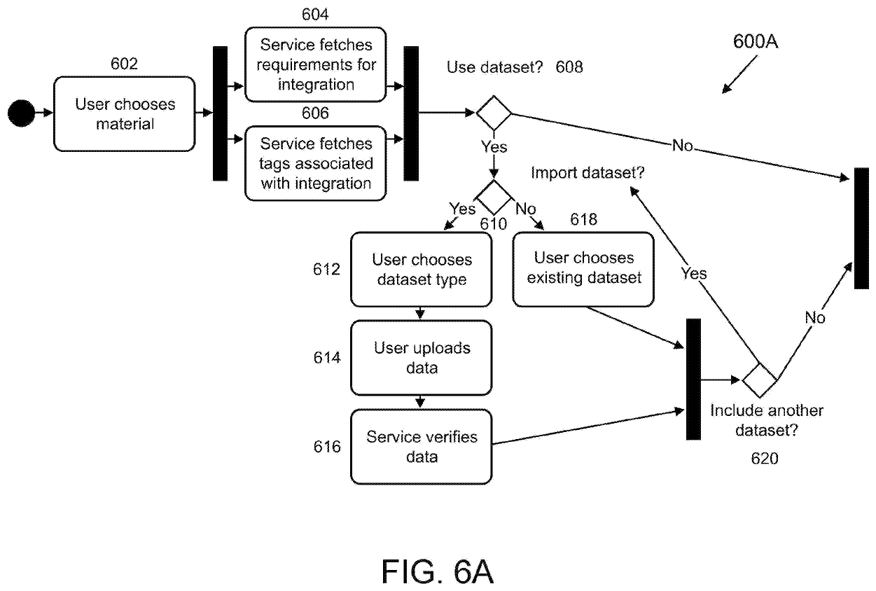

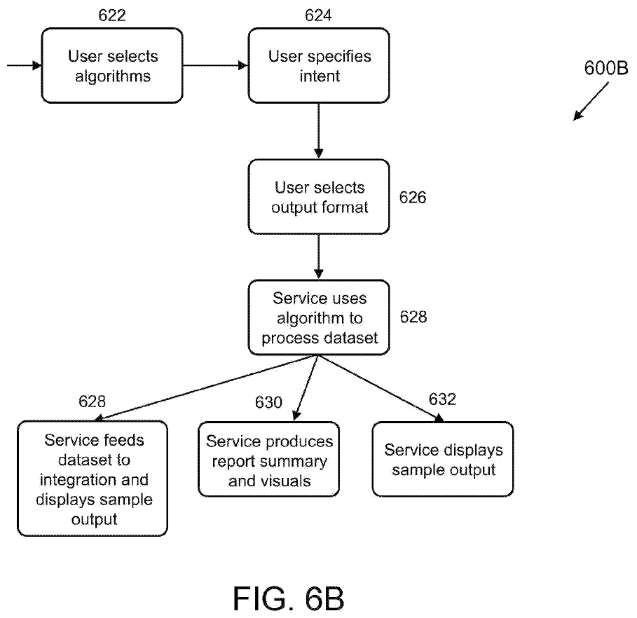

FIGS. 6A-6B show an exemplary methodology 600 for a user to build an AI system, according to another embodiment of the present disclosure. Methodology 600 can be the designer/prototyper mode. In an exemplary methodology 600, a user starts with a pre-determined AI design question or approach. For example, a user can intend to create transparency regarding the utilization of emotions analysis in voice interfaces. As discussed below, methodology 600 uses deep learning, the design question, any keywords and/or input data (whether user created or uploaded from an existing dataset) to (1) identify patterns, and (2) make comparisons with both labeled and unlabeled data in order to create new labels, relationships, models and/or context. [0135] At step 602, the user identifies the material. Materials take both physical and digital forms in the design. The hardware of a product may lend itself to the utilization of specific data/models/algorithms intended for that specific product. For example, digital material includes a software application, a hardware device, or any other product utilizing Artificial Intelligence. In some examples, the materials comprise the form of the system; with more embodied AI devices, the materials and form themselves affect how the disclosed AI tool produces output. In some examples, the materials can produce the form.

In some examples of step 602, the user makes decisions regarding how and what will be designed. For example, if the user wants to design for a product like Amazon's cloud-based voice service, Alexa, only specific design choices will be available based on that product.

Once the material is chosen at step 602, the design tool (or service) fetches the requirements for the integration at step 604. In some examples, at step 606, the design tool can also retrieve any tagging information related to the material (or product) chosen in step 602.

At step 608, the user is then prompted to include data by one or many of these options: from existing data sets (step 618), user created data sets step (612). In other examples (not shown) the user can select real time data from a sensor or data from an APL The input can also include any AI tagging (AI contextual attributes or metadata) provided by any other product.

At step 612, the user creates a specific data type and then uploads the data type at step 614, having it verified by the service/design tool at step 616. Therefore, the data type conforms to the material chosen in step 602. The user can upload pre-existing data sets that conform to the new data type.

In some examples, multiple datasets can be used at step 620.

In some examples of methodology 600 (not shown), the user is then prompted to enter a “consideration input” and/or an intent at step where they can add cultural context, ethics, etc. (any variable that should be considered in the design process). These input considerations will be output at the end, and can also be used to highlight information throughout the design that might be relevant to that consideration. There are several benefits to entering the “consideration input”, the primary benefit is to build ethics, culture and bias controls into the design. In some examples of methodology 600, the users are reminded to design with and for these input considerations throughout the design process and not only at step.

At step 622, the user is provided with learning algorithms, which are populated by the material. Inputs to the learning algorithms (or models produced by these learning algorithms) can be existing datasets, user uploaded data sets, real-time sensor information, API's, and the design question/key words (or any other input as discussed above with respect to step 110 of FIG. 1). The input can also include any AI tagging (AI contextual attributes) provided by a specific product (discussed further below). The user can train data locally with open source SDKs and/or scale using cloud services.

At step 624, the user identifies an intent, which reflects the intention of the design. In some example, the tool prompts users to identify a personal culture of the users or a culture that the user is designing for. The tool can analyze and adapt later prompts to the user based on this input.

At step 626, the user identifies the format of the output.

At step 628, the service feeds a dataset to integrate and display in the sample output. There are many possible outputs from this tool. One output, shown at step 628, is a prototype built on an SDK with the data the user suggested (in the form of suggested code, API, AI Tagging (AI contextual attributes) and/or written information). Additional outputs (not shown) can include hardware, physical material, or auditory noise

Another output is auto-generated analysis/visualization (a report summary with visuals), shown at step 630. This report can include technical and social/cultural considerations. In the report, the output can also highlight issues of concern with the AI design process or designed biases in data, models and demographic information about the creators. An exemplary output according to step 630 can provide a recommendation to utilize pitch changing to identify the presence of an algorithm (earcon). The report can include suggestions of pitch changing libraries. Step 630 can further provide for populating the output step 632, the service then displays the sample output.

### AI Tagging

In one embodiment of the present disclosure, the tool provides AI tagging (also referred to as AI contextual attributes). AI tagging (AI contextual attributes) includes receiving content descriptors of (1) the algorithms/models, (2) input data used in the design of existing AI systems, (3) the demographic information of the humans or machines proposing the AI system, and (4) who created the materials and form of the AI system. The disclosed tool uses the AI tags (AI contextual attributes) to increase algorithmic transparency by providing data, algorithm/model information in the design and development process of an AI system. The disclosed tool also provides for tagging created AI systems with the demographics of the creators, content descriptors of the algorithms used, and/or content descriptors of the input data used. Therefore, the disclosed AI tool provides pre-build non-technical considerations AI system design, giving these considerations equal importance to the technical algorithm selection. Output from the disclosed AI tool therefore shapes bias characteristics that exist in conventionally-designed AI systems. The output can be displayed, felt, or heard through various devices (e.g., phones, embedded haptics in clothing, and/or sound produced in location specific ML systems)

In some embodiments, AI tagging (AI contextual attributes) is incorporated at the beginning of the AI design process (e.g. before step 110 of FIG. 1, or before steps 310 and 410 of FIGS. 3 and 4, respectively), when the user imports information from a specific product and/or dataset. In other embodiments, AI tagging (AI contextual attributes) is output from the design tool.

In some examples, the disclosed AI tool receives AI tagging (AI contextual attributes) data from a user in his home, at a worksite, through a user's mobile device, through a scanner, through an RFID chip embedded in a computing device. In some examples, the user can access the AI tags (AI contextual attributes) through any of these devices, or while viewing a system in augmented realities. In other examples, a user receives a text message identifying the bias. Any other method for uploading an AI tag (AI contextual attributes) or displaying AI tagging (AI contextual attributes) can be used as well, as contemplated by one skilled in the art.

### Form/Material/Medium Alternatives

Different media types afford the utilization of specific types of algorithms or AI development frameworks.

### AI Design Tool Across Environmental Configurations

Data collection has tremendous implications on user privacy and significantly effects conventional AI designs regarding culture and transparency. User privacy concerns change how users design, accept, contribute to, and opt into information, data, and models.

The disclosed AI tool provides for collecting data insights from multiple and varied realities in order to expand the reach of an AI system beyond conventional AI systems. This data provides more holistic cultural perspectives on the roles of user bodies, location, thinking about feelings, and user interaction with color; this holistic perspective provided by the disclosed AI tool provides a different cultural perspective for users than conventional AI systems.

In some examples, the disclosed AI tool receives user-rated data (e.g., embodied data sorting) or other reviews of conventionally-designed AI systems. The disclosed tool then identifies patterns in sorting to determine how the salience of objects and media varies across cultures.

The present disclosure provides additional examples of collecting data across realities, including:
Augmented Reality Data Collection-For example, the AI tool collects location based feeling placement, when users identify where they would like to tag a feeling, by dropping a color-coded feeling in a specific location. Users can leave information in locations that can then be collected and used for a more complicated AI system, which can build across multiple data streams, across multiple realities to focus on more embodied AI experiences.
Virtual Reality Data Collection-Virtual reality data collection can be collected similarly to augmented reality data collection, as would be readily contemplated by one skilled in the art.
XR-“X” can expand across senses; some example include biometric and other natural physical realities.

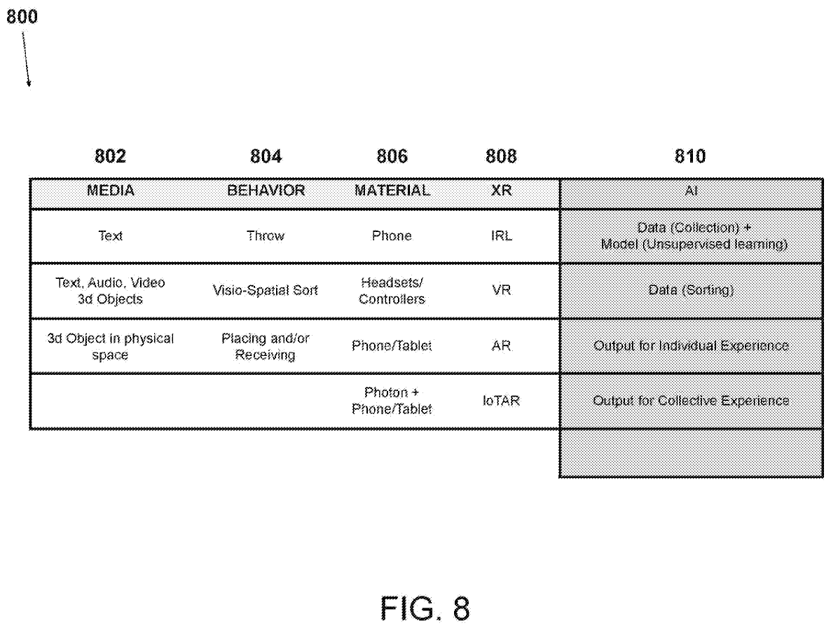

FIG. 8 provides a chart 800 showing how different data can be collected across realities. For example, chart 8—shows the datasets: media 802, behavior 804, material 806, reality type 808, and artificial intelligence model 810. An exemplary artificial intelligence model 810 can include one type of media 802, one behavior 804, one material 806, and one reality type 808.

For example, a collection and unsupervised learning artificial intelligence model can use textual media, throwing behavior, a phone as material, and data collected from real life.

For example, a data-sorting artificial intelligence model can receive media input from textual media, audio media, video media, and 3-D object media. The data-sorting artificial intelligence model can use visio-spatial sort behavior, use headset/controller material, and a virtual reality implementation.

For example, an AI system which provides output for an individual experience (i.e., a teaching model) can use 3-D objects in physical space, can cause the items to place and/or receive, can use a phone or tablet, and provide augmented realities.

In another example, an AI system which provides output for a collective experience provides a photon (i.e., electric communication) and a phone/tablet. The AI system is provided in Internet of Things augmented reality.

### Contextual Normalcy

The present application implements a “contextual normalcy” methodology that fundamentally transforms how user data is collected and permission is granted. Unlike conventional systems that force users to consent to data sharing before providing information (often leading to consent without understanding), the present invention provides a platform for users to first disclose their information and then decide what they are interested in sharing. Therefore, the disclosed design tool ensures greater accuracy in user responses over conventional systems.

This implementation provides a specific mechanism for addressing the community requirements aspect of bias characteristic shaping. By allowing communities to determine data sharing after providing information, the system can collect more accurate information about community needs and perspectives, better identify both present bias patterns and missing representation, shape bias characteristics in a way that respects community agency, and provide a system for users to engage with feeling and develop their emotional health through community centered design.

In one embodiment of the present disclosure, the AI design tool provides an interactive experience for a group of users around the world (for example, the group of users can be diverse). The AI design tool provides a set of questions to the group of users and receives personal refinement from each user. The set of questions can be directed towards the user's feelings. The questions range from general cultural concepts of feelings (e.g., “How would your community describe ‘feeling average’?”) to more personal ideas about how the users feel (e.g., “How do you know you feel blue or melancholy?”). The AI design tool collects responses over an extended period of time. This information can be sorted or analyzed using various models, including supervised learning or unsupervised learning. For example, the AI design tool groups together keywords from the iterations of questions (much like a flocking algorithmic script).

From these groupings of culturally specific questions, the AI design tool (1) predicts which questions a particular user will be comfortable answering, according to the groupings; and (2) prompt a user to consent to any of a plurality of public disclosures of the user's data AFTER the user has honestly answered the question. Therefore, unlike conventional data collection systems which first require a user to opt-in to disclosure before the user has provided any information, the disclosed design tool provides a platform for users to first disclose their information and then decide what they are interested in sharing. Therefore, the disclosed design tool ensures greater accuracy in user responses over conventional systems.

With the grouped questions and the user responses, the disclosed AI tool examines emotional and behavioral patterns to determine future questions and to determine which questions should be provided to which users. Therefore, the disclosed AI tool provides a system for users to engage with feelings and develop their emotional health.

Additionally, the AI design tool reveals the assumptions m the design and development of conventional systems by increasing AI literacy through user workshops reliant on the disclosed tool. Using this tool, conventional approaches to AI development and design can be deconstructed; the tool can create new approaches; and the tool redefines and provides alternatives to existing problematic knowledge systems.

Using questions and data, the disclosed AI tool can identify response patterns to show traits of reported feelings across cultures and different demographics. The speculative, interactive, and design practices of the disclosed AI tool provides alternative embodiments than conventional treatments for mental health diagnosis and treatment.

In some examples of this embodiment, the disclosed AI tool collects and organizes different types of data across different realities or environments. For example, the AI design tool can collect data from crowd sourcing, embodied data sorting in virtual reality, and location-based feeling placement in augmented reality (e.g., the user drops a color-coded feeling in specific locations). The disclosed AI tool can use the data from each reality to provide a different strength for data collection.

### User Testing

In some examples, the disclosed AI tool provides an interface for users to see how their responses to a question compare with (1) their previous response and (2) other responses around the world. Some embodiments include keyword search options and visualizations.

### Mental Health Embodiment

Therefore, a tool according to the present disclosure develops a AI tool to diagnose depression; the developed tool has a lower bias than conventional diagnostic methods. The disclosed tool provides embodiments focusing on mental health for bots, browsers, digital materials, smart materials, haptics, handwriting, spoken words, and locations.

An exemplary tool according to this embodiment can take as input: (1) crowdsourced data about user feelings, (2) user thoughts about their feelings, (3) location data, (4) varied voluntary demographic information, and (5) clinical research regarding keyword patterns found in existing diagnostic systems and assessments. In some examples, the present tool provides for the shaping of bias characteristics by examining who designed the data collection, who contributed to the data, who created the models, which models where used, and why.

The exemplary tool provides supervised and unsupervised learning with more data collection. In an exemplary embodiment, the disclosed AI tool selects the algorithm to analyze the data based on the AI' s database collection.

The exemplary tool provides a plurality of output options, including (1) visualization, (2) alternative information for inputs, (2) new words, (4) new classifications, (5) new language of emotions, (6) data from a contextual normalcy (according to the contextual normalcy embodiment discussed above, (7) data from an augmented reality distributed emotion application, and (8) intelligent location-based experiences.

Therefore, an embodiment of the present tool provides data primarily focused on individual and collective cultures as well as project-defined communities and teams.

Embodiments of the invention are directed to a collaborative software tool that facilitates new ways to create and shape emerging technologies. In some embodiments, the collaborative software tool places equal weight on both social and technical components of the design process, centers multiple perspectives and community driven design, and is explicitly exploratory (not prescriptive).

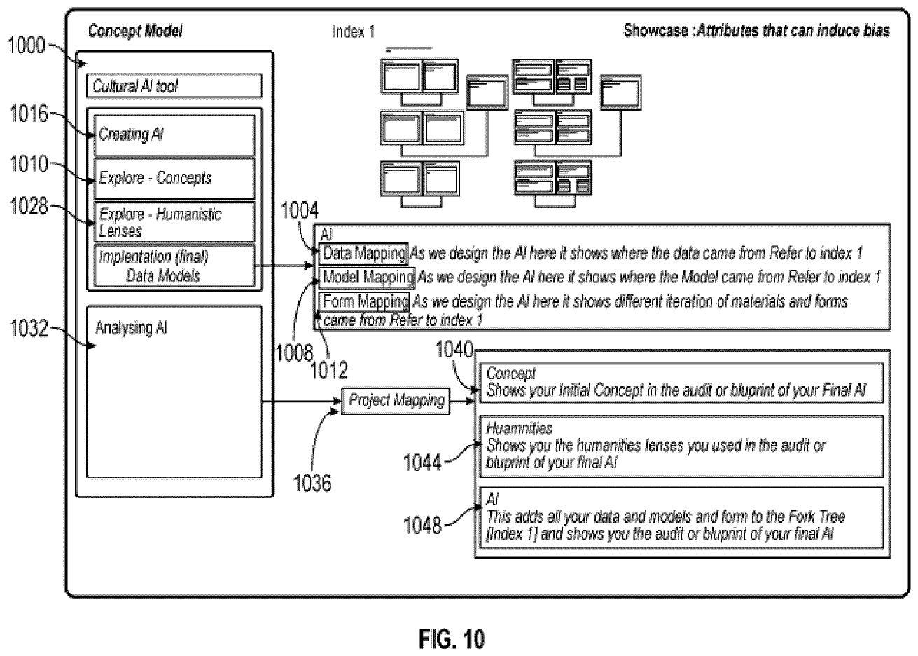

FIG. 10 illustrates a conceptual map of the collaborative software tool 1000. As shown in FIG. 10, the tool 1000 includes tools for data mapping 1004, model mapping 1008, and form and material mapping 1012. The tool allows for creating AI 1016, exploring concepts 1020, exploring humanistic lenses 1024, and implementation using the final data models 1028. The tool 1000 may also include analyzing AI 1032, which includes project mapping 1036. The project mapping 1036 may include: a concept section 1040, humanities section 1044 and AI section 1048. As shown in FIG. 10, the concept section 1040 shows the initial concept in the blueprint or audit of the AI. The humanities section 1044 shows the humanities lenses used in the blueprint or audit of the AI. The AI section 1048 includes all of the data, models, and form and material and also shows the blueprint or audit of the final AI. The sections are modular and are movable in the tool. Additional details about the tool are disclosed hereinafter.

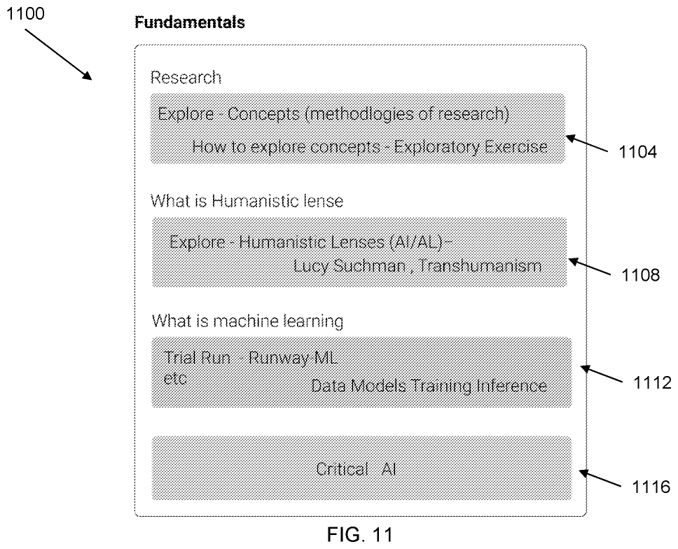

FIG. 11 illustrates an example of the fundamentals in action with the mapping sections implemented 1100. As shown in FIG. 11, the explore concepts step includes exploring the methodologies of research 1104. The process continues by exploring humanistic lenses 1108. The process continues by using a training model inference 1112. The process continues with Critical AI 1116.

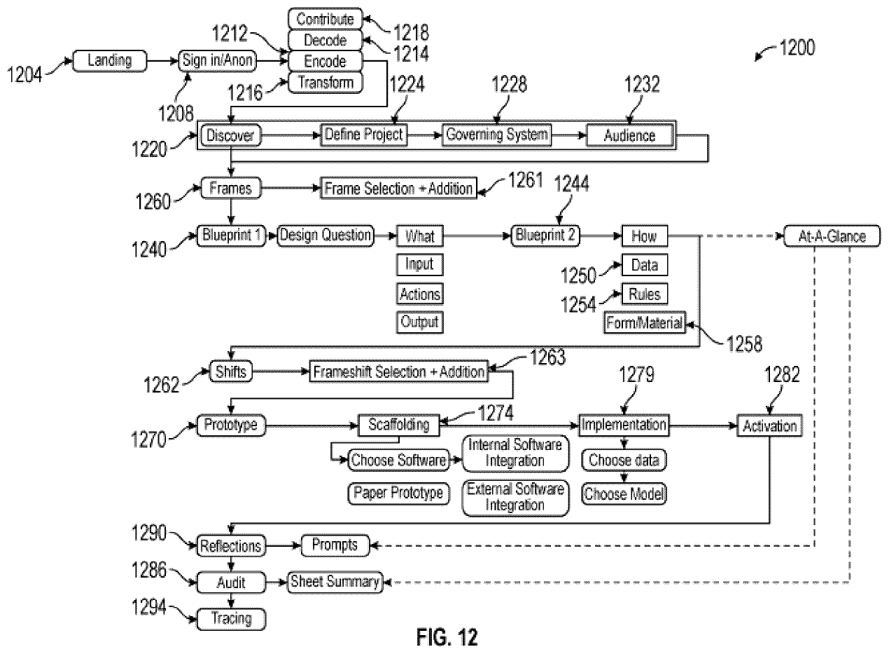

FIG. 12 illustrates a process of designing social technologies using the tool and various sections of the tool 1200. It will be appreciated that the sections are modular and that the order of the process is not limited to that shown in FIG. 12. As shown in FIG. 12, a user may access the tool at a landing 1204 where the user is prompted to sign in or access the tool anonymously 1208. The user then selects that they want to encode 1212 to indicate that they are designing social technologies. The designers may also enter into the project by trying to understand an existing project (decode) 1214, transform or modify an existing one (like remixing) 1216, or contribute a perspective, data or model, or any type of insight into an existing project 1218.

In FIG. 12, the tool may begin with a discover process 1220, in which designers are asked to think about the discovery process (e.g., who are they designing with, who are they designing for) and the context (e.g., projects focused on intelligence vs. life). The designers are asked to describe or define the project 1224. The designers are also prompted to identify themselves or, in some cases, may want to be protect and not identify themselves. The community is defined or the individuals on the project may also be identified in this section. The user also decides the “governing system” of the project 1228, including which parts of the project are open to additional outside collaboration. In this section, the users implement the data collection system, where the user decides which data they want attached to the project in various sections. The users decide the duration of the data usage, and the rules for usage, and which pieces of data (or information) will be used. The project may be attached to the tool's database but may also link out to other databases. The user may also prototype what it would be like to use a different database (e.g., relational vs. object oriented, etc.). The designers are also asked to identify who they are creating the project for (i.e., the audience) 1232, such that it can be determined whether there are any potential disconnects between the people creating the tools and the people using or being affected by these tools.

As shown in FIG. 12, the process also includes a blueprint section—blueprint 1 1240 and blueprint 2 1244. It will be appreciated that this may be done earlier or later in the process. Additionally, as will be discussed in further detailed hereinafter, various cards can be locked and commented on or the whole section can be locked or commented on during the blueprint process. Part 1 of blueprint 1240 focuses on what does the project do (e.g., inference) and part 2 of blueprint 1244 focuses on how it works (e.g., training). The blueprint section is interchangeable, and can take on its own form.

As shown in FIG. 12, the tool also includes a data collection section 1250. In the data collection process 1250 the user is asked to critically think about data collection, type of data, who decides what becomes data, and who creates the data question. Here, the user either retrains or identifies or creates “rules” 1254. Rules may include artificial intelligence, life, and knowledge models—which may include” deep learning, machine learning models, algorithms, and community or individually defined rules that may become a model or algorithm. Users are prompted to think about the knowledge system, transfer of knowledge to information, exploration of how information becomes data. In the data collection portion (in the blueprint section), there may be a versioning of the data to track who has changed what data. The user also explores both form and material 1258. A user might want to speak to form only, or material only, or both form and material. In the form/material question, the users can create or use community and individual contributed design patterns and explorations. These patterns and/or behaviors may also incorporate a combination of patterns across realities. For example, one pattern in AR may affect or incorporate information from VR, or IRL. The design or learning output from one reality (VR) may generate or be an input for another reality (AR).

The tool may also include a frames/EKUs/EKUs section 1260 and/or a frameshifts sections 1262. The frames/EKUs/EKUs section 1260 or frameshifts section 1262 may include frames/EKUs/EKUs, lenses, filters, etc. that can be applied to the project holistically or on each section. These frames/EKUs/EKUs may represent current thinking about a technology from a specific perspective, or they may offer shifts in the way the technology or parts of the technology are framed or understood. The frames/EKUs/EKUs may also encourage designers or contributors to think critically about a technology project. In the frames/EKUs/EKUs section 1260, the user may select frames/EKUs/EKUs or add frames/EKUs/EKUs 1261. Similarly, in the frame selection and addition, a user may select frames/EKUs/EKUs or add frames/EKUs/EKUs 1263.

The process also includes a prototype section 1270, scaffolding section 1274, implementation section 1279, activation section (also referred to as testing) 1282, and audit section 1286, discussed in further detail hereinafter. The tool may also include a reflections section 1290 and a tracing section 1294. The scaffolding section 1274 includes choosing software 1275 and performing an internal software integration 1276. An external software integration 1277 may also be done. A paper prototype 1278 may also be generated during the scaffolding section. The implementation section 1279 may include choosing data 1280 and choosing a model 1281.

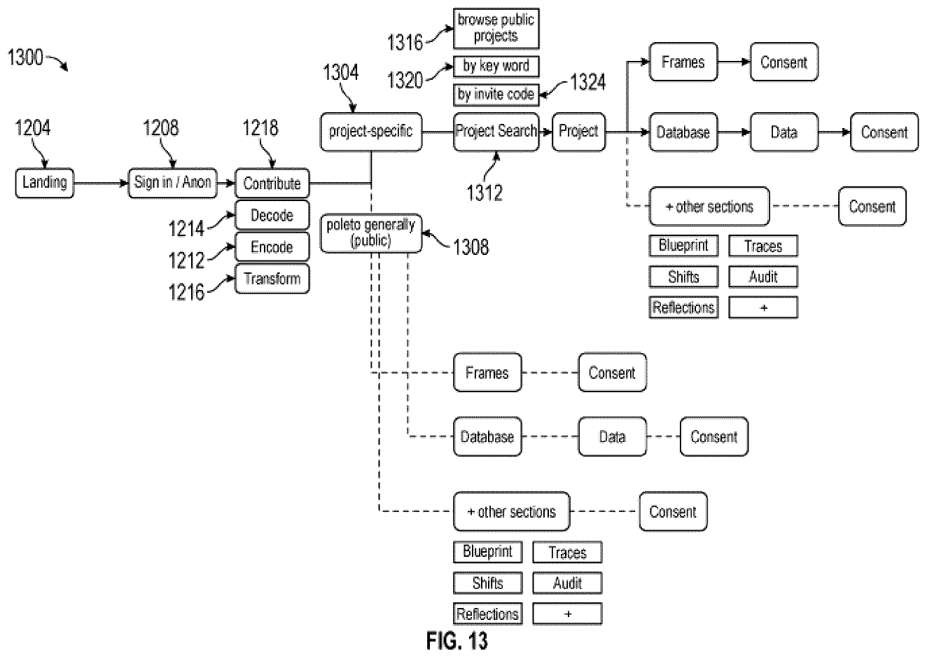

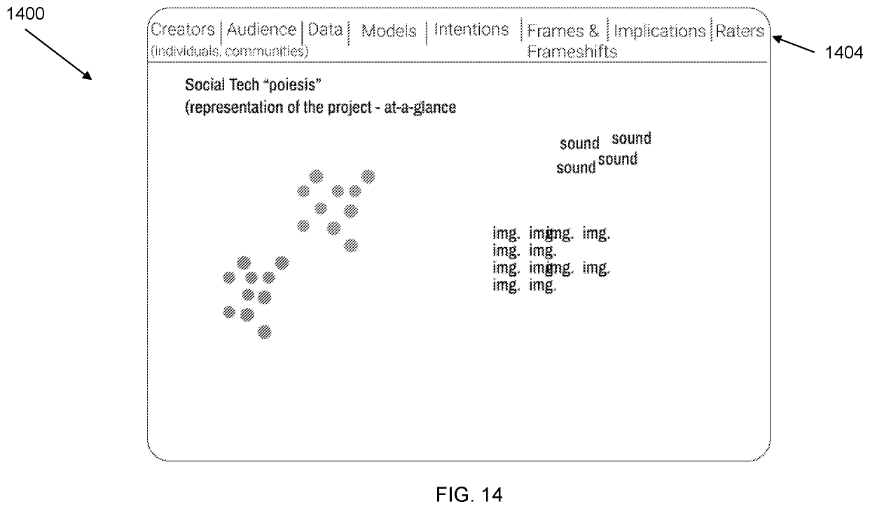

FIG. 13 illustrates a system map 1300 according to embodiments of the present disclosure. In addition to making a project (through decode, encode, or transform), the tool also provides a path for “donation” or “contribution” to existing projects, or to the tool's public library. These donations can be in the form of data or “frames/EKUs/EKUs”. This allows those contributing or donating to consent to who or what projects they are donating to. In this example, the creator enters the landing page 1204, signs in 1208, and chooses the contribute option 1218. These donations can be in the form of, for example, data or “frames/EKUs/EKUs”.

The user may choose to contribute to a project that they have been invited to (that is not publicly available), which may include responding to a product or working on a shared research project 1304. The creator may also or alternatively opt to choose a publicly available project to contribute to 1308.

When the contribution is to a specific project, the user may perform a project search 1312. The project search may be done using, for example, browsing public projects 1316, by key word 1320, or by invite code 1324.

In both iterations, the creator may contribute to data, frames/EKUs/EKUs, shifting of frames/EKUs/EKUs-or any portion of the tool—such as the consent, blueprint section, audit, etc.

FIG. 14 illustrates an exemplary project representation 1400. In the project representation 1400, a user can add modules/sections to the headers 1404. This is the “at a glance” view of the data, algorithms, software and lenses used in the project. Similar to a QR code, it is a quick read for someone new to the project. A visualization/sound (earcon) of the project summary that shows the project at a glance (visual, sound, etc) poiesis/imprint. This can be realized on paper, a screen, using VR and AR or can be embedded or stored in objects. Users add the headers above based on their project. Additional categories can also be pulled from the methods/landing page.

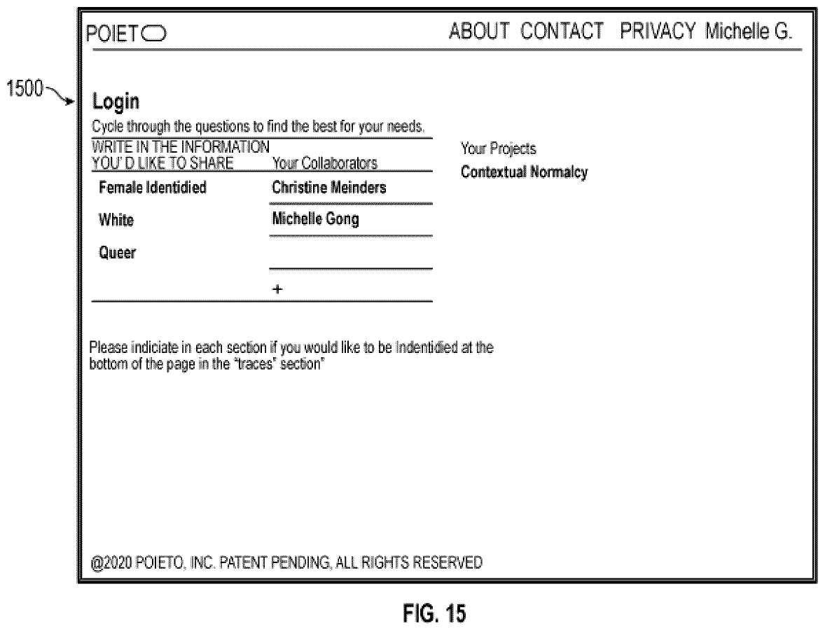

FIG. 15 illustrates an exemplary user interface screen of the login page 1500. As shown in FIG. 15, in the creator section, the user is asked to enter in their own demographic information, and may add their own identifying information. And, they are asked to share this information in each relevant section. Here, they can identify what groups they are a part of or would like to join.

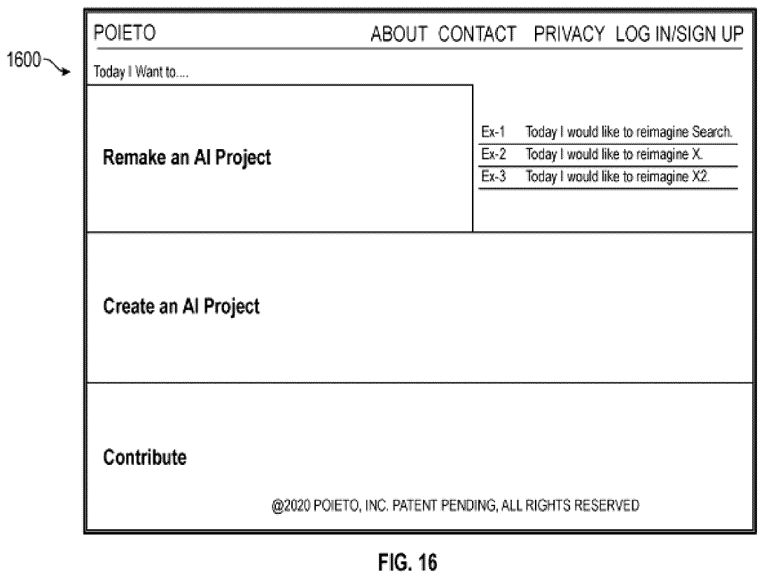

FIG. 16 illustrates an exemplary user interface of a section where users can select whether to remake (transform), create (encode), deconstruct (decode) or contribute to a social technology project 1600. A project can be driven by individuals, nonprofits or self-defined communities. The tool allows for a community to contribute their info and collaborate together. The mechanics of community sourced input is expressed in how a team may collaborate from the very beginning or pull from community sourced data, with community defined leaders and creating checkpoints specific to each project.

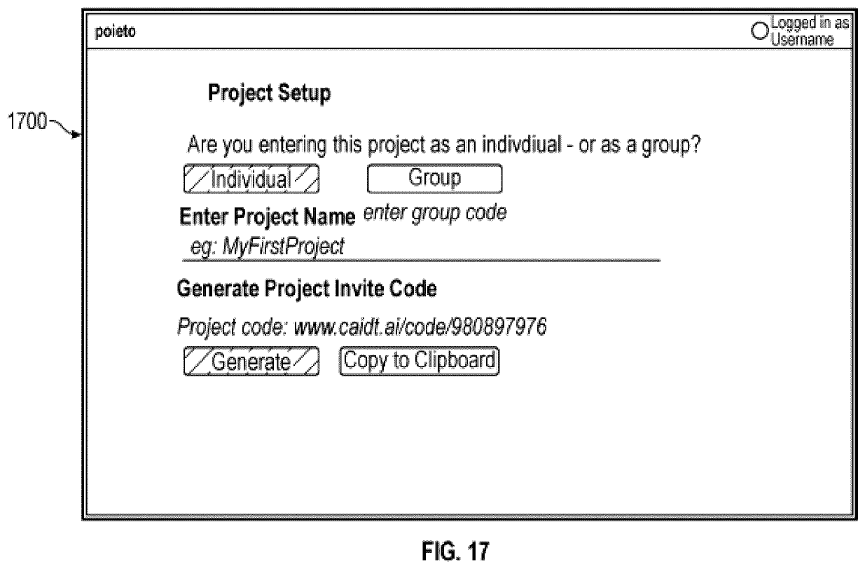

FIG. 17 illustrates an exemplary project setup user interface 1700 where the project creator is asked if they will enter as an individual or as a group. If the user is part of a group, they are further requested to enter the group name. The creator can enter in an existing project name or add an invite code.

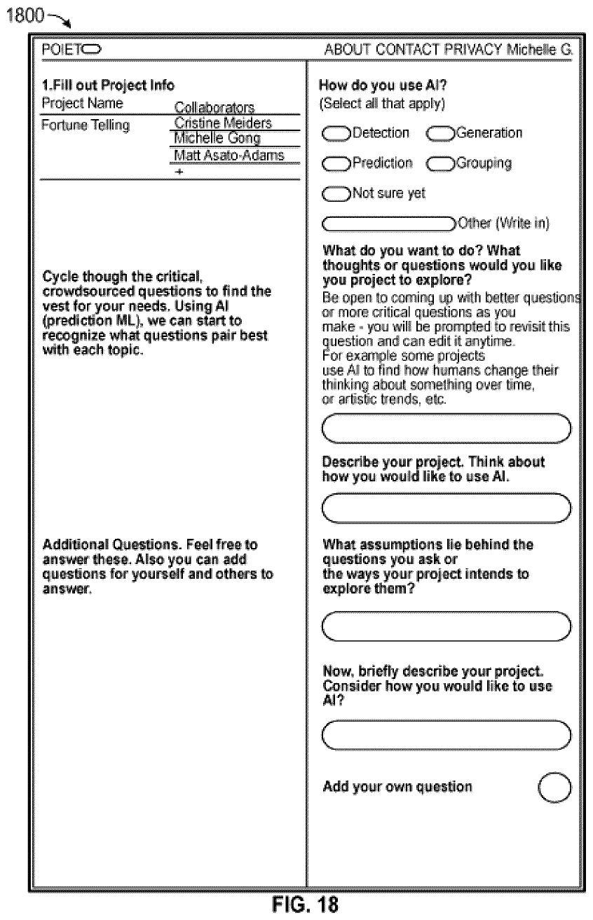

FIG. 18 illustrates an exemplary user interface illustrating a discover section of the tool 1800. In the discover section of the tool 1800, the user is prompted with several questions and asked to think about the project (e.g., who is making it and who is it for). In the example shown in FIG. 18, the user is presented with various approaches to AI-via a checkbox or they may write in a response. The user is able to describe their projects, and keywords may be used later for recommendations at certain stages of the projects. The user can write in questions/considerations, find more questions, and/or upvote existing questions. Similar to other sections of the tool, they may upvote or downvote specific questions.

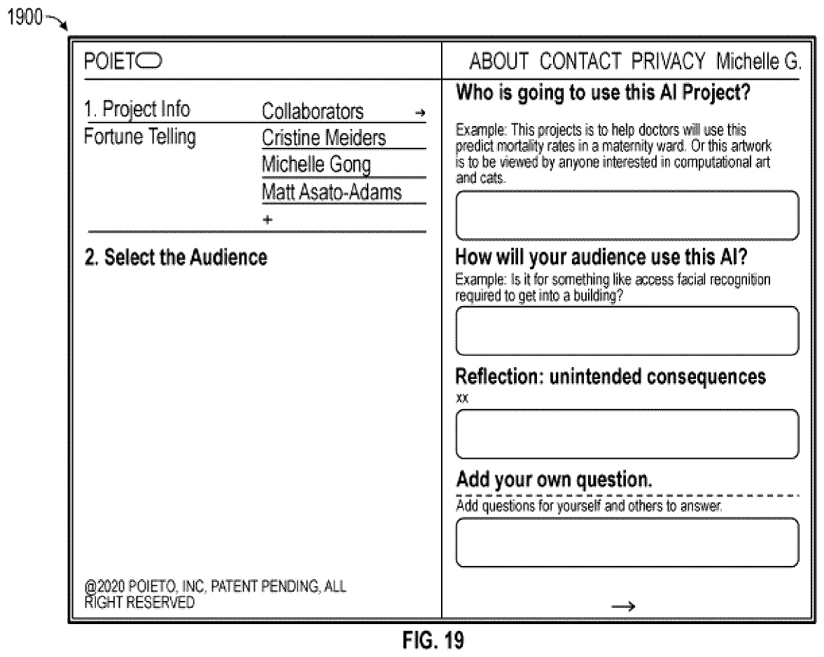

FIG. 19 is an exemplary user interface section 1900 of the tool where the user or group identifies the intended audience of the project. This helps people recognize if the project is being designed for the user or group that they are or are not a part of Additionally, the designers can upvote/downvote questions, write in questions, and/or find questions that fit with the project.

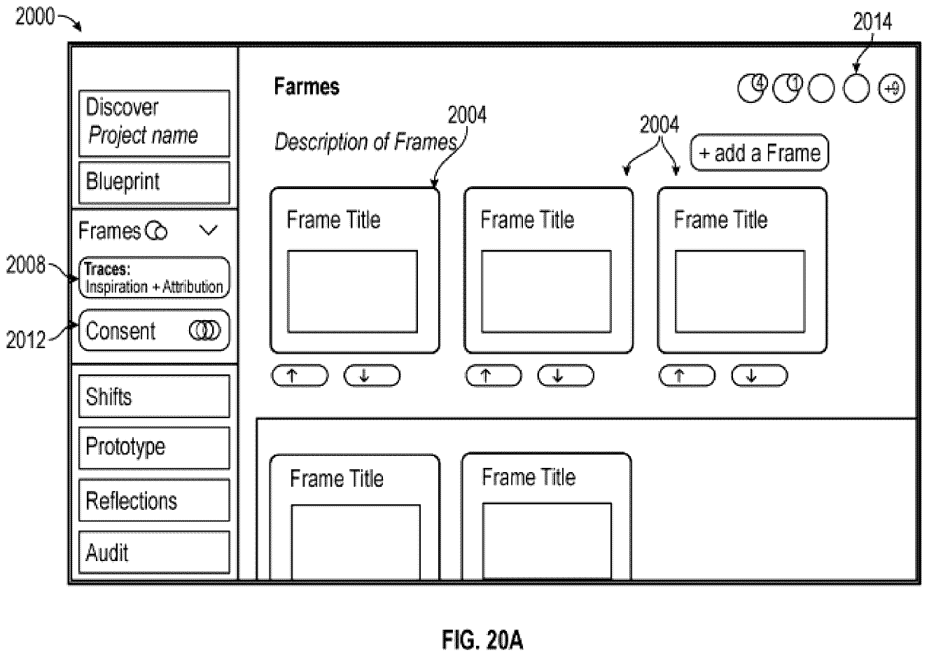

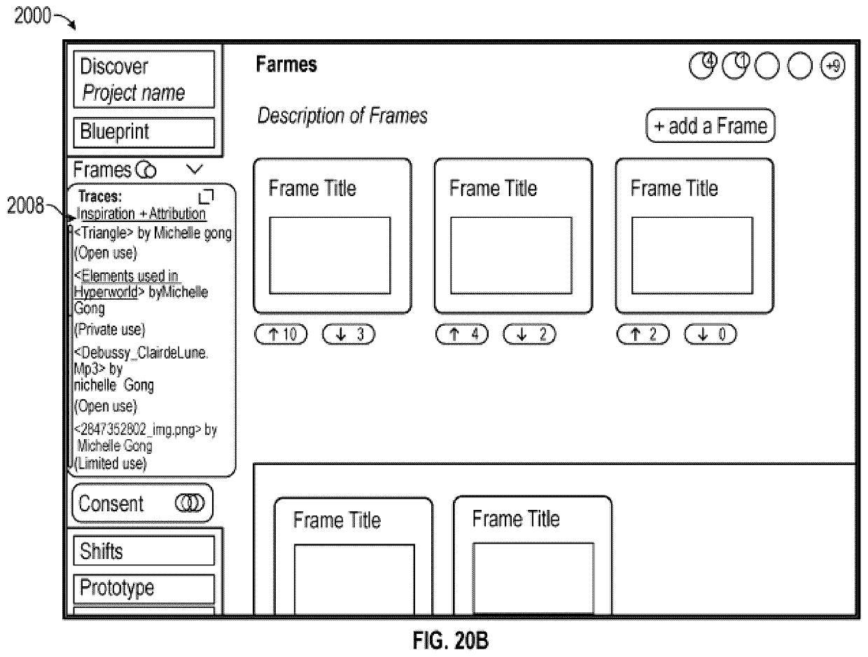

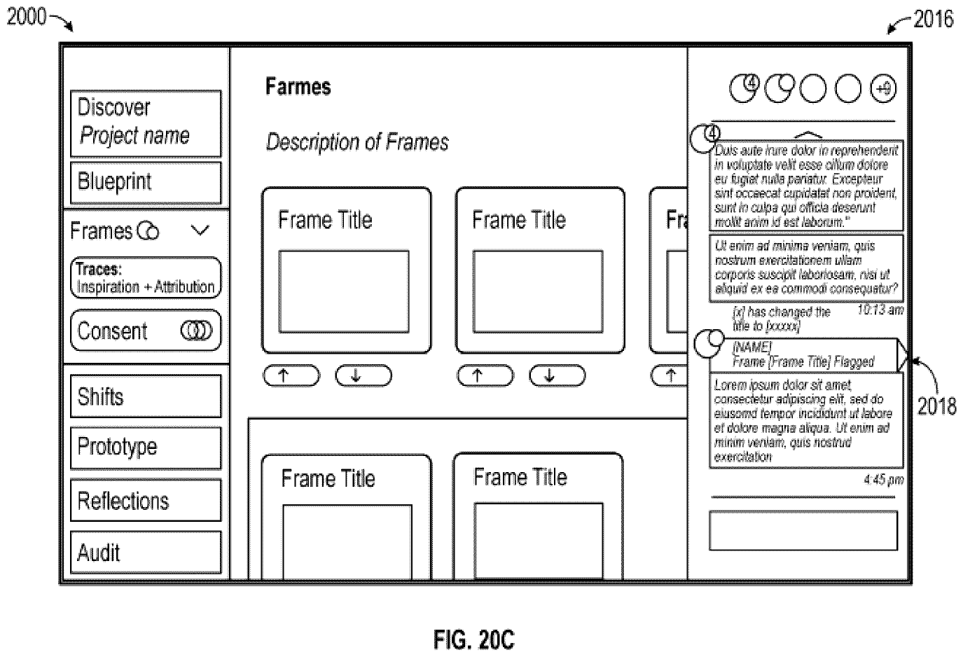

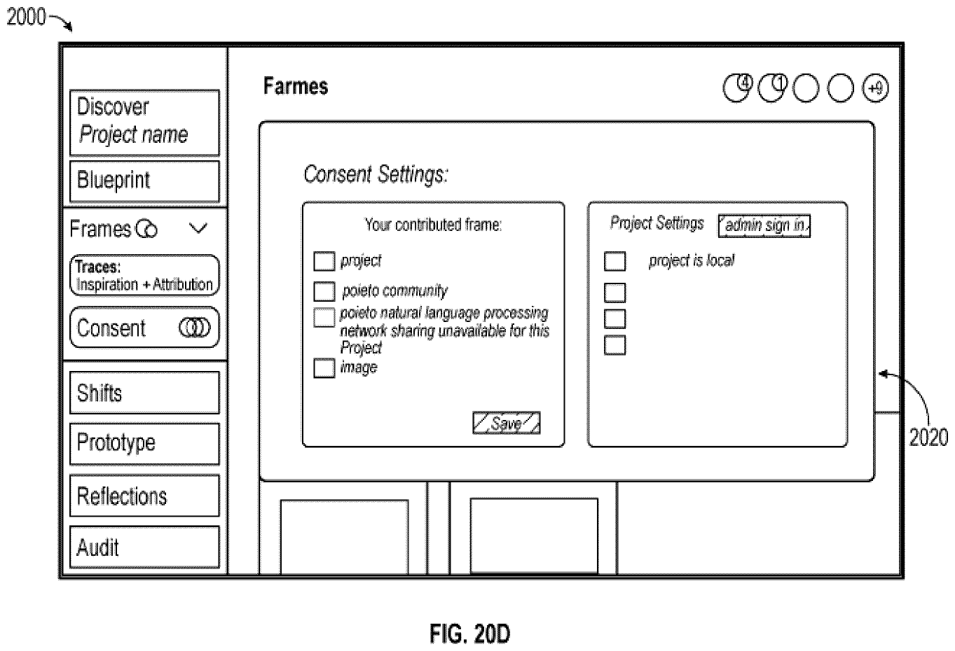

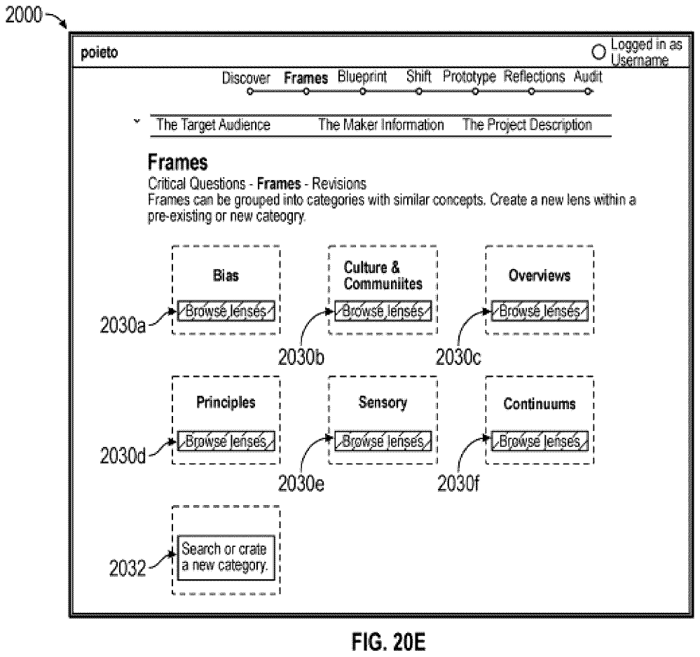

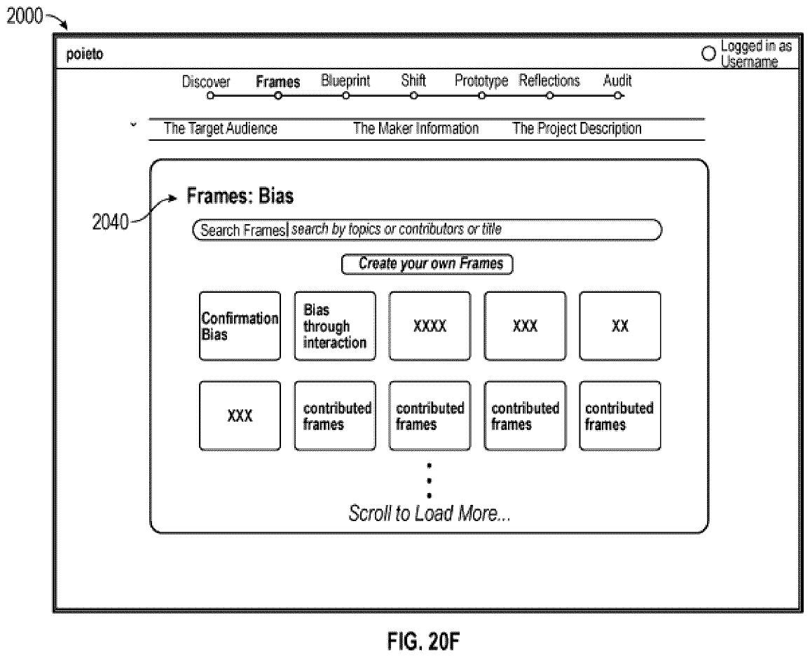

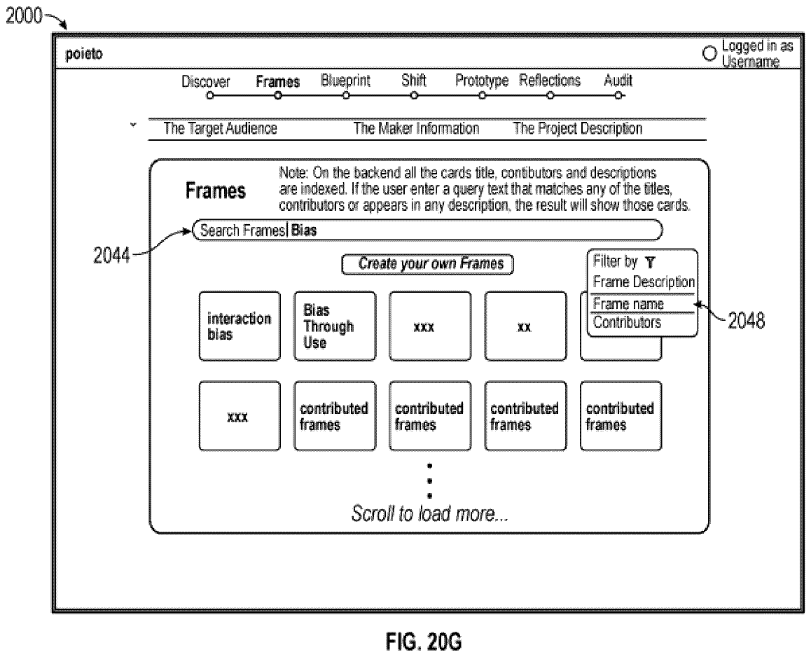

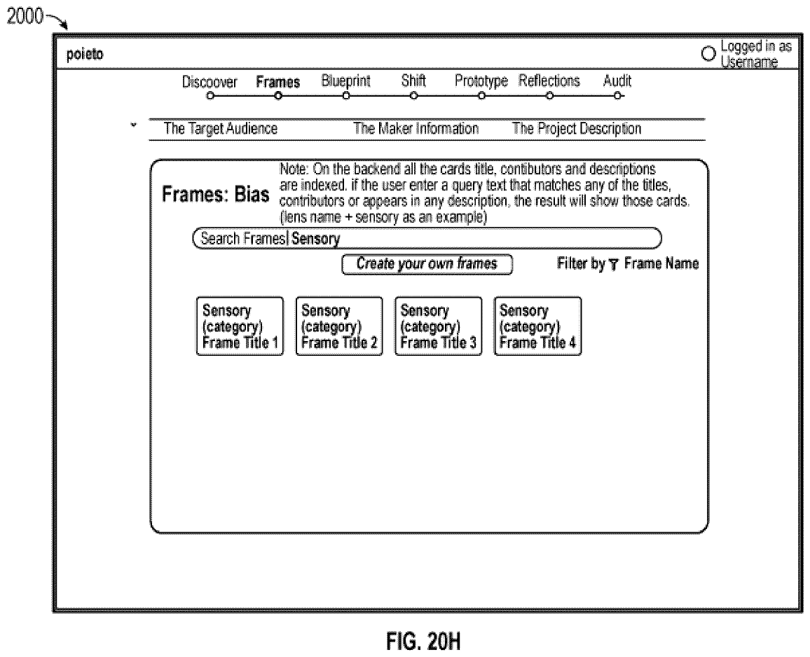

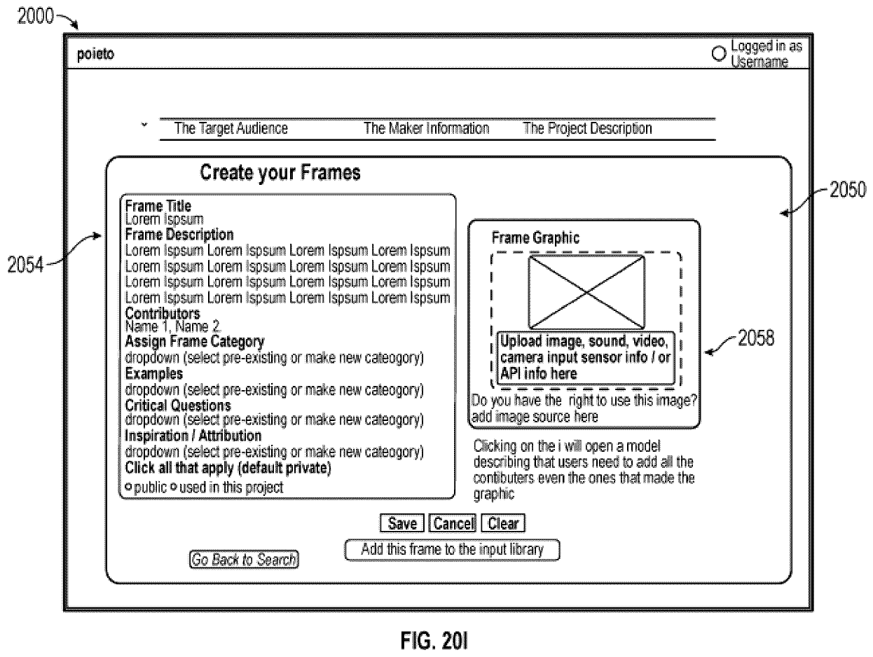

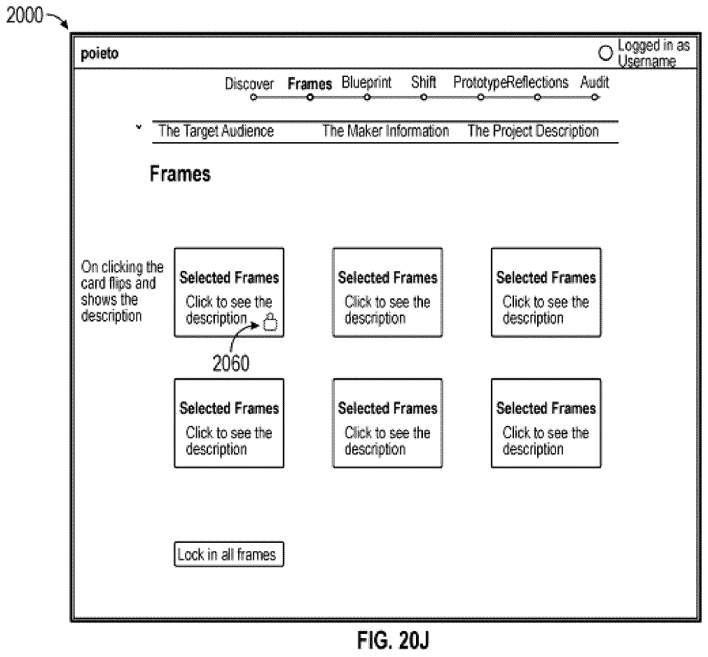

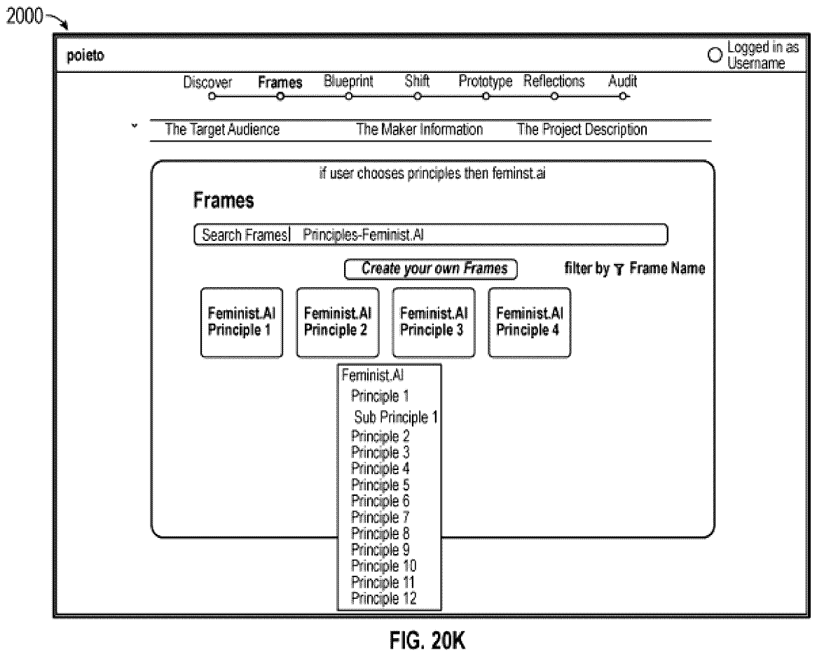

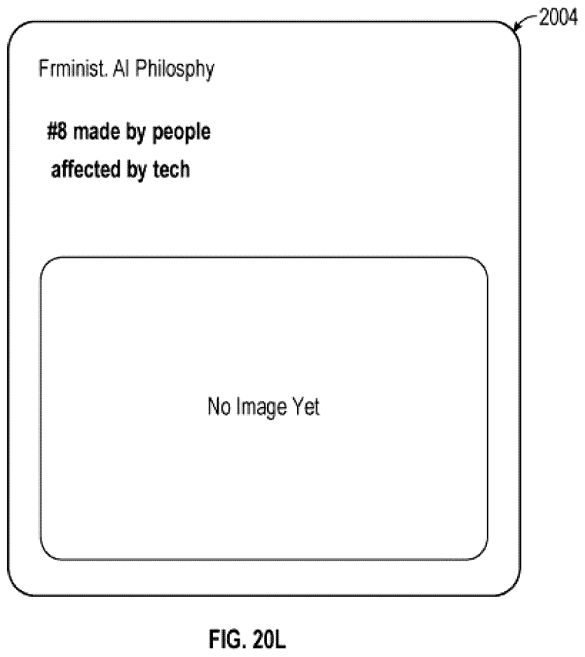

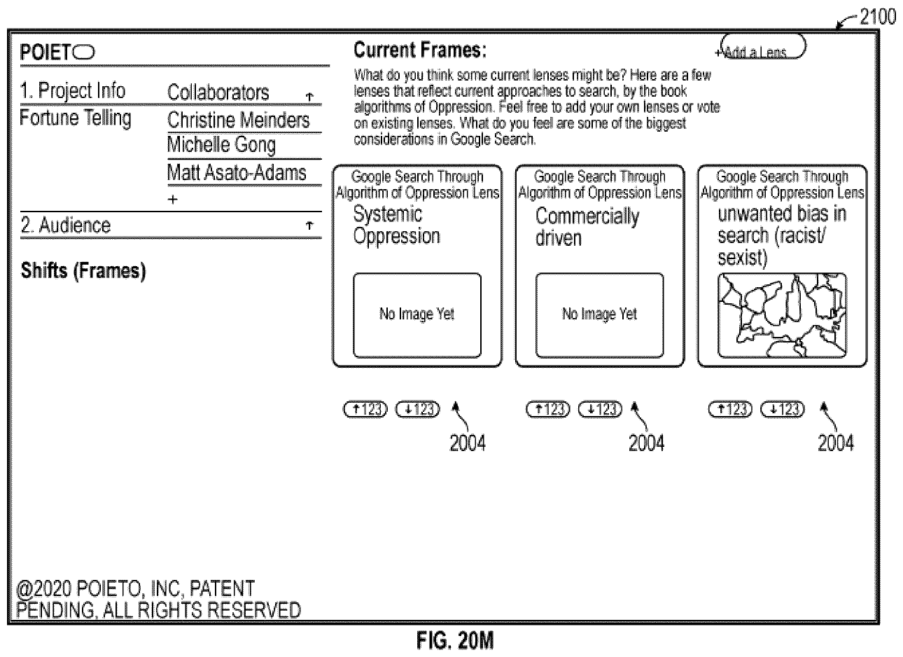

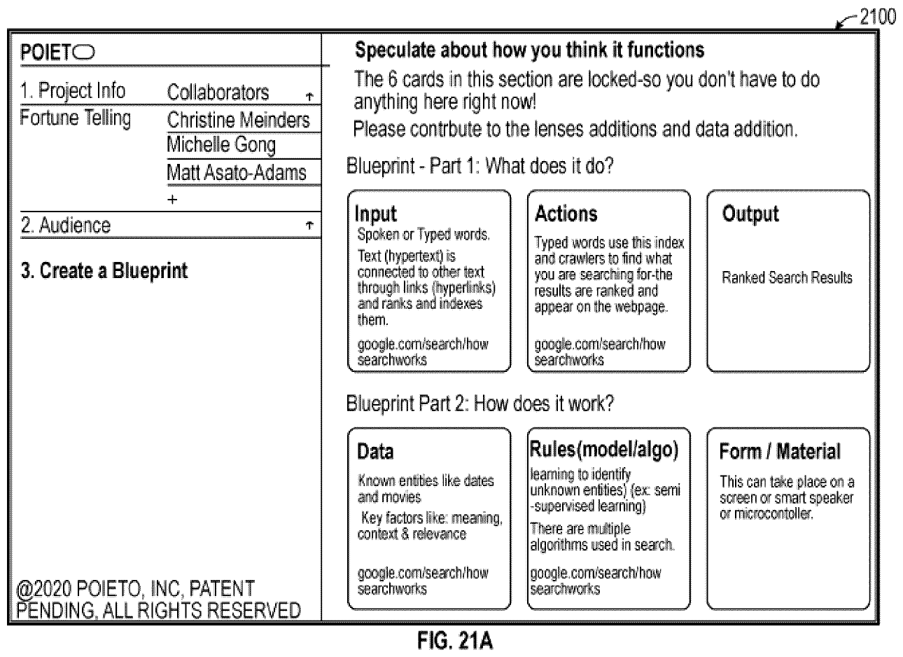

FIGS. 20A-20M illustrates exemplary screen shots relating to the frames/EKUs/EKUs section of the tool 2000. The social and community created frames/EKUs/EKUs 2004 help prototype through possible design futures. These frames/EKUs/EKUs may be used to describe existing approaches to technology, or may offer a “frame” shift-new approach to creating a tech project. Examples of frames/EKUs/EKUs 2004 include privacy, bias, time, level of connectivity and the like. The frames/EKUs/EKUs 2004 may directly affect a project if it requires changes in data or models, as discussed in further detail with respect to the data/model mapping section).

FIG. 20A illustrates an exemplary screen shot relating to the frames/EKUs/EKUs section of the tool 2000. Within the frames/EKUs/EKUs section shown in FIG. 20A and throughout the entire duration of the tool (the discover section, blueprint, shifts, prototype, reflections, audit-and any additional sections) illustrates a drop down section for traces 2008 (tracing the attributions and inspiration of those directly contributed to the portion of the project being created (showing what they did). The consent icon 2012 is off in this subsection of frames/EKUs/EKUs which is shown in a later screen as a pop out. The circle icons 2014 in the top right represent contributors. Although traces and consent are illustrated in the frames/EKUs/EKUs section, it will be appreciated that these can be part of any section (e.g., blueprint, discover, etc.)

As shown in FIG. 20B and discussed above, one aspect of the frames/EKUs/EKUs section 2000 is traces 2008. Traces 2008 show a ledger of inspiration and attribution 2016 for each section. As shown in FIG. 20C, one aspect of the frames/EKUs/EKUs section 2000 includes flagging and comments on sections of project 2016. As shown in FIG. 20C, the dark triangle on the right 2018 signals that someone has flagged a section for review. A comment may be added to provide context as to why the section has been flagged for review. The flagging and comments section 2016 may also incorporate rating systems used internally or when active as a user research tool when reviewing a corporate prototype. It will be appreciated that the flagging and commenting may also be a part of other sections of the tool (e.g., blueprint, discover, etc.).

FIG. 20D illustrates another exemplary screen shot relating to the frames/EKUs/EKUs section of the tool 2000 illustrating an exemplary screenshot of the consent section 2020. In the consent section 2020, the user can identify existent areas they give their consent to have their contributions used, they may also write in new suggested areas, and identify specific pieces of data to be shared, as well as how that information is shared (for example is it a local ml system, or cloud-connected).

As shown in FIG. 20E, the frames/EKUs/EKUs (filter, lenses) 2004 can be grouped into categories with similar concepts 2030a-f. A new frame can be created within a pre-existing category 2030a-f or a new category 2032. Each individual or group of people may contribute or add frames/EKUs/EKUs as they see fit. The individuals or groups adding frames/EKUs/EKUs may also be identified. The frames/EKUs/EKUs may be individual frames/EKUs/EKUs or a grouping of frames/EKUs/EKUs (pack).

As shown in FIGS. 20F and 20G, the frames/EKUs/EKUs may be searched. As shown in FIG. 20F, the frames/EKUs/EKUs may be searched by category (e.g., bias) 2140. Alternatively, as shown in FIG. 20G, a user may enter a search term in a search field 2044, which returns frames/EKUs/EKUs relating to that search term. For example, in FIG. 20G, the search term “bias” returns different frames/EKUs/EKUs relating to the “bias” search term. The frames/EKUs/EKUs may be indexed by title, contributors, descriptions, etc. such that a user can search by any of the title, contributor or description and any matching frames/EKUs/EKUs will be returned. The frames/EKUs/EKUs may be further filtered by frame description, frame name or frame description 2148, as shown in FIG. 20G. FIG. 20H illustrates an alternative search for frames/EKUs/EKUs matching the search term “sensory.” In some embodiments, the frame search results return a display with only the title of the frames/EKUs/EKUs. In other embodiments, the contributors and/or descriptions may also appear in the search results.

As shown in FIG. 20F-20H, the frame entry point examples identifies where individuals can search and add frames/EKUs/EKUs. The card may include the contributors, descriptors and other relevant information (on the front or back of the card); this information is indexed for search purposes. The group of contributors may also be grouped into groups (i.e., a whole bunch of icons in another icon).

FIG. 20I is a detailed view of an exemplary screen shot of a user interface for creating an exemplary frame 2004. As shown in FIG. 20I, the frame card information and headers can be added or renamed 2054. Examples of the frame card information 2054 include the frame title, frame description, contributors, frame category, examples, critical questions, inspiration/attribution and whether the frame is public or private. The frame may also include a graphic or other files 2058 may be added to the frame. These files may be, for example, direct audio/video, images, videos, APis, sound, sensor info, etc. It will be appreciated that the files may be uploaded or searched for and taken from other frames/EKUs/EKUs, data, input, cards, etc.

As shown in FIG. 20J, the user can lock in 2160 one frame or many frames/EKUs/EKUs as a group of frames/EKUs/EKUs. Comments can also be added to one frame or a group of frames/EKUs/EKUs. In one embodiment, the frame may be displayed with a description of the frame only and selecting on the frame will display additional information about the frame.

As shown in FIG. 20K, users can also search by philosophy. For example, as shown in FIG. 20K, a user may search for frames/EKUs/EKUs relating to the values or philosophy of an organization. For example, as shown in FIG. 20K, the search may be for a feminst.ai philosophy as a whole or may pull specific pieces of the philosophy.

FIG. 20L illustrates a detailed view of a frame card 2004 contributed to by Feminist. AI members. This exemplary card incorporates principle #8 (visualization of the Feminist. AI philosophy that people directly affected by tech should be making the tech).

As shown in FIG. 20M, the frames/EKUs/EKUs can be used to help remake a project (such as a search algorithm) to identify current assumptions in the design process through different frames/EKUs/EKUs (lenses). Here, the current frames/EKUs/EKUs 2004 are pulled directly from the book Algorithms of Oppression by Safiya U. Noble as applied by (or processed by) the Feminist. AI community. All too often in tech, there is a prominent focus on the software—and its developers are well compensated for their labor regardless of whether the things they create have problematic aspects to them. Academic and community work is not being used to make software better nor are such practitioners in these areas compensated for their labor. The tool fully integrates this course correction into the design process in a way that is publicly recognized and can be financially compensated using the frames/EKUs/EKUs 2004. This can be incorporated in the blueprint section or other sections/actions of the tool.

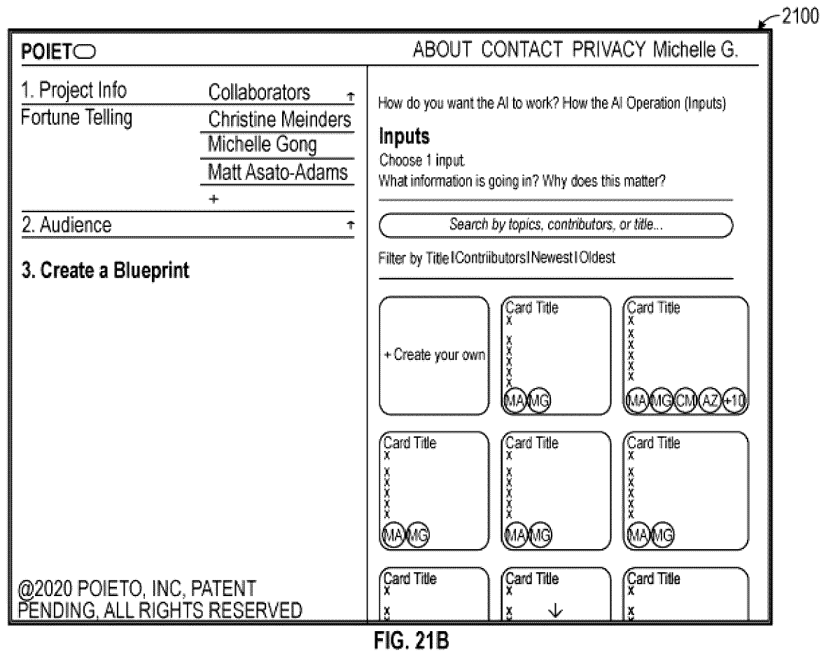

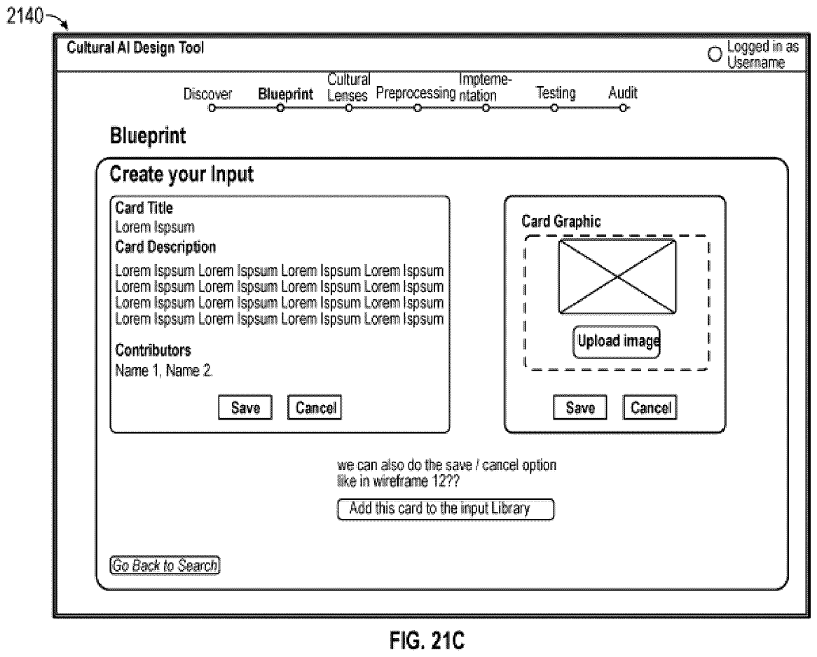

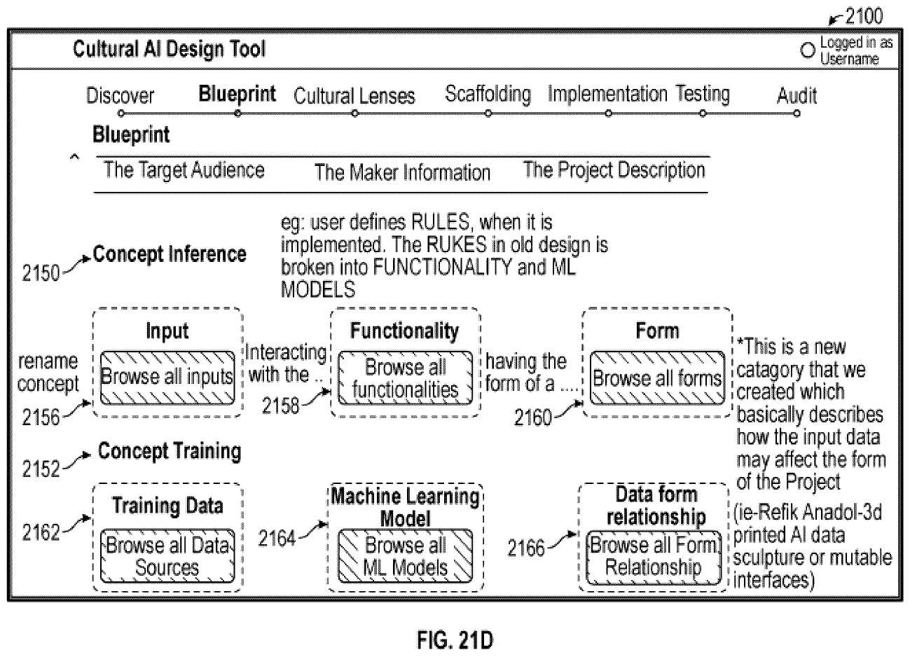

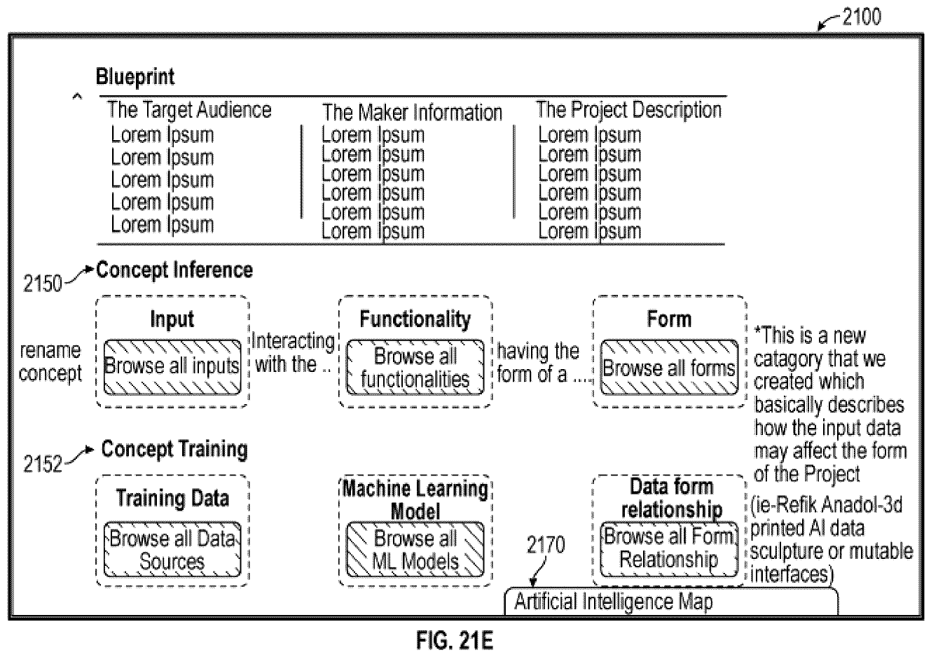

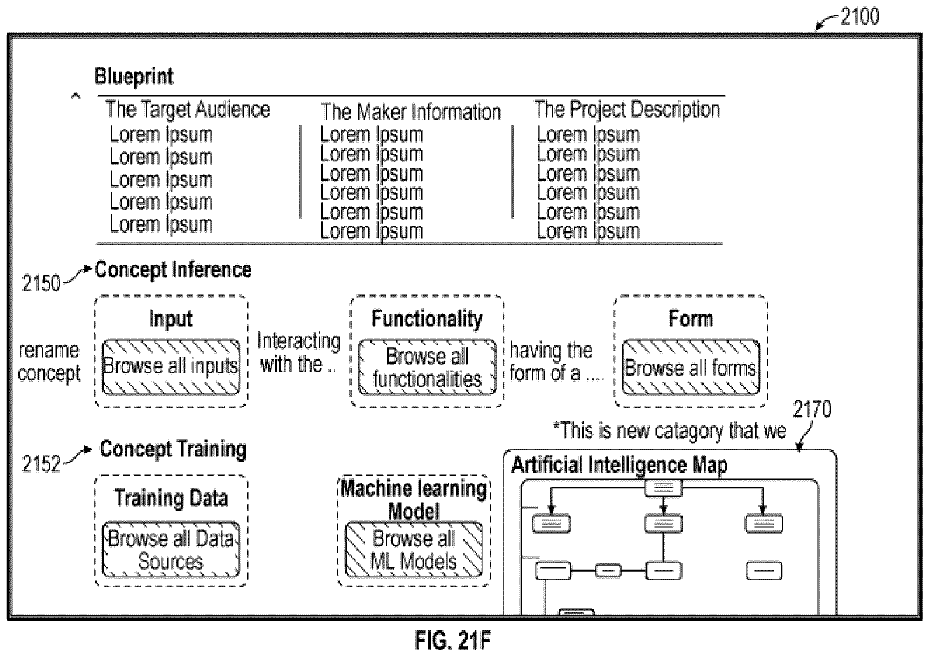

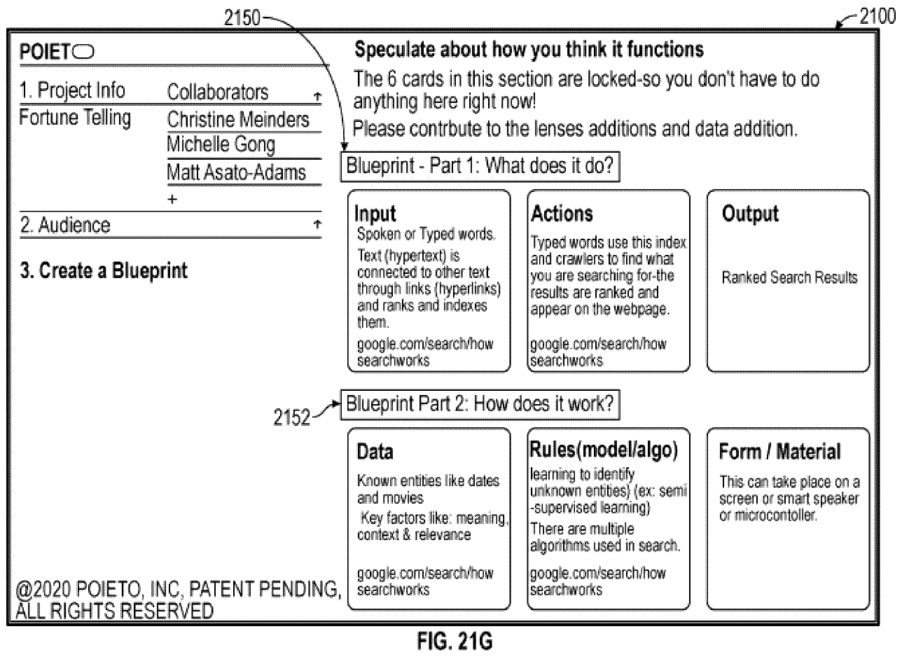

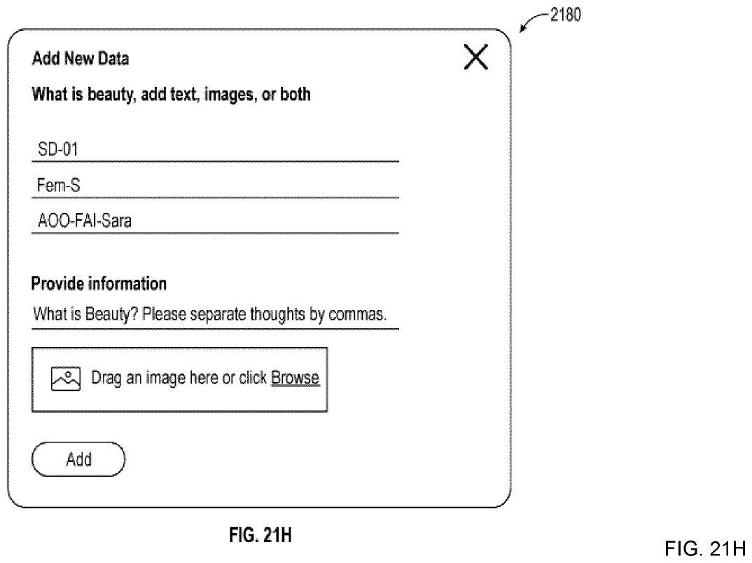

FIGS. 21A-H illustrate exemplary user interfaces relating to the blueprint section 2100. As shown in FIG. 21A, the “create a blueprint” section of the tool is shown. In this section, users can identify what is going into the system or add what they think goes into the system and open it up to community to contribute. In the actions section, the tool looks at functionality as well. Users may also rearrange the cards, which may include input, actions, output, data, rules and form/material as shown in FIG. 2lA. The user defines the rules, but then the rules are broken down into functionality and model. The input may “interact with the actions/functionality”, and has the form of a specific output or outputs. These sections may be moved around, locked and commented on.

As shown in FIG. 2lB, the community can also contribute information and groups can collaborate together. The mechanics of community sourced input is expressed in how a team may collaborate from the very beginning or pull from community sourced data. This process can be replicated throughout the blueprint section. In this example, the creators may create their own cards for the input section. Here you see the creators (who have agreed to be identified) on the cards. This process can be replicated through the blueprint section.

FIG. 21C illustrates an exemplary input card 2140. As shown in FIG. 21C, the card may include images, but similar to the frames/EKUs/EKUs card, users may add an API, sound, sensor input, live video, audio, mp3, etc. The uploads may be audio/video, image, video, API, sound, and/or sensor info that can be uploaded or searched for/taken from other frames/EKUs/EKUs, data, input, cards, etc.

As shown in FIG. 21D, the blueprint section 2100 includes concept inference 2150 and concept training 2154. As discussed above, users define rules when it is implemented. The rules are broken into functionality and machine learning (ML) models. As shown in FIG. 21D, in concept inference 2150, the input 2156 “interacts with the actions/functionality” 2158, and has the form of a specific output or outputs 2160. In concept training 2152, the concept is trained using one or more of training data 2162, ML models 2164 and data form relationship information 2166.

As shown in FIG. 21E, this section provides an example of the position/orientation map pop-up 2170 of FIG. 2lF in a collapsed state. FIG. 2lF shows the position/orientation map 2170 in the expanded state. The position/orientation map 2170 identifies where the participant is in the design process.

As discussed above and shown in FIG. 21G, the blueprint section 2100 includes two aspects:-what does it do (inference) 2150 and how does it work (training) 2152. It will be appreciated that the input data and material may affect the form or experience of the project.

FIG. 21H illustrates an example of the data collection card 2180. Users may add elements to this card 2180 or remove elements from this card 2180 As shown in the exemplary card 2180, the users may provide information about “what is beauty” and images or other files (e.g., APIs, sound, sensor input, live video, audio, mp3, etc.) can be added. The data in the data collection card can be source data or “retraining” data.

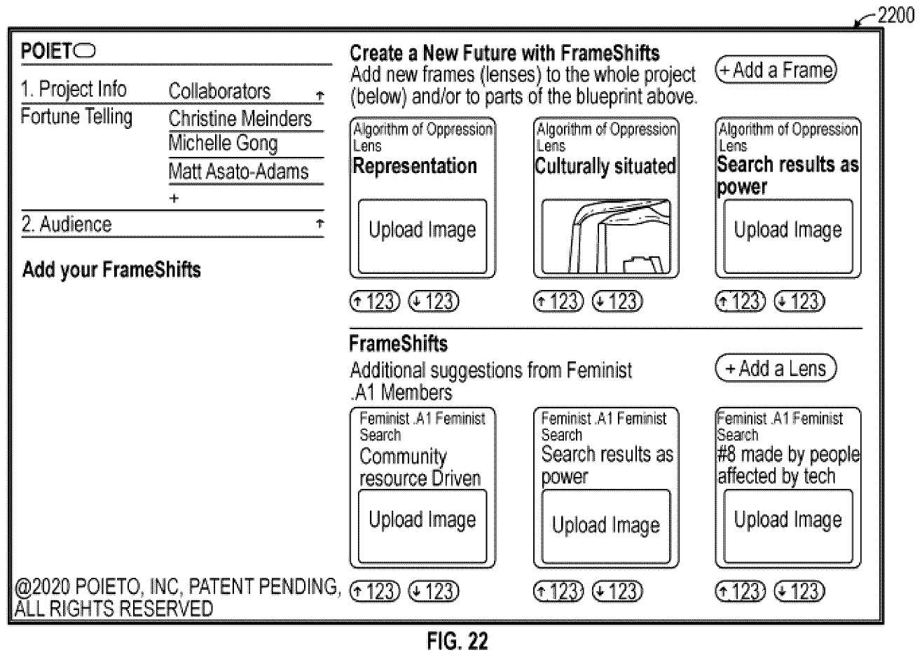

FIG. 22 illustrates an exemplary use of the tool to shift an existing frame or recommend a new frame (i.e., frameshift) 2200. As shown in FIG. 22, a user can add as many layers (grouping) of frames/EKUs/EKUs or individual frames/EKUs as needed. In FIG. 22, the first row illustrates a set of frames/EKUs offers new perspectives from the Algorithms of Oppression Lenses book by Safiya U. Noble-here we ask, what if we designed for positive representation, multiple culturally situated searches, and use search as a form of community power. The second row illustrates additional frames/EKUs suggested for the project. In this section, people may revisit previous project information-like the frames/EKUs-and may offer a shift in that thinking. The frames/EKUs may come from an individual, a book, a group of people, etc. and people may login and suggest or remove frames/EKUs.

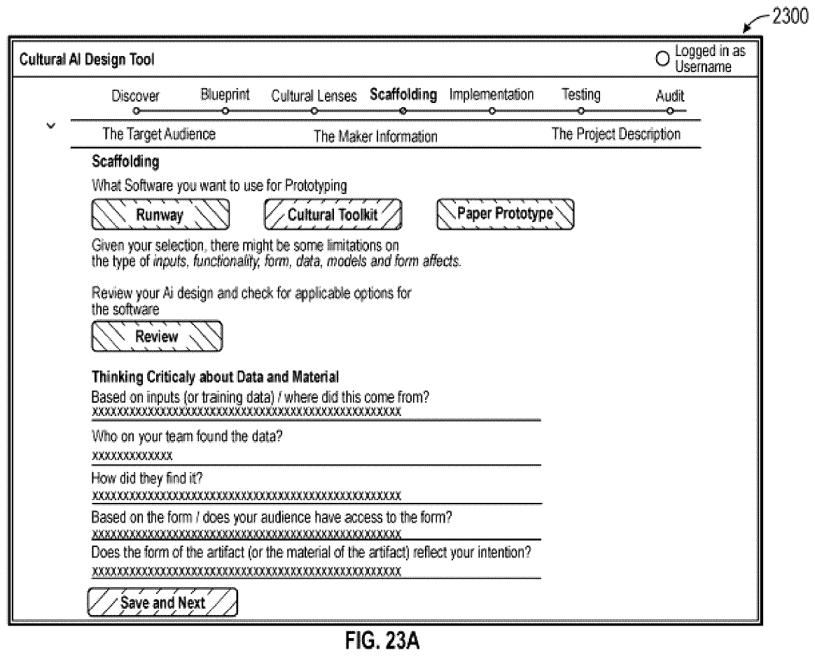

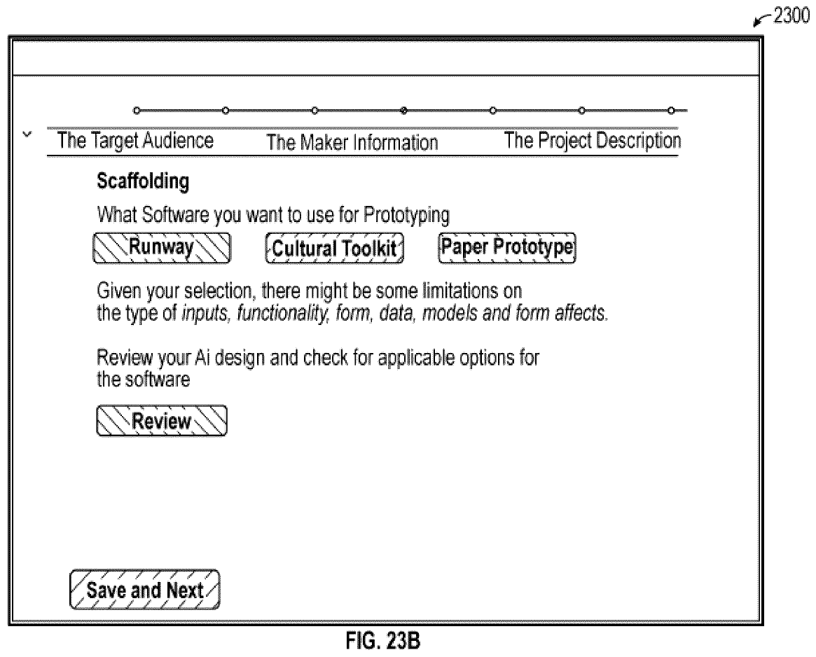

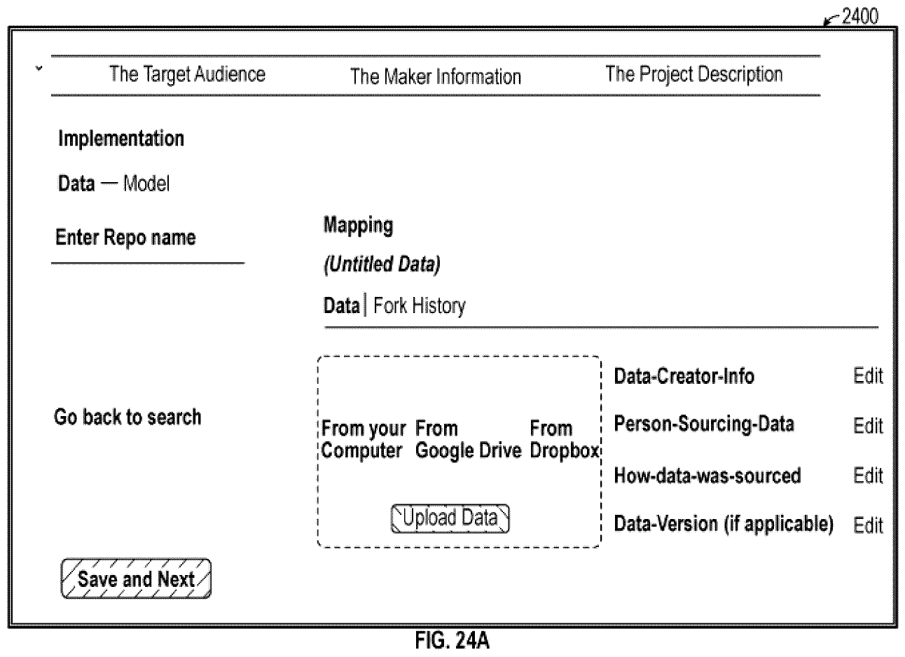

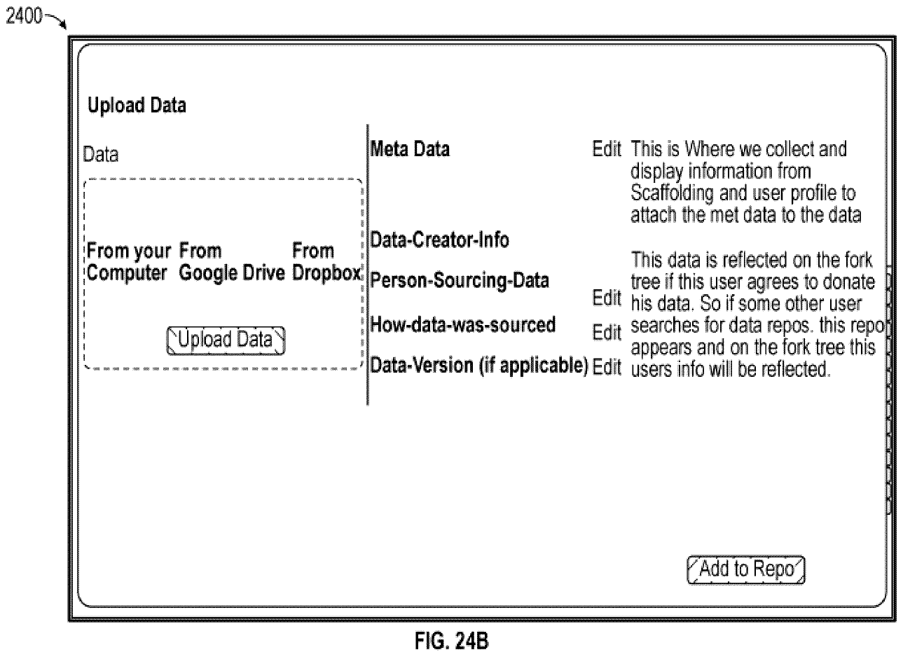

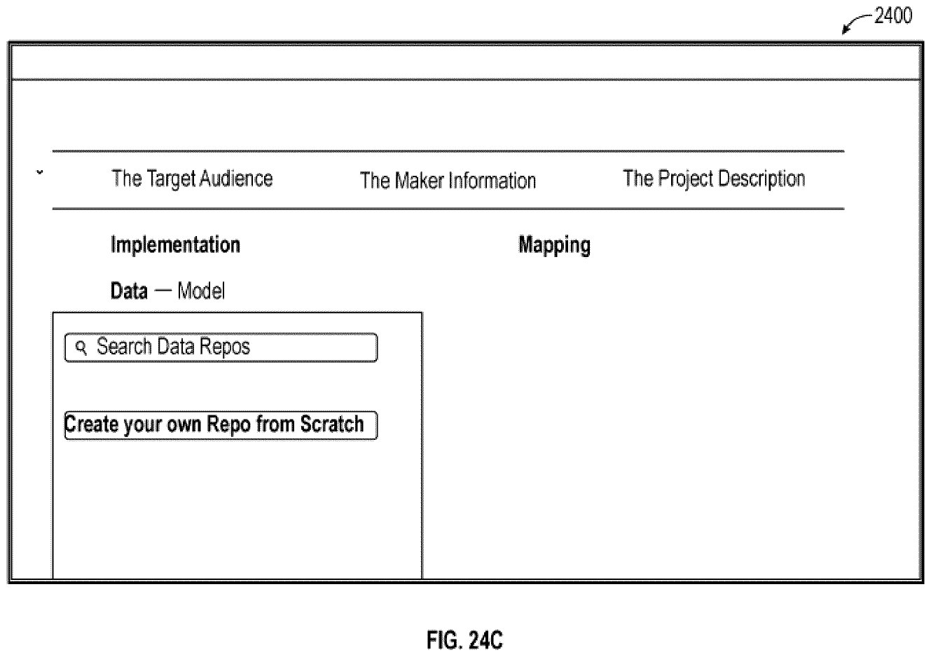

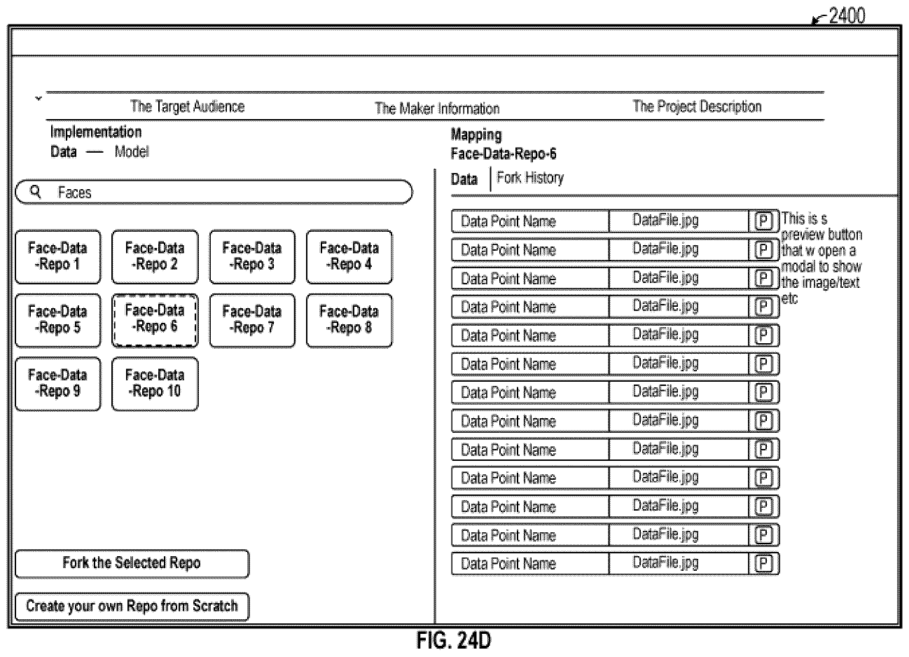

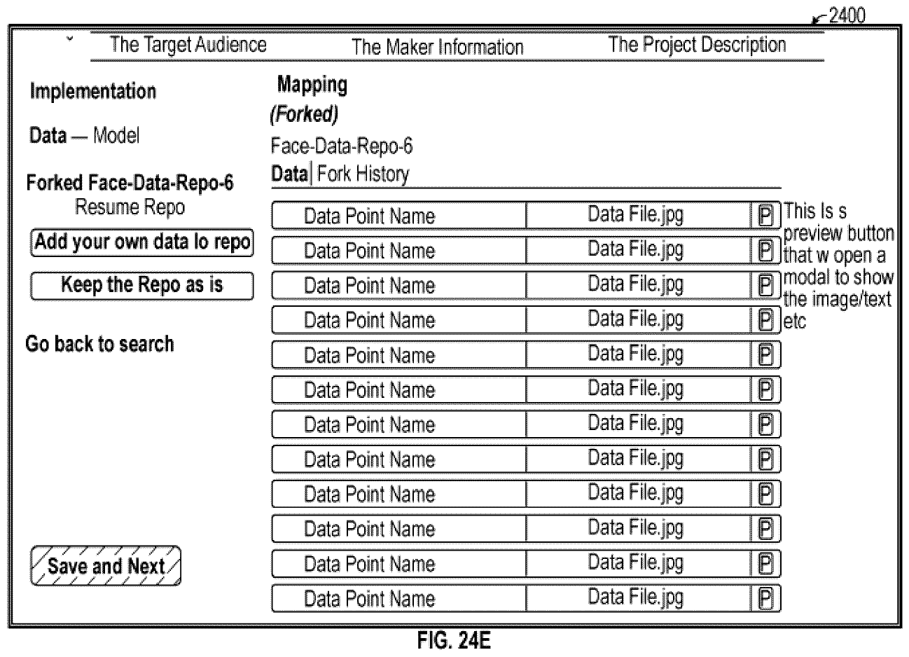

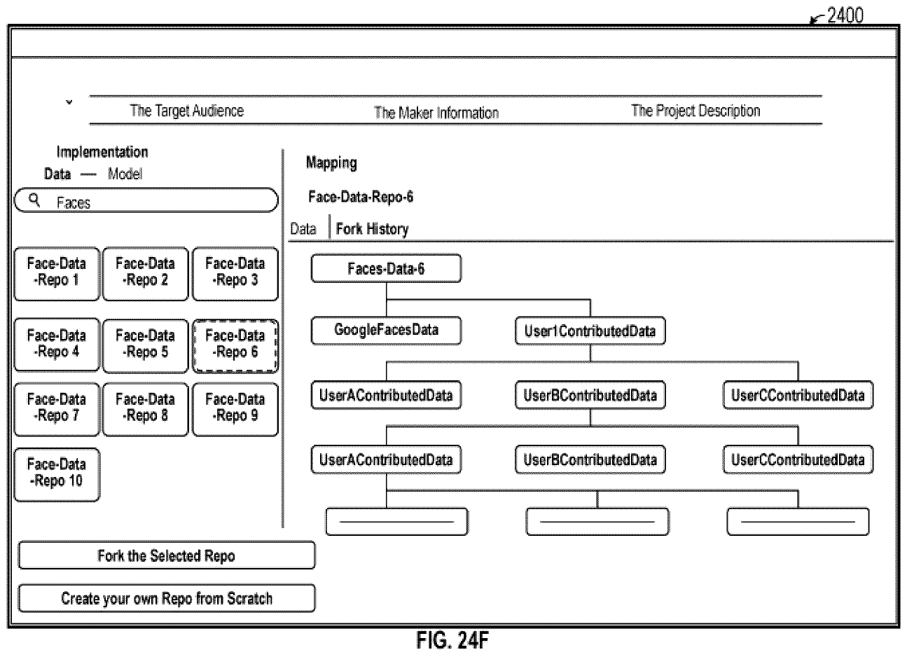

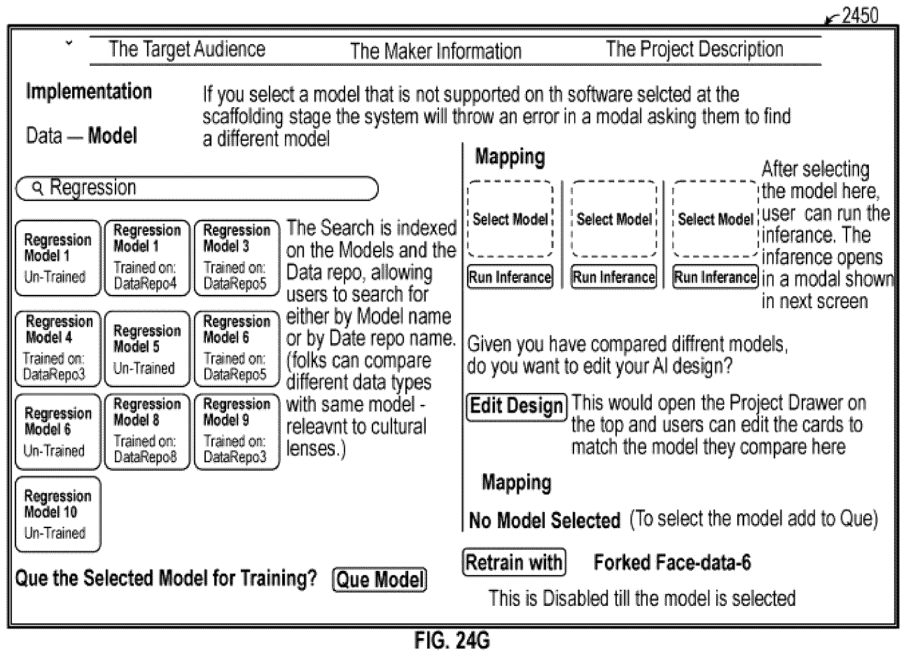

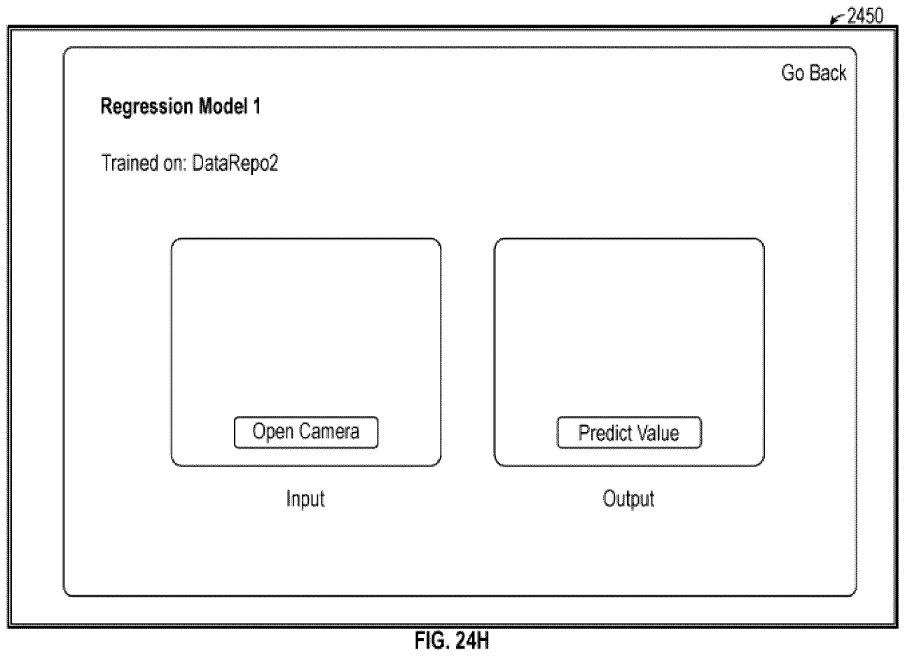

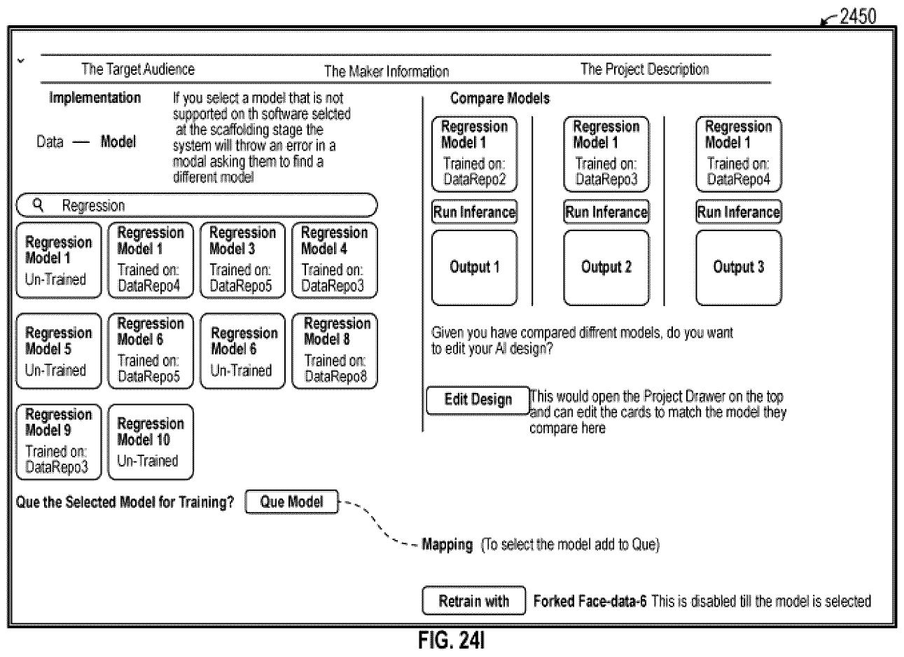

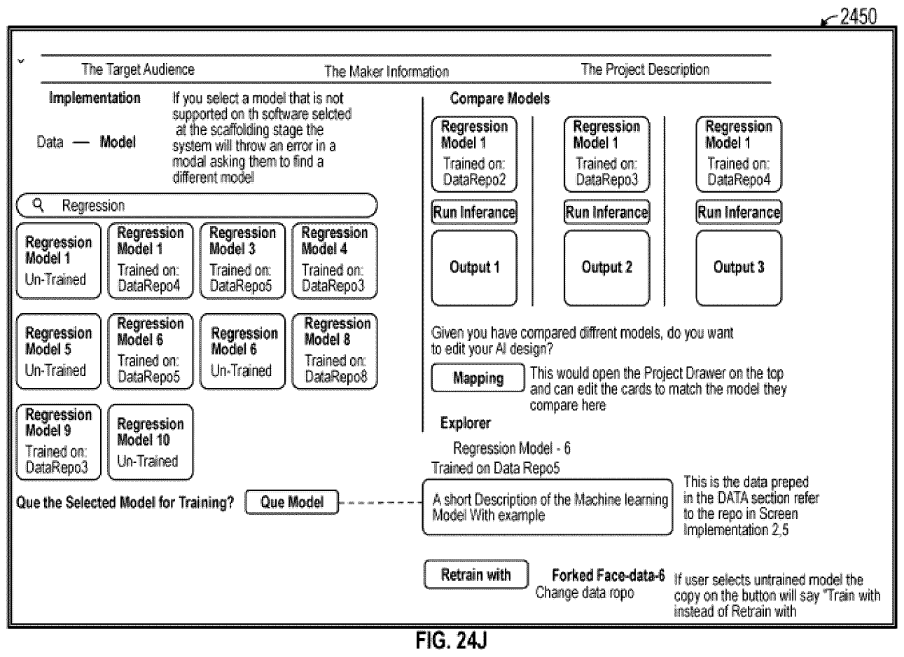

FIGS. 23A-23B, 24A-J and 25 illustrate examples of the prototype section of the tool, which includes scaffolding, implementation (data and model), and activation (also understood as testing) modules.

FIGS. 23A and 23B illustrate an example of the scaffolding section of the tool 2300. In the scaffolding section 2300, a user identifies integration with potential software. In this section, the user identifies the compatibility with other tools or sections of the collaborative software tool sections (and the ability to integrate with those sections). For example, if a user is using runway ml, but wants to upload audio data, when they get to data uploads, a warning will appear about compatibility and make suggestions regarding other options. The project creator may also use the models or algorithms built within (or local to) the tool itself

FIGS. 24A-F are exemplary user interfaces relating to the data uploading implementation section of the tool 2400 and FIGS. 24G-J are exemplary user interfaces relating to the model implementation section of the tool 2450.

As shown in FIG. 24A, in the data implementation section 2400, a user can create/upload data from an existing dataset locally, a remote or networked dataset, or may input an APL FIG. 24B illustrates an exemplary upload process. On the design card, the user can see the history of the model, how it was made, who contributed, and at what point it was changed or updated. For example, the user may load a csv or excel file exported from unity, containing movement (e.g., information from an accelerometer sensor). Rating of various objects in unity (sound, visuals, videos, patterns, etc.)—focusing on more embodied approaches to data collection. The user may also upload data from those in their network (it may only be available to them via their drive). Here, the creator is asked creator and sourcing information (i.e., who is sourcing the information including, for example, social and background information). FIG. 24C illustrates an example where the user can explore or map the data and model section. As shown in FIG. 24D, the user may incorporate a data repo that already exists (e.g., via github, gitlab, internally with a group data network). The user may also see previous versions of the data (e.g., data updated or retrained by the Feminist.AI community). As shown in FIG. 24E, the user can add their own data to the data repo, and work with their own forked data. As shown in FIG. 24F, the user can select the model within the repository—then the toolkit shows the history of the model, how it was made, who contributed, and at what point it was changed or updated.

FIG. 24 G-J show the model implementation section 2450. The model implementation may compare different models with one dataset, or one model with different datasets. As shown in FIG. 24G, the user can run inference on various models (with one data set) and can also engage in the reverse (where they use various datasets on one model and compare). If a user selects a model that is not supported by the software selected in the scaffolding section, the tool will throw an error in a model requesting that the user select another model. The search is indexed on the models and the data repository, allowing the users to search either by model name or data repository name (and can compare different data types with the same model relevant to the individual or community created frames/EKUs (lenses)). After selecting a model, the users can run the inference. The inference opens in a modal shown in FIG. 24H. The “edit design” button opens a project drawer that allows users to edit cards to match the model. FIG. 24H illustrates an example of a model instance being run. FIG. 241 illustrates an example of an implementation model search. In this section, users can queue various models and retrain with a specific dataset. The dataset is disabled until the model is selected. FIG. 24J illustrates an implementation model search where a particular model has been selected.

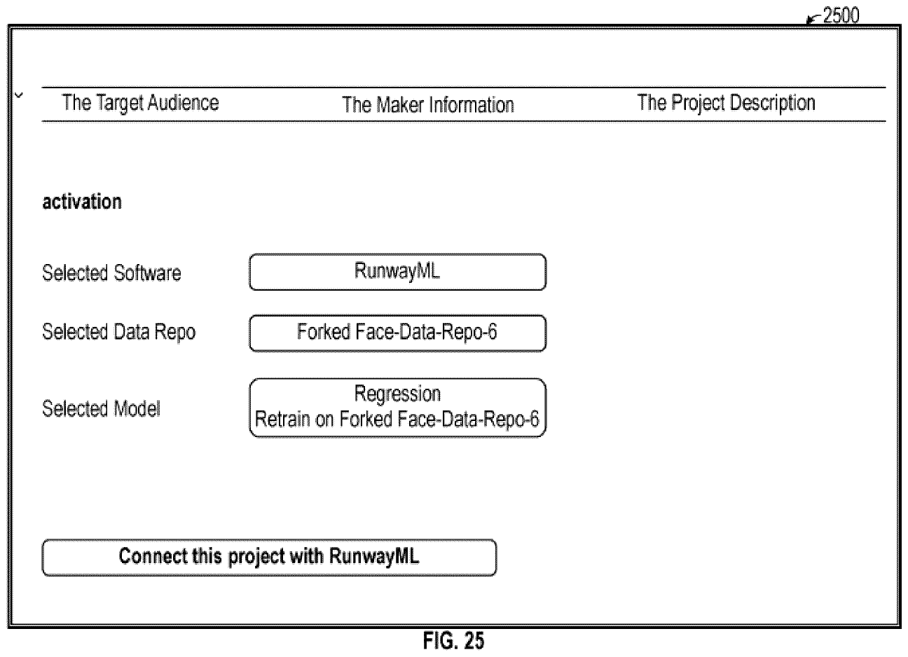

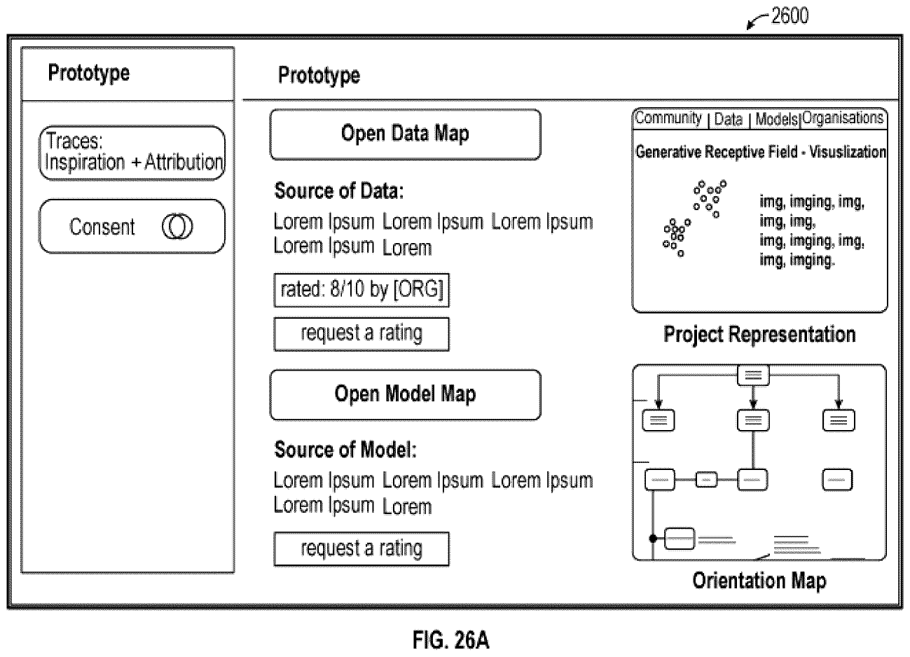

FIG. 25 illustrates an example of the activation (testing) section 2500 of the tool. In this section, the user identifies any software integrations, models and data. If there are any issues here, suggestions are made regarding alternative models, data, etc. User may be redirected to other sections or required to update data or data parameters. Here, the user may connect their project with external software (if it has not already been connected).

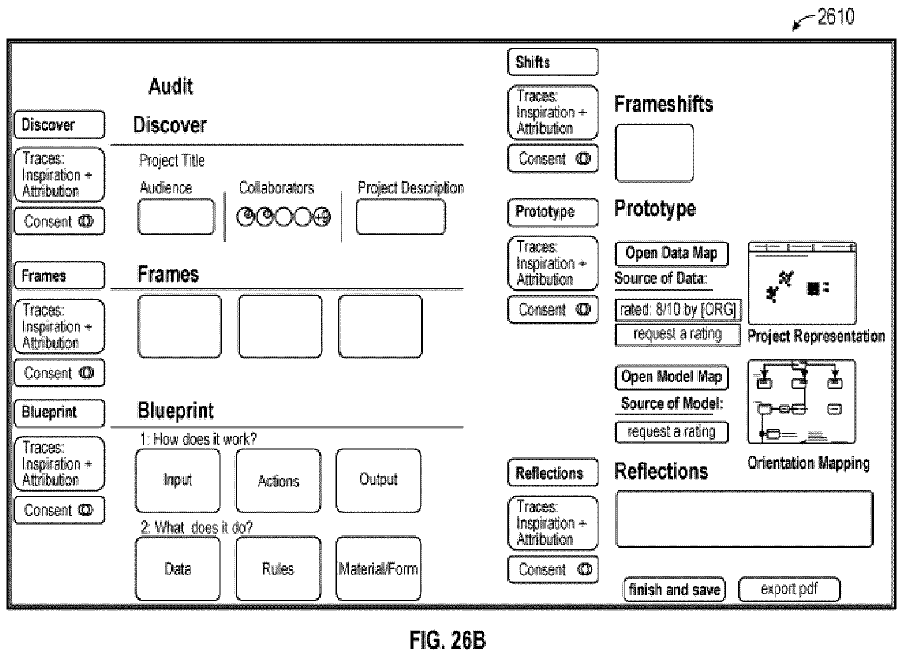

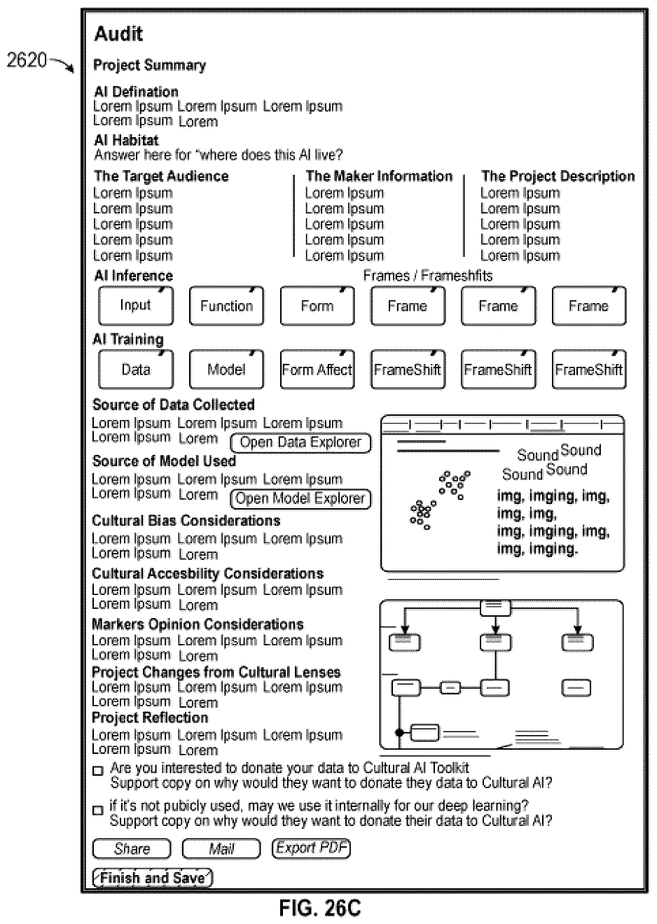

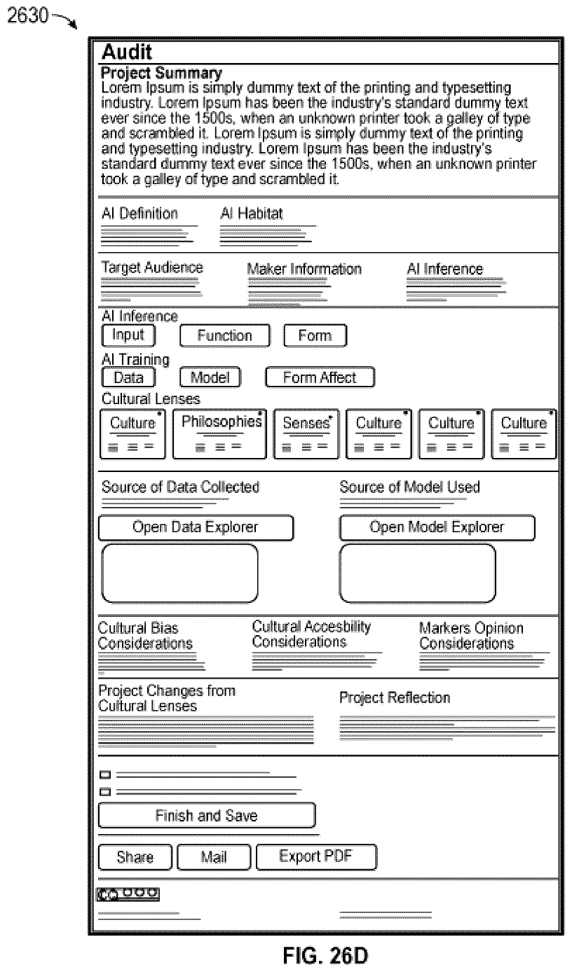

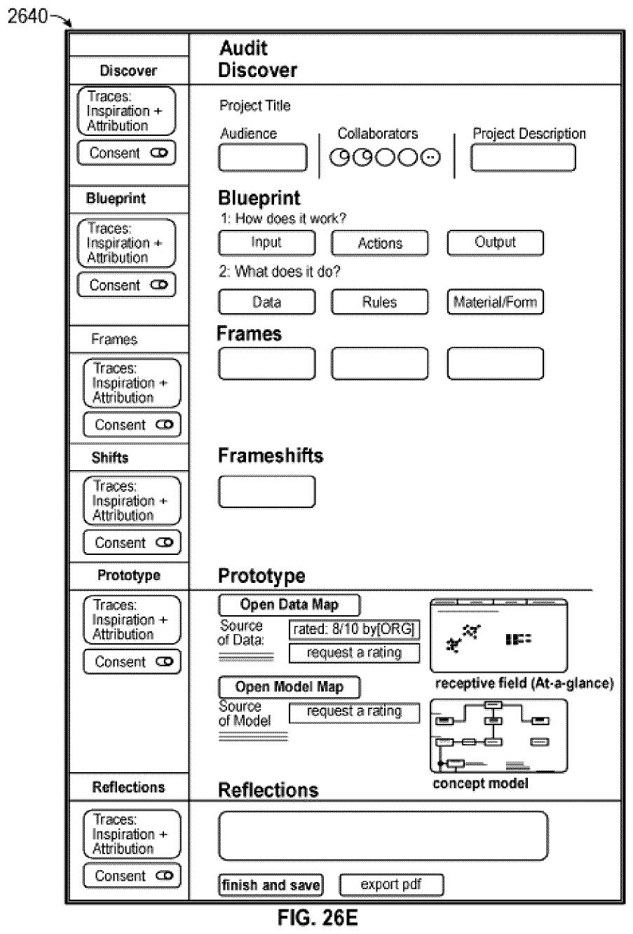

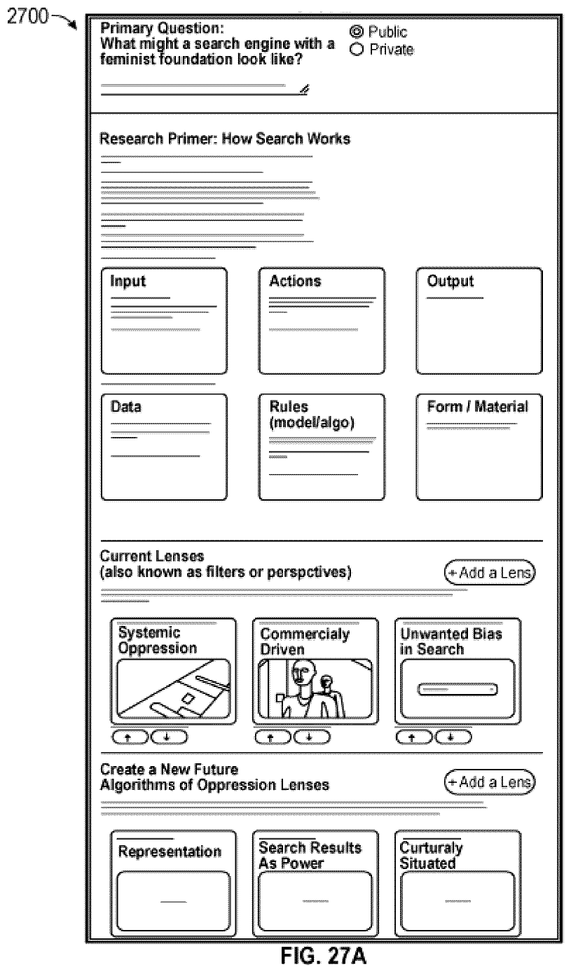

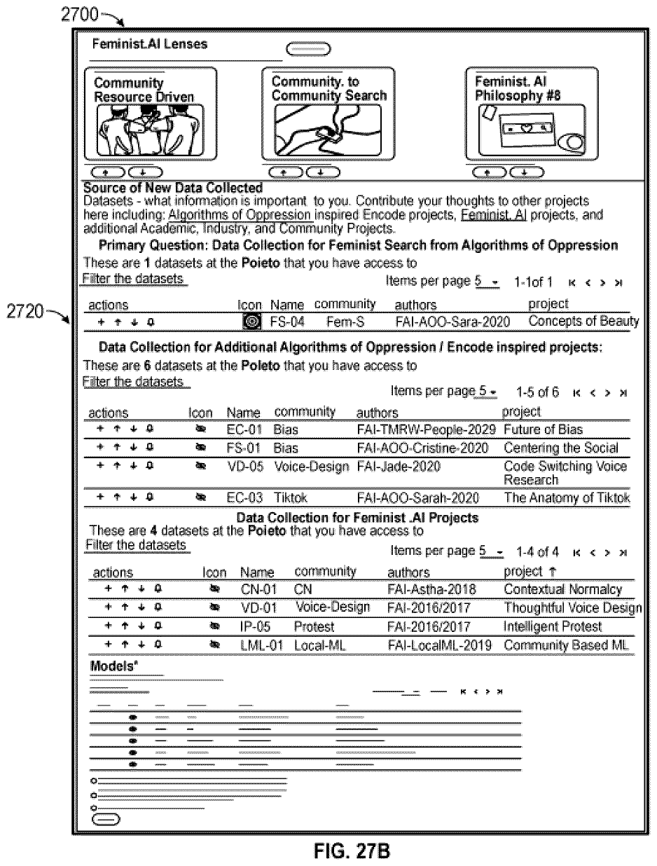

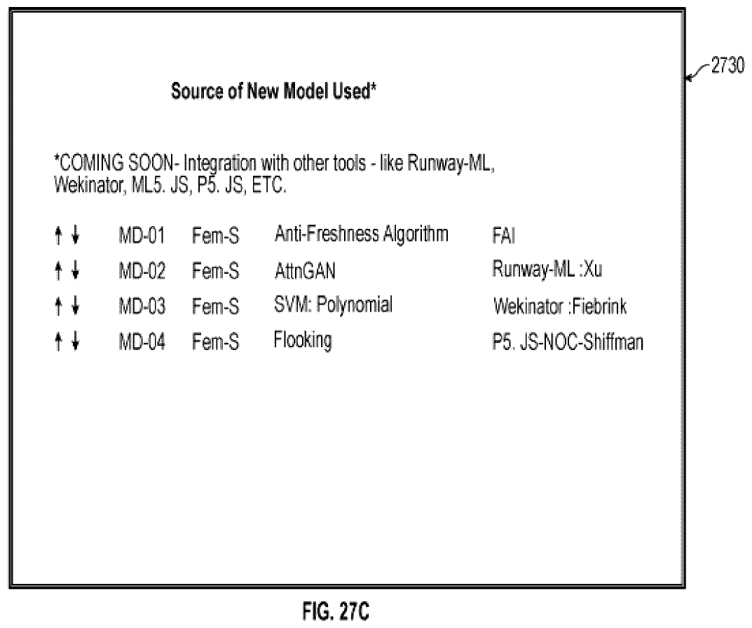

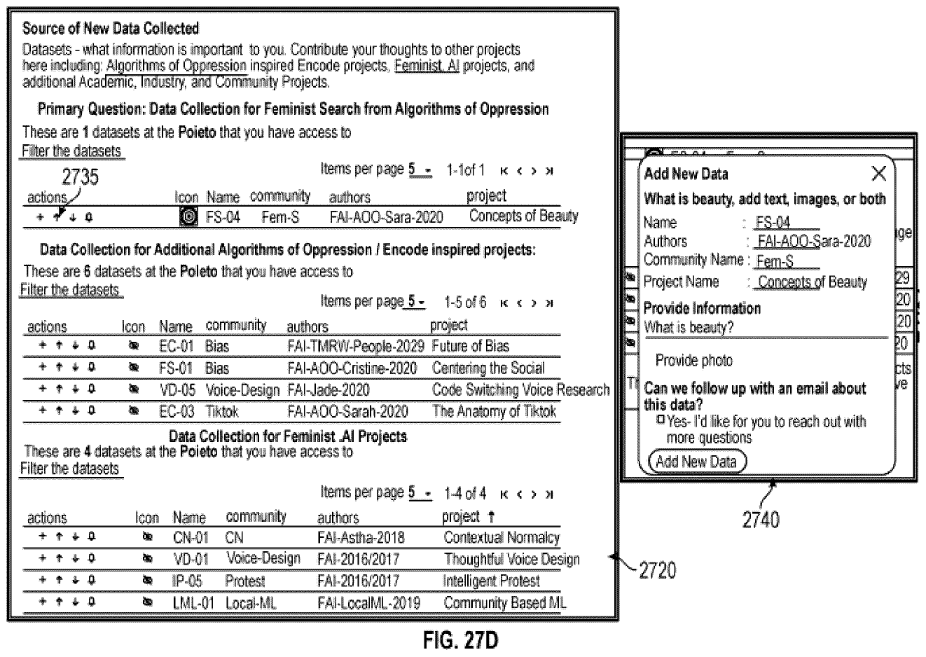

FIGS. 26A-E illustrate alternative variations of the audit section (2600, 2610, 2620, 2630, 2640) of the tool. This section may also include an at-a-glance section (project representation)—where there is a sensory (or accessible) entry point to the project—through a visualization, sound or sensor output that represents the whole project—through visuals or other sensory inputs/outputs, where the user can add information that is important to the final project representation card. In the audit section of the tool (in this case, the project representation), the user can see the state of diversity of dataset and the various considerations. On the screen, this is the section that “pops out” to represent various projects. The final snapshot identifies who was involved and their decision making. The final project asks people to socially position their work and describe where it lives. The audit section allows for the project to be viewed holistically, commented on, connected with—here the project can show some of the frames/EKUs and considerations made during the design process, look at the consent section, inspiration, comments, flagging and rating sections, as well as ask people to consider the social implications of the project, where it may live, and if there is a disconnect between the users and creators. This audit section provides a view (or recap) of the data, algorithms, software and lenses used in the project. The visualization sound (earcon) of the project summary shows the project representation (visual, sound, etc.) poiesis/imprint and can be realized on paper, screen, via VR and AR or may be embedded or stored in objects. Users can add headers to the project representation section of the audit section based on the project and any additional categories pulled from the methods/landing page. FIGS. 26A-C also include the orientation/position map. FIG. 27A-Dare exemplary user interfaces that illustrate a project page 2700, which incorporates data collection section (for a specific project or related projects), showing that projects can be grouped by non-profits, academic institutions, project type, the individuals creating the project or own the project and the like. The tool provides a place to collect data and make critical projects with input from communities, as shown in FIGS. 27A and 27B. The tool provides a place to collect data and make critical projects with input from communities. Communities contribute and this this information can be used in education programming of the tool. Projects from this information page can be remixed or used in the tool (if consent is given). As shown in FIG. 27C, a user can click on existing models or suggest new ones in the sources of model section 2730, like the anti-freshness algorithm or link out to something like runway ml, or p5.js to incorporate with the project. Rather than using google search to reimagine google search, a user can do it with, for example, Wekinator, Runway ML, or p5.js. In the data collection information shown in FIG. 27B and reproduced in FIG. 27D, a user can contribute information to existing algorithms of oppression inspired or Feminist. AI projects. For example, they can contribute by checking the plus button 2735 in the data collection section 2720 to launch a data contribution card 2740, as shown in FIG. 27D.

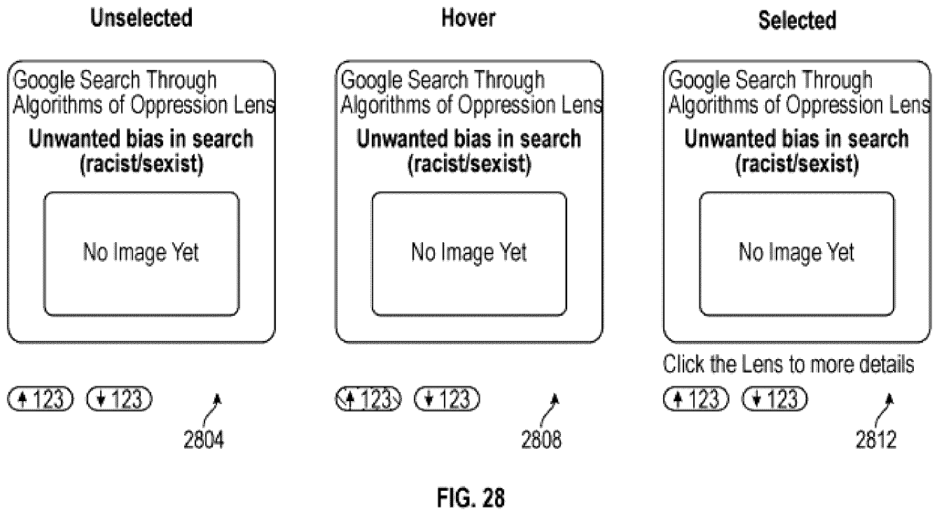

FIG. 28 illustrates the card selection states within the tool, according to an embodiment of the present disclosure. As shown in FIG. 28, exemplary card selection states include unselected 2804, hover 2808 and selected 2812.

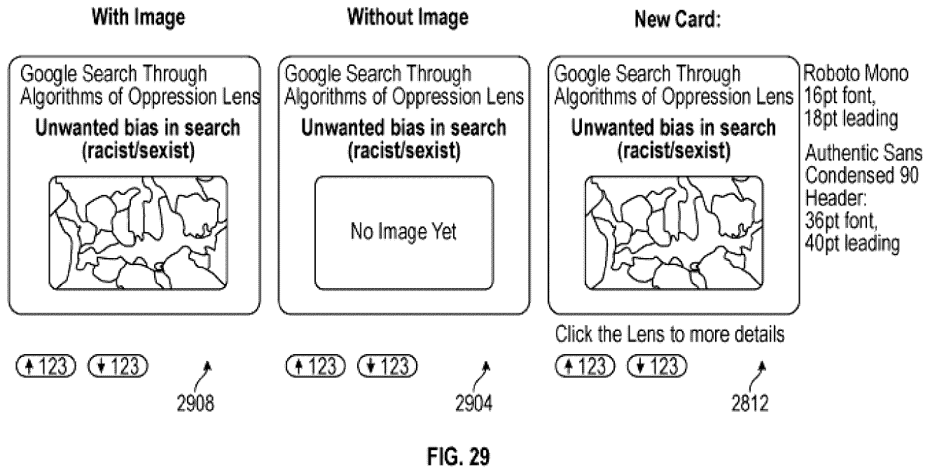

FIG. 29 illustrates examples of types of data collection cards including blank cards 2904, cards with an added image or other input (such as a sound, API, etc.) 2908, and a new card 2912.

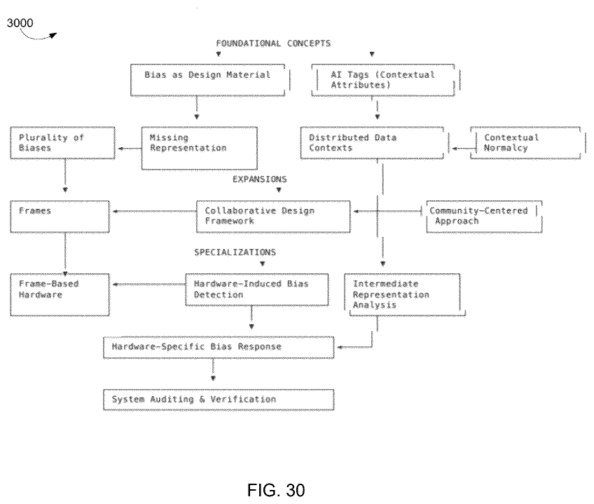

FIG. 30 is a block diagram of the interrelation between concepts used in the system, according to an embodiment of the present disclosure. As shown in the block diagram 3000 of FIG. 30, foundational concepts may undergird the foundational technologies employed by the systems, devices, and methods of the present disclosure. These foundational concepts may be expanded upon by the expansion concepts and the specializations depicted in FIG. 30. The interrelation between concepts used in the system shown in FIG. 30 is an example of how the system may be organized. Other configurations of the system may be used.

### Conceptual Hooks

The frames/EKUs approach described herein may be applied across various dimensions, including potentially across temporal contexts. The system can collect usage data of user selections... over a plurality of usage instances. Bias characteristics may therefore evolve over time. The process flow illustrated in FIG. 12, which shows the sequential stages of the tool from discovery (1220) through blueprint (1240, 1244), implementation (1274-1281), and audit (1286), provides a conceptual foundation for how frames/EKUs might be applied across different points in system development. The frames/EKUs categorization structure could potentially provide a foundation for such temporal analysis in future implementations.

While the present application primarily describes frame application at the design level, one skilled in the art would recognize that similar categorization approaches could potentially be applied at various stages of AI system deployment, including potentially at the implementation level. The network architecture described in FIG. 7 could support such applications across different system components. Additionally, the system map illustrated in FIG. 13 demonstrates how different components can work together throughout the implementation process, suggesting possible integration points for frame-based analysis at various implementation stage

As described above, the disclosed tool “can be used in Virtual Reality, XR, Augmented Reality and/or real life” across different hardware implementations. Different, hardware environments may potentially introduce their own considerations for bias analysis, suggesting future extensions of the frames/EKUs concept to hardware contexts might be valuable. FIG. 8 further illustrates how different data can be collected across realities, showing various combinations of media (802), behavior (804), material (806), and reality type (808) that could inform how frames/EKUs are applied in different hardware contexts.

### Machine Learning

Various aspects of the present disclosure can be performed by a machine-learning algorithm, as readily understood by a person skilled in the art. In some examples, the steps 120 and 130 of FIG. 1, steps 320 and 330 of FIG. 3, steps 420 and 430 of FIG. 4, steps 510 and 540 of FIG. 5, steps of the processes of FIGS. 12 and 13 can be performed by a supervised or unsupervised algorithm. For instance, the system may utilize more basic machine learning tools including (1) decision trees (“DT”), (2) Bayesian networks (“BN”), (3) artificial neural network (“ANN”), or (4) support vector machines (“SVM”). In other examples, deep learning algorithms or other more sophisticated machine learning algorithms, e.g., convolutional neural networks (“CNN”), or capsule networks (“CapsNet”) may be used

DT are classification graphs that match input data to questions asked at each consecutive step in a decision tree. The DT program moves down the “branches” of the tree based on the answers to the questions (e.g., First branch: Does the dataset comprise widely representative data? yes or no. Branch two: Is the dataset missing a specific racial/ethnic group? yes or no, etc.).

Bayesian networks (“BN”) are based on likelihood something is true based on given independent variables and are modeled based on probabilistic relationships. BN are based purely on probabilistic relationships that determine the likelihood of one variable based on another or others. For example, BN can model the relationships between input datasets, output datasets, material, and any other information as contemplated by the present disclosure. Using an efficient BN algorithm, an inference can be made based on the input data.

Artificial neural networks (“ANN”) are computational models inspired by an animal's central nervous system. They map inputs to outputs through a network of nodes. However, unlike BN, in ANN the nodes do not necessarily represent any actual variable. Accordingly, ANN may have a hidden layer of nodes that are not represented by a known variable to an observer. ANNs are capable of pattern recognition. Their computing methods make it easier to understand a complex and unclear process that might go on during predicting a body position of the user based a variety of input data.

Support vector machines (“SVM”) came about from a framework utilizing of machine learning statistics and vector spaces (linear algebra concept that signifies the number of dimensions in linear space) equipped with some kind of limit-related structure. In some cases, they may determine a new coordinate system that easily separates inputs into two classifications. For example, a SVM could identify a line that separates two sets of points originating from different classifications of events.

Deep neural networks (DNN) have developed recently and are capable of modeling very complex relationships that have a lot of variation. Various architectures of DNN have been proposed to tackle the problems associated with algorithms such as ANN by many researchers during the last few decades. These types of DNN are CNN (Convolutional Neural Network), RBM (Restricted Boltzmann Machine), LSTM (Long Short Term Memory) etc. They are all based on the theory of ANN. They demonstrate a better performance by overcoming the back-propagation error diminishing problem associated with ANN.

Machine learning models require training data to identify the features of interest that they are designed to detect. For instance, various methods may be utilized to form the machine learning models, including applying randomly assigned initial weights for the network and applying gradient descent using back propagation for deep learning algorithms. In other examples, a neural network with one or two hidden layers can be used without training using this technique. In some examples, the machine learning model can be trained using labeled data, or data that represents certain user input. In other examples, the data will only be labeled with the outcome and the various relevant data may be input to train the machine learning algorithm.

For instance, to determine whether a particular regulation fits the input data, various machine learning models may be utilized that input various data disclosed herein. In some examples, the input data will be labeled by having an expert in the field label the relevant regulations according to the particular situation. Accordingly, the input to the machine learning algorithm for training data identify various legal regulations as ‘relevant’ or ‘non-relevant’.

Supervised Learning: The disclosed AI tool provides for using supervised learning to engage in classification. For example, the tool pairs keywords from questions with the primary feeling word in a particular question, and uses this as training data.

Unsupervised Learning: In another embodiment of the disclosed tool, the tool removes keyword pairs and determines what patterns emerge.

### Local Hardware Model

The present disclosure contemplates that a local hardware model can be used to provide various embodiments of the present disclosure. For example, the disclosed AI tool can be provided for an electromechanical device which allows a user to create and follow associative trails of links and personal annotations while interacting with the disclosed AI tool. Such a local hardware model can mimic the associate processes of the human brain (or the local hardware model mirrors other natural systems), and allow a user to better learn how to construct and deconstruct AI systems. For example, electro-mechanical controls and display device scan be integrated into a desk. Such a local hardware model can provide haptic, tactile, auditory, physical, and visual feedback to a user. Feedback can additionally be provided across realities

### Other Hardware Considerations

The features of the present disclosure may also be performed on quantum computing systems, living intelligence systems, biological computing systems, and other computing paradigms. For example, the frames, hardware-software integration, and other features may be extended to platforms and computing environments based on non-digital or non-silicon technologies.

The systems, devices, and methods may implement enhanced biological computing integration including bio-sensor integration (neural interface compatibility, organic computing substrate support, biological signal processing), neuromorphic hardware optimization (synaptic plasticity simulation, neural spike processing, brain-computer interface compatibility), and living tissue processing coordination (cellular computing networks, bacterial computation support, biological catalyst systems) enabling seamless integration with biological computing systems while maintaining hardware-software optimization.

Further, the systems, devices, and methods may implement biological hardware bridge architectures supporting hybrid biological-digital processing while maintaining bias characteristic signature coherence across biological and digital processing domains. Bridge architectures include bio-digital interface protocols (biological signal translation, digital-biological communication, hybrid processing coordination), biological welfare preservation (health monitoring during bio-digital processing, stress detection in biological components, protection protocols for biological systems), and performance optimization (biological-digital synchronization, hybrid efficiency optimization, cross-domain resource management).

### Computer & Hardware Implementation of Disclosure

It should initially be understood that the disclosure herein may be implemented with any type of hardware and/or software, and may be a pre-programmed general purpose computing device. For example, the system may be implemented using a server, a personal computer, a portable computer, a thin client, or any suitable device or devices. The disclosure and/or components thereof may be a single device at a single location, or multiple devices at a single, or multiple, locations that are connected together using any appropriate communication protocols over any communication medium such as electric cable, fiber optic cable, or in a wireless manner.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present invention, but merely be understood to illustrate one example implementation thereof.

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some examples, the present disclosure contemplates any of the following networks (or a combination of the networks), including: a distributed network, a decentralized network, an edge network, a federated network, and/or a mesh network.

Implementations of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter network (e.g., the Internet), mesh networks, and peer-to-peer networks (e.g., ad hoc peer-to-peer networks).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a “data processing apparatus” on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit)

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory can be supplemented by, or incorporated in, special purpose logic circuitry.

Other examples of processors include AI hardware devices.

### Bias Characteristic Shaping

The system implements a framework for compensating hardware-induced bias characteristics through calibration procedures, transformations, and adaptive processing. This can be done with a hardware bias compensator configured to respond to hardware-induced biases. Responding to hardware-induced bias may include bias shaping. The hardware bias compensator can include a bias analyzer capable of modeling and comparing the performance of devices and sensors to baseline or reference measurements. The hardware bias compensator can also perform calibration procedures to assess the performance of hardware devices and sensors. Based on the bias analyzer and the calibration procedures, hardware-specific bias response methods can be used.

The disclosed tool's approach to bias characteristic shaping differs from conventional debiasing methods by recognizing bias as a design material to be contextually shaped rather than universally eliminated. This paradigm shift, introduced in the examples above, enables AI systems to be optimized for specific community requirements while maintaining effective operation.

The frame-based approach facilitates community-centered bias characteristic shaping by formalizing community requirements through frame-specific representation targets, establishing minimum representation thresholds for underrepresented categories, defining objective functions that balance multiple, sometimes competing, requirements, and validating shaped bias characteristics against community-defined metrics.

This methodology enables the creation of AI systems with bias characteristics that appropriately reflect the needs of the communities being served, rather than applying universal debiasing that may inadvertently reduce effectiveness for specific contexts. The approach builds upon the data adjustment examples provided above by systematizing the process through which such adjustments are determined and validated.

In some embodiments, the identified biased portions are selectively removed from the dataset. These identified biased portions can be removed from the input dataset, training dataset, intermediate representation, or the output of the AI model.

When portions of data are removed from the input dataset and/or the training dataset, the unbiased remaining data can be passed to the AI model. This can be used to generate new unbiased output, adjust model weights, or retrain the AI model. In some example embodiments, the method includes retrieving, via the one or more processors, supplementary input data in a database of artificial intelligence systems. The supplementary input data corresponds to the identified portion of the received input and does not comprise the at least one bias. The supplementary input data or training data can be used in place of the original data. Supplementary data can also be context-specific information designed to counteract identified biases, improving the model's fairness and accuracy.

Supplementary data can also be integrated into the processed dataset. Such supplementary data can be designed to address underrepresented contexts or correct hardware-specific biases, and can be included in place of the removed biased portions. The supplementary data can also be used to introduce a desired bias into the data. For example, in an AI model designed to be used with a mostly female userbase in a women's health context, the supplementary data can be used to skew a general population input dataset to be more focused on women's issues, women's health, and other more socially feminine contexts.

Supplementary data can also be used to address hardware-specific concerns of the input data. For example, input data from a certain set of microphones may be biased due to recording characteristics of the microphones. They may not be able to record certain frequencies or distinguish tones as well as other types of microphones, leading to a bias in the recorded audio data. In this example scenario, the system may identify the biased portions of the audio data based on the known characteristics of the microphones and supplement or otherwise augment the input data to respond to the bias.

For hardware-induced biases, such as the biases described above, the system can apply corrective transformations to the input data before feeding them into the AI model. This might include color correction, normalization, or other preprocessing techniques to neutralize biases introduced by data capture. This can be done through a compensation module that calculates the corrective transformations for sensor biases.

The normalization and regularization of data can include various techniques. The system can normalize input data (e.g., using z-score normalization or min-max scaling) to ensure that features are scaled consistently, which helps the model converge faster and perform more efficiently on certain hardware. This is particularly important when the device handles real-time data inputs, as normalized data ensures stability and better accuracy. In some example embodiments, batch normalization can be applied during training, which normalizes each layer's inputs to have a mean of zero and a standard deviation of one. When deploying to the device, these batch normalization parameters are saved as constants, reducing the need for additional calculations during inference. This allows the model to generalize better and make faster predictions without recalculating normalization metrics. For devices that use quantized models (for example, 8-bit integer models), normalization can be adapted to the lower precision data format, ensuring that the model maintains accuracy in a quantized format. For example, range-aware batch normalization can adjust normalization ranges to fit the lower precision data format, optimizing for both memory usage and computational efficiency. Normalization and regularization can be used in other ways to increase efficiency and respond to biases identified in the AI model.

The system can also adapt to computational architecture limitations through model optimization, precision adjustment, and workload distribution strategies. An architecture adapter can calculate adaptation profiles that account for computational architecture limitations. For example, the weights and training information of the AI model to mitigate architecture-induced bias. Likewise, the intermediate representation of the AI model can be adjusted to mitigate such bias. In other configurations, the training data or the output data can also be selectively adjusted based on the adaptation profile.

Supplementary data can also be used to augment incomplete or insufficient datasets. Many forms of bias are due to inadequate data available about certain populations or social groups. Based on its identification of portions of insufficient data, the system can augment the biased portions to help better represent the population or group in question.

In some example embodiments of the present disclosure, the system may respond to biases identified in the intermediate representation of the trained AI model. These identified portions of the intermediate representation can be modified by the system to change the execution or output of the trained AI model.

The system can modify the biased portions of the intermediate representation by selectively recompiling, reinterpreting, or directly modifying the biased portions of the intermediate representation. In this way, the system can detect and adjust for bias on-device without needing external resources or retraining, resulting in an efficient, fair, and real-world adaptable AI system. This directly enhances the computer's operational capabilities, allowing for bias-aware and context-sensitive AI applications even on hardware-limited devices. The system can modify these aspects of the trained AI model without fully retraining or recompiling the model, saving computational resources and time.

This direct modification of the intermediate representation may be facilitated by representing the AI model or portions of the AI model as monads. These monad portions can be portions of the dataset, portions of the intermediate representation, and/or portions of the output. The monad portions can manage state changes to respond to bias asynchronously, efficiently, and preemptively. Monads can represent each device's model state and be used to structure updates without directly mutating the model. Each hardware device can maintain a monadic state that records its individual bias-corrected model, and the transformations applied by the system. By treating each local model update as a function that applies a small state change, the system can compose these updates in a way that minimizes bias without needing to retrain the AI model entirely. Each monadic transformation can represent:
A bias correction function
A feature scaling or normalization update
A threshold adjustment

This way, each device applies updates in a predictable, functional manner, with a known series of transformations that ensure the model stays synchronized across devices.

Using monad portions, instead of retraining the entire model in response to bias, a technique called incremental learning or transfer learning can also be used. This allows the system to adjust only certain aspects of the model—like bias weights or decision thresholds—without fully retraining. The hardware can run these updates locally, using smaller data samples that represent known biases. In some example embodiments, different hardware device (like IoT sensors, edge servers, or mobile devices) can run partial updates. By maintaining a local, smaller model with just the necessary updates, devices avoid the computationally intensive process of full retraining.

The monad portions can also be used to adapt the intermediate representation of the AI models to different hardware. Each monadic function in the chain could represent a specific hardware adjustment or optimization step. For example, a device could apply a function to adjust for sensor bias, followed by another to optimize memory usage, etc. Each step is transparent and can be recomposed based on observed performance. The monads can also facilitate the use of compilers and interpreters specific to hardware, especially AI hardware devices. These frameworks allow the system to adapt model weights, quantize parameters, and compile the model to take advantage of the specific hardware features on each device.

Some other example embodiments may also use the monad portions to implement a federated learning framework to increase efficiency. In a federated learning framework, where each hardware device (or node) trains on its local data and only sends the model updates (rather than raw data) to a central model. This approach can preserve data privacy while updating the global model with collective local adjustments for bias.

The federated learning framework can also be used to implement a feedback loop for retraining and responding to bias. The system and devices coupled to the system can send performance metrics and feedback (related to efficiency, accuracy, and potential biases) back to a central system or local network via federated learning. The system can store these feedback logs, which then inform a recommendation system on optimal model configurations for each hardware type.

In some example embodiments, the system can also modify the outputs of the trained AI model to respond to bias. Identified biased portions of the AI model output can be responded to in various ways.

The system may use selective data augmentation to augment the output data to respond to identified bias. For example, if the AI system identifies certain groups as underrepresented or overrepresented, the system can apply selective data augmentation techniques to balance the dataset. For instance, synthetic data for underrepresented categories can be generated to ensure a balanced output. The augmented data can also be data pulled from another dataset or other materials representative of an unbiased output. The system may also label the output data to assess its trustworthiness, value, or level of bias.

In some example embodiments, the AI system can also maintain reports on the parameters, model weights, and inputs that create given portions of output. The system can then use these data to compare outputs to prior modifications or transformations of the AI model.

The hardware bias shaping may be implemented using a cross-platform and cross-framework system. For example, frames/EKUs may be used to implement deployment across platforms comprising consistent behavior across frameworks, performance optimization maintenance, frame portability, community validation consistency, migration pathway effectiveness encompassing framework transition support, data compatibility maintenance, user experience continuity, governance preservation, and integration testing quality involving cross-framework validation, compatibility verification, performance benchmarking, and governance compliance testing.

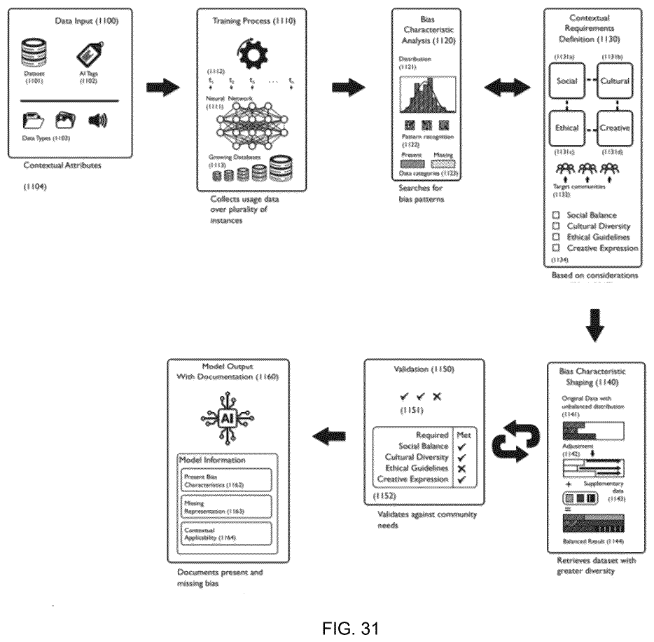

FIG. 31 is a flow diagram showing bias characteristic shaping, according to an embodiment of the present disclosure. Data input 1100 includes dataset 1101, contextual attributes 1102, data types 1103. The training process 1110 performs context-aware bias analytics 1114 with weights 1113 and neural network 1111. This may use a growing database 1112. Bias characteristic analysis 1120 generates a distribution 1121, performs pattern recognition 1122, and creates data categories 1123. The contextual requirements definition process 110 uses social 1131a, cultural 1131b, ethical 1131c, and creative 1131d biases and data about target communities 1132 to achieve social balance, cultural diversity, ethical guidelines, and creative expression guidelines 1134. Bias characteristics shaping 1140 takes original data 1141, performs adjustment 1142, and adds supplemental data 1143 to generate balanced data 1144. The validation process 1150 determines in process 1151 if the guidelines 1152, which may be guidelines 1134, have been met. The model output process 1160 creates documentation including present bias characteristics 1162, missing representation 1163, and contextual applicability 1164.

### Audit and Verification Capabilities

In some configurations of the present disclosure, the system may also implement strategies for maintaining consistent AI behavior across different hardware environments through profile-based adjustments and calibration. A cross-device compensator may determine a compensation strategy based on detected differences between different hardware devices associated with the training, deployment, or inference of the AI system. A compensation strategy may include various techniques, such as normalization, regularization, data supplementation, and intermediate model adjustment, based on the characteristics of the hardware environments. Various compensations strategies may be modeled to predict the outputs of AI systems across various hardware environments. The compensation strategies can be applied to the hardware environments to maintain consistent AI behavior and output across the different hardware environments.

In some configurations of the present disclosure, the response to bias may also include introducing certain targeted biases to the system, AI system, input/output data, or the hardware and sensors associated with the system. These targeted biases may be used as a method to shape and guide the operation and development of the AI system. For example, in certain contexts, it may be beneficial to have the AI system produce biased data to rectify a societal issue that is reflected in bias input data. Producing a certain desired output may involve identifying the bias in the input data and subsequently producing a targeted bias in the output.

In some example embodiments of the current disclosure, the system may maintain an audit log of information related to bias detection, removal, and supplementary data adjustments, creating a transparent audit trail. This log provides a traceable record of bias mitigation measures applied during model training, compilation, and deployment, creating a model that can be audited and verified.

The audit logs may contain information related to bias detection, removal, and supplementary data adjustments. This can include past transformations, identified biased portions of data, removed data, data augmentations, intermediate representation, monad compositions, or other changes made to respond to bias. The audit logs may be maintained on a single device, and contain information related to the changes made by hardware on that device, or they may record changes to the AI model made across multiple networked devices. The audit logs may also contain state information regarding the monads, intermediate representations, and other aspects of the AI model.

In some embodiments, the audit log may be implemented as a blockchain. The blockchain can support decentralized storage of incremental model updates, providing an immutable audit trail of bias responses. The entries in the blockchain may be hashed and recorded, and may further utilize off-chain storage, allowing for a reduced computational load. Updates to the blockchain may be shared over a network to maintain a global ledger of the edits may to an AI model in deployment across multiple devices.

An example method for logging updates to an AI model on a blockchain includes starting each device with a local version of the AI model, which can be downloaded or preloaded from a central server. Each device can periodically assess its data for biases (e.g., certain demographic attributes being underrepresented) and apply incremental updates using a monadic function that transforms the model state. After each bias adjustment, each device logs this change on a local blockchain network, hashing and recording the transformation function and outcome. This creates a local blockchain audit log of the bias responses made on a particular instance of the AI model or device. Across a network, devices in the network may periodically aggregate updates via consensus. The blockchain verifies and records the aggregated adjustments. The blockchain can also integrate and ensure agreement across various adjustments and bias responses to maintain a version of the AI model that is most representative of the most recent bias responses. This process can be performed iteratively, improving the model locally and synchronizing across the network, collectively reducing bias over time.

The monad functionality of the system can facilitate the blockchain-based auditing of the bias responses. Monads ensure that each local update is predictable and functional, maintaining model integrity across hardware. The blockchain provides an immutable record of updates and ensures that the synchronization across devices is transparent and traceable. Together, these technologies reduce the computational load, allowing hardware devices to make lightweight, bias-adjusted model improvements without full retraining. Such model improvements can be made in the input data, training data, intermediate representations, the output data, or in any combination of these elements.

The audit log can also be used to facilitate modifications of the intermediate representation of the AI model. Each device can compile its version of the model based on hardware capabilities and log these optimizations on a local blockchain. This approach keeps a verified record of all hardware-specific optimizations and configurations across devices. Likewise, the audit log can maintain a ledger of device-specific hardware profiles, allowing each device to access the historical performance of similar devices and adapt its model accordingly. For instance, a device with a certain microphone type can obtain bias-correcting model updates tailored for that sensor profile. Similarly, during model compilation or interpretation, the system can include bias corrections specific to the device hardware. For example, for a camera prone to certain color distortions, the system can compile a version of the model that pre-processes images to correct for this bias. This way, each device runs an optimized, bias-corrected version of the model that accounts for its hardware limitations.

The audit log can also maintain a history of data labels regarding the quality, quantity, and/or bias of datasets. AI-based data labelers and raters can score the quality or relevance of labels, and these ratings are logged on the audit log. Each label's rating history is immutable, allowing for tracking which labels have been consistently rated as high or low quality. Ratings from multiple labelers help the system assess label quality. Higher-rated labels are considered more reliable, while lower-rated ones may trigger re-evaluation. The audit log may include a consensus mechanism that can aggregate these ratings, identifying data points that may need relabeling or verification. The system can then make the appropriate bias responses to these biased portions of the data.

The AI model can also use this feedback to implement an adaptive learning system that is used for selective data removal and augmentation. The audit log can provide history of label reliability, which can feed back into the model's training process, helping the model adapt more quickly to high-quality data and improve over time.

The system can also use low-rated labels as triggers for reanalysis. When a label's rating falls below a threshold, the system initiates a second pass for verification. This process helps ensure that all labels used in training are of a consistent quality.

Based on label ratings and confidence scores, the system can reorganize the dataset, grouping data points by quality. This reorganization optimizes data selection for the next training cycle, prioritizing high-rated labels while deprioritizing or discarding low-rated ones. Low-rated data can be removed to shape bias, and high rated data can be included as supplemental data in other AI models. Likewise, if labels for a particular category consistently receive low ratings, the system can trigger a data call, prompting data collectors to gather new samples for that category. This ensures that the model's dataset remains robust and balanced, avoiding overfitting on unreliable labels and replacing data removed as part of a bias response.

The label ratings and confidence scores can be utilized during retraining or partial retraining of the AI model or portions of the AI model. By assigning weights to data points based on label ratings and confidence scores, the model can prioritize learning from high-quality, unbiased data. Data points with lower confidence (often linked to potential biases) can be given less influence during training, reducing their impact on the model's learning process. During training, weights can be adjusted dynamically based on ongoing ratings and detected patterns of bias. For instance, if a certain type of data is identified as biased mid-training, its weight can be reduced, ensuring it has less influence on model outcomes.

In some embodiments, counterfactual examples (data modified to represent different demographic scenarios or features) can be used to retrain the AI model to be robust against specific biases. For instance, counterfactual examples can simulate data for underrepresented groups, ensuring the AI model's predictions are not unfairly skewed. This can be integrated into the supplemental data provision process. The system can also generate synthetic data designed to be neutral with respect to certain biases (e.g., demographic attributes). By training on this data alongside real-world data, the model learns to generalize without relying on biased features.

The audit log can further be used by the AI system as data indicating certain portions of the input data, training data intermediate representation, and/or output data that contribute to bias. By examining the data features associated with labeled data with a low rating, the model can correlate specific attributes with bias. For example, if low-rated data points consistently share a demographic attribute, this can suggest a bias linked to that feature. As more devices or users contribute ratings, the system builds a larger dataset of label assessments. If certain types of data are frequently flagged as biased across users, this can indicate that the data collection process itself (such as certain sensors or environments) introduces the bias. This insight can be used to improve the data-gathering process. In cases where data-capturing hardware (such as cameras or sensors) introduces bias, smart materials and adaptive mechanisms can provide contextual data about the environment in which the data was collected. For instance, the blockchain can log metadata such as lighting conditions, location, or time, which can reveal if certain environments are causing biases. These data can be used by the system to identify portions of the AI model that are contributing to bias.

The system may also maintain a registry of hardware profiles with known bias characteristics for reference during detection and mitigation operations. The hardware profile registry can contain profiles for various hardware environments, sensors, devices, and other hardware associated with the system or the training and inference of the AI system. The profiles can include information regarding identified biases, known biases based on external sources, and hardware limitations of the associated hardware devices.

The profiles can also include a similarity measurement that measures the similarity of hardware profiles to each other. This may identify hardware that is similar to other hardware associated with the system. Based on these similarity measures, the profiles of the hardware devices can be updated. For example, if information is known about related hardware profiles, a profile missing that information can be updated. The profile similarity can also be used to inform the generation of corrective transformation for similar biases from similar hardware associated with similar hardware profiles.

The system can also include a verification and validation framework for verifying the effectiveness of bias mitigation measures through comparison testing and validation metrics. The bias verification framework can receive or generate one or more bias metrics based on the expected or desired performance of bias mitigation measures. Based on these bias metrics, a test suite can be generated. The test suite may compare a known set of associated inputs and outputs with the observed outputs of the AI system subjected to bias mitigation measures. The test suite may also measure structural changes in the AI system, input data, output data, or intermediate representation to determine the effectiveness of various bias mitigation measures. Based on these test results, new bias mitigation measures can be determined and applied to the AI system and associated hardware devices.

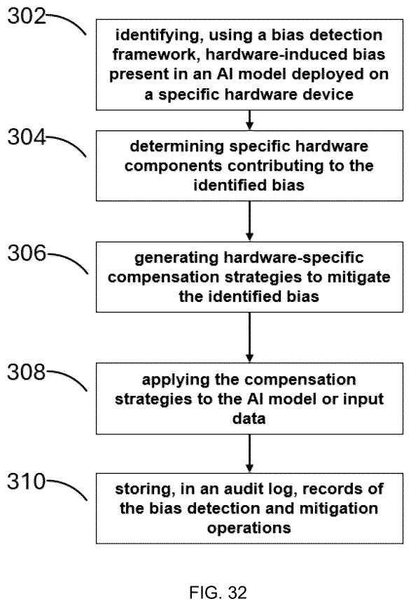

FIG. 32 is a flow diagram showing an auditing and verification process, according to an embodiment of the present disclosure. The auditing and verification process is an exemplary process, and other processes and methods may be used to audit and verify the systems and methods herein.

At block 302, the system identifies, using a bias detection framework, hardware induced bias present in an AI model deployed on a specific hardware device. This may be done by assessing the capabilities of the device and the hardware of the device. Hardware-induced or hardware-associated bias may be determined based on the assessed capabilities.

At block 304, the system determines specific hardware components that contribute to the identified bias. The system may determine this based on the capabilities of specifications of the devices and/or their components.

At block 306, the system generates hardware-specific compensation strategies to mitigate the identified bias. These strategies may be based on the capabilities or specifications of the hardware and the components. The hardware-specific compensation strategies may include bias shaping.

At block 308, the compensation strategies are applied to the AI model or input data. For example, bias shaping strategies may be performed on the AI model, an intermediate representation of the AI model, or the input data of the AI model. In some example embodiments, the compensation strategies may also be applied to the output data of the AI model.

At block 310, records of the bias detection and mitigation operations are stored in the audit log of the system. This may include storing blockchain-based receipts in a blockchain audit log of the system. The audit logs include information associated with the identified bias and the compensation strategies taken in response to the bias. In some example embodiments, the operations include storing the results of the compensation strategies. In other example configurations, the operations include storing bias shaping attributes of the compensation strategies.

The AI tags (AI contextual attributes) described herein provide a foundation for documenting bias characteristics at a point in time. As illustrated in the audit section variations shown in FIGS. 26A-E, the system supports project-level audit capabilities that can show “the state of diversity of dataset and the various considerations” made during the design process. FIG. 27A-D further demonstrates how project pages can incorporate data collection sections, allowing for ongoing documentation of project development. In more complex implementations, these tags and audit mechanisms could potentially be extended to support tracking changes to bias characteristics over time, creating a more comprehensive record of how AI systems evolve.

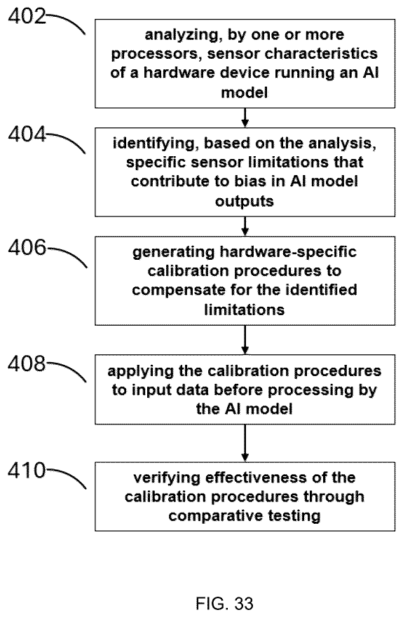

FIG. 33 a flow diagram showing hardware-specific bias characteristic shaping, according to an embodiment of the present disclosure. The flow of FIG. 33 begins at block 402.

At block 402, the system analyzes, by one or more processors, sensor characteristics of a hardware device running an AI model. The characteristics may include technical data related to the sensors of the hardware device, known biases, and identified biases of the sensors. In some example embodiments, the characteristics include a plurality of capabilities of the sensors of the hardware device.

At block 404, the system identifies, based on the analysis of the sensor characteristics, limitations of the sensors that contribute to bias in AI model outputs. For example, the system may analyze an identified bias and the sensor characteristics to determine that specific characteristic of the sensors contributed to the identified bias. In other example embodiments, the system may identify the limitations of the sensors based on known or potential biases or limitations. For example, the system may determine that the limited color range of a camera contributed to an AI model's biases when identifying human skin tones.

At block 406, the system generates hardware-specific calibration procedures to compensate for the identified limitations. For example, the system may determine that a specific hardware compensation must be made in the input data, the AI model, an intermediate representation of the AI model, and/or the output data of the AI model to perform bias shaping relative to an identified limitation of the sensors of the hardware device.

At block 408, the calibration procedures are applied to input data. This may be done before the input data is processed by the AI model. In some example embodiments, applying the calibration procedures includes applying the procedures to the AI model, an intermediate representation of the AI model, and/or the output data of the AI model. Applying the calibration procedures may include performing bias shaping.

At block 410, the system verifies the effectiveness of the calibration procedures through comparative testing. Comparative testing may include comparing the output data of the AI model prior to and subsequent to the compensation strategies. The comparative testing process may use the auditing and verification system. Comparative testing may also include comparing the functionality of the AI model, its intermediate representation, or the input data prior to and subsequent to the compensation strategies.

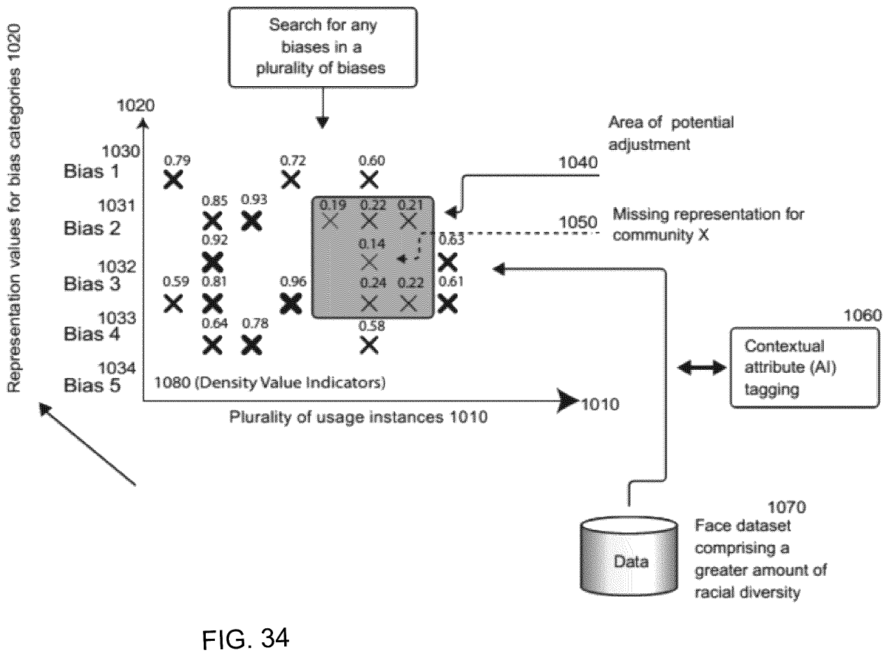

FIG. 34 depicts example operations for a method for searching for a bias in a plurality of biases across a plurality of usage instances 1010. Element 1020 of FIG. 34 shows representation values for bias categories. Biases include 1030, 1031, 1032, 1033, and 1034. A plurality of biases can be determined, and an area of adjustment 1040 determined. The area of adjustment 1040 includes missing representation for community X 1050. Contextual attribute tagging 1060 may compare a face dataset 1070 with the biases to determine the plurality of biases.

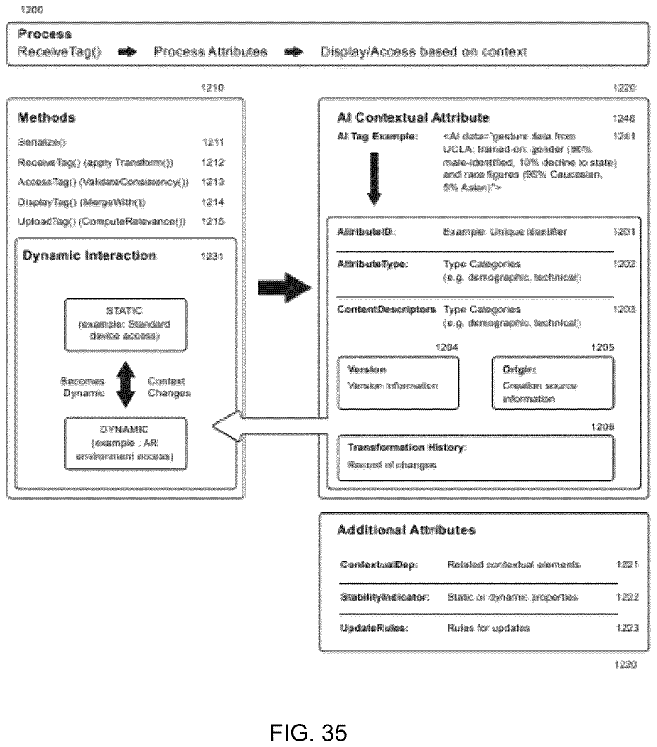

FIG. 35 depicts a process for AI tagging. Process 1200 includes methods 1210, such as serialization 1211, receiveTag 1212, AccessTag 1213, DisplayTag 1214, UploadTag 1215, and dynamic interaction 1231. Attributes 1220 include example 1241, which includes ID 1201, type 1202, descriptors 1203, version 1204, origin 1205, transformation history 1206, and additional attributes 1221, 1222, and 1223.

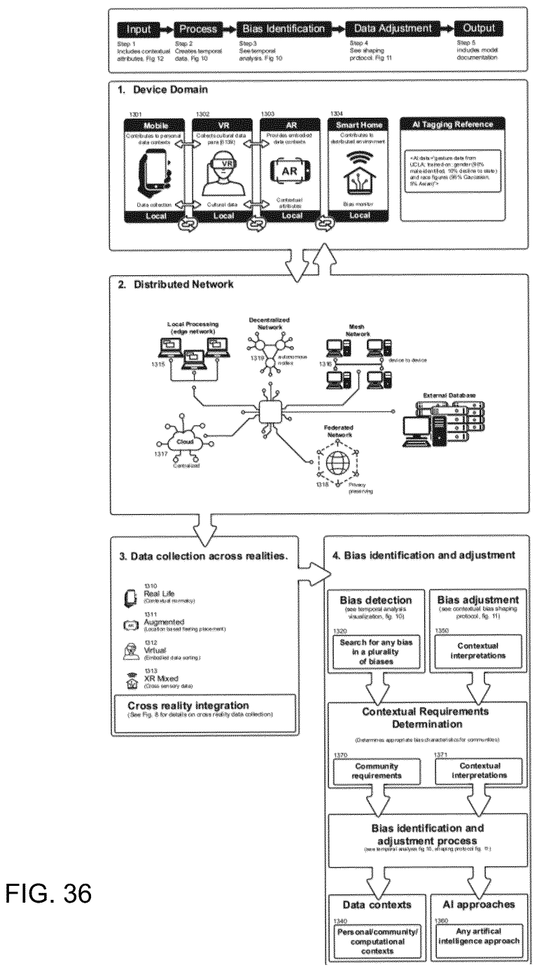

FIG. 36 depicts example configurations of the present systems, devices, and methods. Device domains include mobile devices 1301, VR devices 1302, AR devices 1303, and smart home devices 1304. A distributed network 1315 may be set up. This includes cloud 1317, decentralized network 1319, mesh network 1315, external databases, and federated network 1318. Data collections across realities may be performed across real life 1310, augmented reality 1311, virtual reality 1312, and mixed reality 1313. Bias identification and adjustment may be performed, including bias detection 1320, bias adjustment 1350, contextual determination 1370, contextual interpretation 1371, bias identification including data context 1340 and AI approaches 1360, which includes any AI approach.

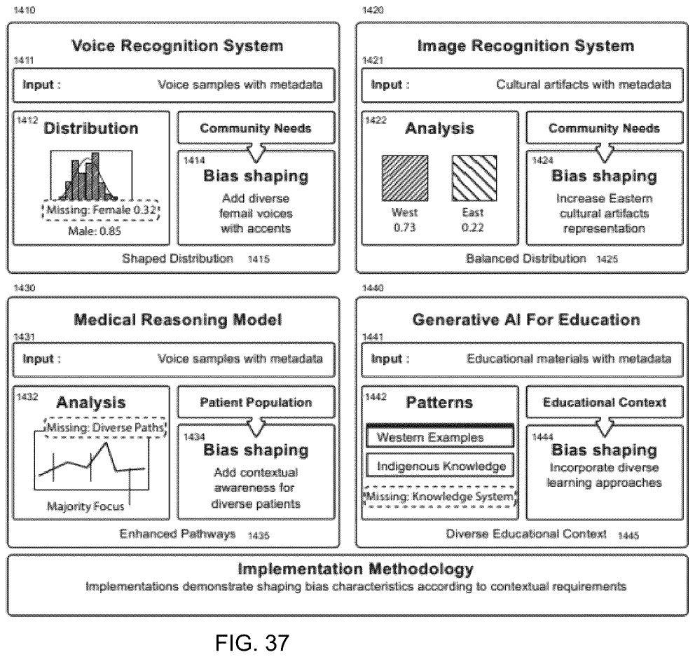

FIG. 37 depicts example inputs for the systems and methods disclosed herein. A voice recognition system 1410 includes input 1411, distribution 1312, and bias shaping 1414. This creates a shaped distribution 1415 model. An image recognition system 1420 includes image input 1421. Analysis 1422 may be performed, which identifies community needs and performs bias shaping 1424. This achieves balanced distribution 1425. Medical reasoning model 1430 includes medical input 1341 and performs analysis 1432. Bias shaping 1434 identifies a patient population. This creates enhanced pathways 1435. Generative AI for education model 1440 includes input 1441 and identifies patterns 1442 in the input. Bias shaping 144 can incorporate other learning approaches to create a diverse educational context 1445.

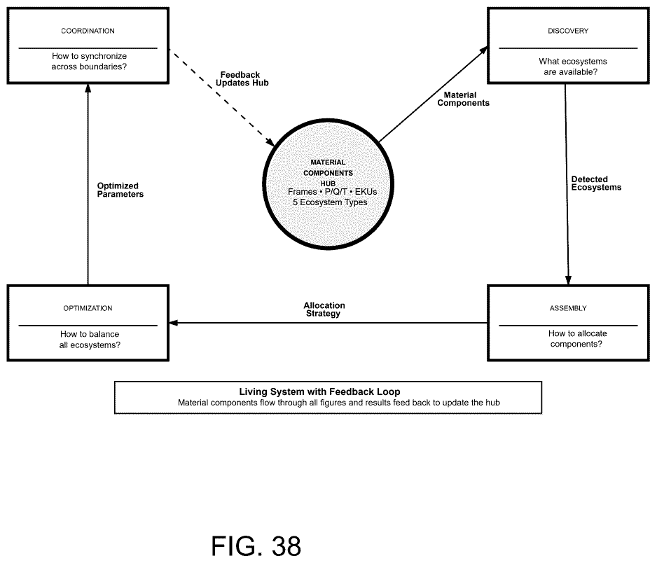

FIG. 38 is a block diagram of interrelations between concepts used in the system, according to an embodiment of the present disclosure. FIG. 38 illustrates how the material components may may include frames, EKUs, the /Q/T/ hierarchy, and the ecosystem types to implement the processing of material components in the system. The material components may discover what ecosystems are available and determine allocation of components accordingly. The system can optimize the allocation of components and resources across ecosystems and coordinate operations across ecosystems. This may implement a living system with one or more feedback loops that update the material components hub.

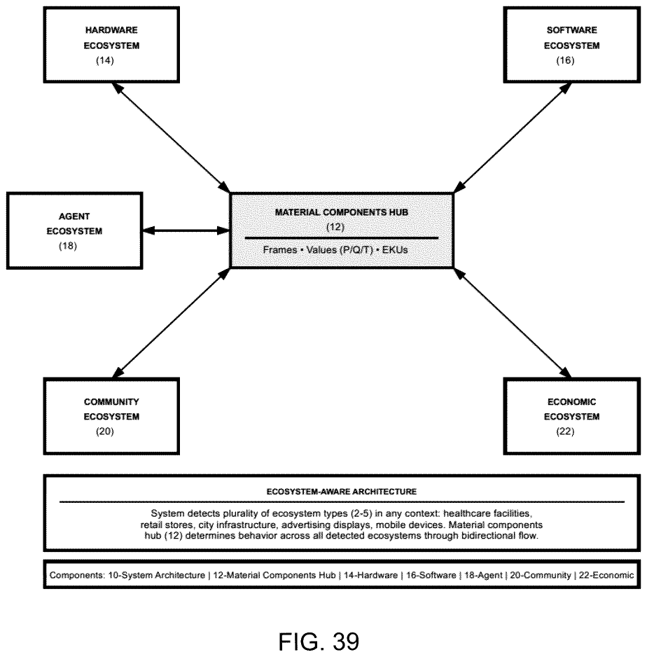

FIG. 39 is a block diagram of the system, according to an embodiment of the present disclosure. As shown in FIG. 39, the system may include a material components hub 12. The material components hub 12 include frames, P/Q/T/ values, and EKUs. The material components hub 12 is communicatively coupled with modules implementing the hardware ecosystem 13, the software ecosystem 16, the agent ecosystem 18, the community ecosystem 20, and the economic ecosystem 22. The hardware ecosystem 18 includes hardware devices associated with the system and one or more AI models. The software ecosystem 16 includes software programs running on the hardware devices, the system, and other computing systems. The agent ecosystem 18 includes one or more AI models, agents, LLMs, living intelligence networks, and other AI systems. The community ecosystem 20 includes groups, communities, ethnicities, organizations, and other communities associated with the system or the operations of the system. The economic ecosystem 22 includes compensation, compensation metrics, accreditation, attribution, economics, and other concepts related to economic considerations of the material components in the material components hub 12. The material components hub 12 may use these ecosystems to monitor contexts across operations fields such as healthcare, retail, infrastructure, advertising, and other fields. The material components hub 12 establishes a foundation architecture with a hub-and-spoke topology.

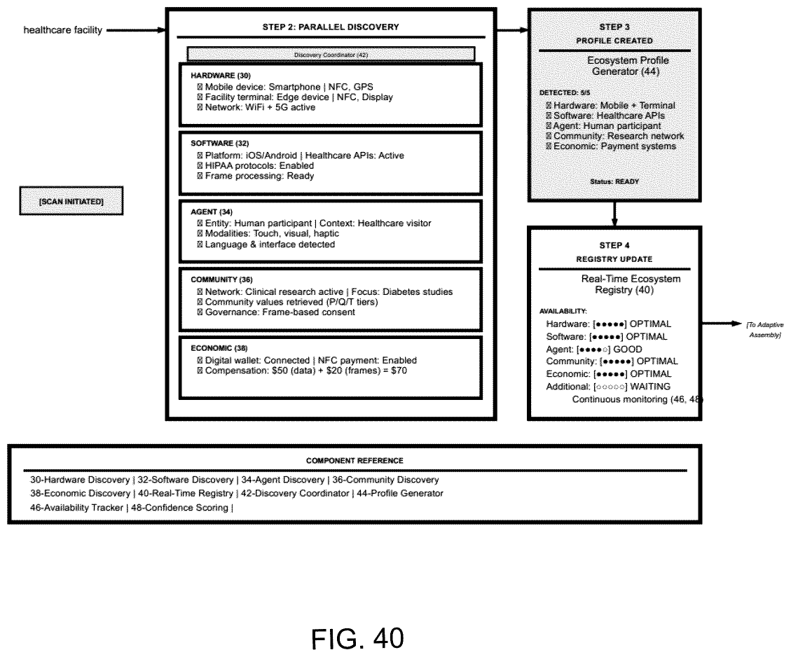

FIG. 40 is a block diagram of an ecosystem discovery process of the system, according to an embodiment of the present disclosure. The ecosystem discovery process discovers available resources within each ecosystem type. This may utilize parallel scanning. The discovery coordinator 42 may utilize information from hardware 30, software 32, agent 34, community 36, and economic 36 ecosystems to discover resources across ecosystems. For each ecosystem, and for the plurality of ecosystems together, the ecosystem profile generator 44 creates a comprehensive profile detailing the characteristics of the ecosystems and the resources available in each ecosystem. Real time registry 40 tracks each profile and provides indications of the status of the ecosystems. In some example embodiments, the real time registry 40 may generate visual indicators of the availability of ecosystems and resources.

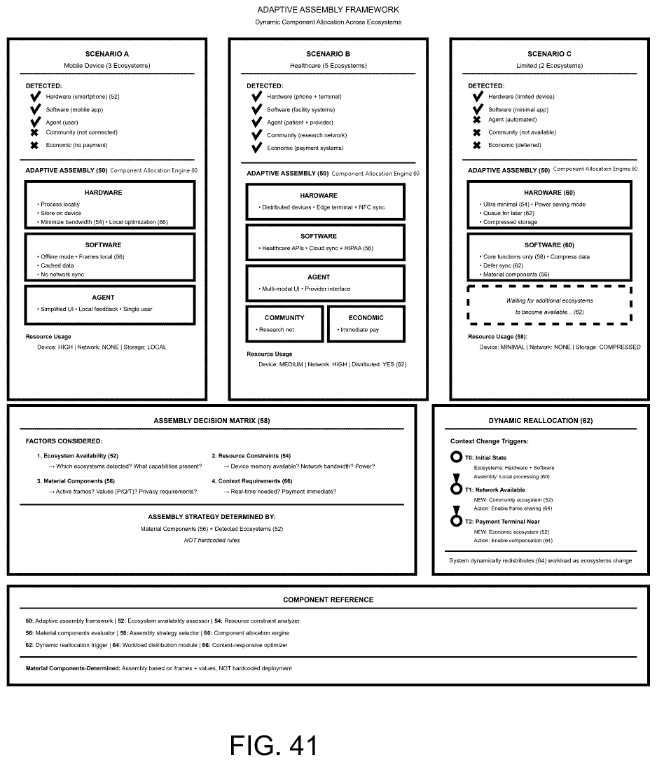

FIG. 41 is a block diagram of an adaptive assembly framework, according to an embodiment of the present disclosure. The adaptive assembly framework allows for the dynamic allocation of components across ecosystems based on the discover process and contextual requirements of the ecosystems. In an exemplary scenario A, a mobile-only scenario, the adaptive assembly process 50 utilizes the component allocation engine 60 to determine that 3 available ecosystems are detected: the hardware, software, and agent ecosystems. and performs local processing and data caching to assemble the components. A resource usage may be determined by the system. In some embodiments, the assembly decision matrix 58 determines the resource usage In an exemplary scenario B, a healthcare scenario, the adaptive assembly process 50 and the component allocation engine 60 identifies five healthcare ecosystems and performs local processing and data caching to assemble the components. The resources usage may be updated based on scenario B, indicating a dynamic reallocation via dynamic reallocation trigger 62. The dynamic reallocation trigger 62 allocates resources to each ecosystem based on changes in the ecosystems or in the availability of ecosystems to the system. In exemplary scenario C, a limited scenario, the adaptive assembly process 50 and the component allocation engine 60 may determine the presence of two limited ecosystems. The resource usage may be updated by the assembly decision matrix 58. An assembly decision matrix 58 balances ecosystem availability 52, resources constraints 54, material components 56, and context requirements 66 to assess each of the ecosystems. It receives real-time information about the resources available to each resources and updates resource usages accordingly. A dynamic reallocation trigger 62 may create context change triggers and states to adapt the system as new ecosystem become available. For example, an initial state of the ecosystems may be defined as T0, wherein the ecosystem has only hardware and software ecosystems available on a local device. At state T0, only local processing is possible. At a second stage T1, a network may be detected. With the network, the system may gain access to a community ecosystem. This may utilize the ecosystem availability 52 component. The system may perform frame sharing via the workload distribution module 64 via the network and the community ecosystem. At another state T2, the system may detect a payment terminal. The ecosystem availability 52 may be assessed and determine that an economic ecosystem is available. The workload distribution module 64 may then distribute resources and perform operations to provision compensation via the economic ecosystem and the payment terminal. As shown, the dynamic reallocation trigger 62 allows for the workload distribution module 64 to dynamically redistribute the workload and operations of the system as ecosystems and ecosystem availability 52 changes.

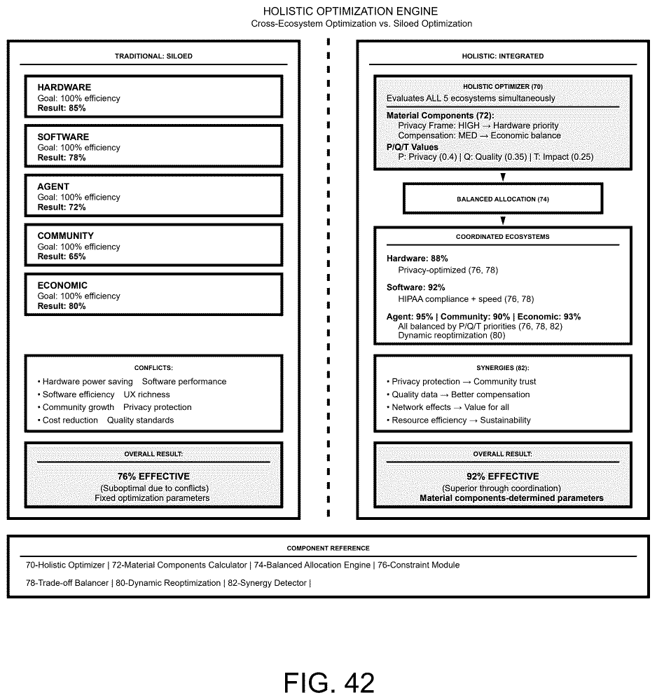

FIG. 42 is a block diagram of a holistic optimization engine, according to an embodiment of the present disclosure. The holistic optimization engine shows a holistic optimization approach across ecosystems. A traditional siloed optimization approach optimizes independently, and may be suboptimal. A holistic integrated approach uses a holistic optimizer 70 to optimize material components and values. The material components may be calculated by a material components calculator 72. The material components calculator 72 assesses the hardware components, resources, and other material components available to the system and the ecosystems to determine which materials are available. The holistic optimizer may also use P/Q/T Values to give priority to different values. In some examples configurations, P values must be followed by all the systems and ecosystems. Q values are prioritized, but not required. T values may be long term values or goals. Other assignments to types of P/Q/T values in the P/Q/T hierarchy are possible. In FIG. 42, the P value is privacy, the Q value is quality, and the T value is impact. Numerical weightings may be assigned to these values, Balanced allocation engine 74 distributes resources across ecosystems in a coordinated fashion The balanced allocation engine 74 may distribute resources according to the material components identified by material components calculator 72 and the P/Q/T values. A trade-off balancer 78 determines the optimal areas to distribute resources to. A constraint module 76 may include various hard and soft constraints across each of the ecosystems. The constraints of the constraint module 76 may be used to further inform resource allocation. The trade-off balancer 78 reviews the allocations made by balanced allocation engine 74 and determines the benefits and trade-offs of the given resource allocations. The trade-off balancer 78 may use the material components identified by material components calculator 72 and the P/Q/T values to reallocate resources. Dynamic reoptimization 80 reallocates resources based on changing conditions in the ecosystems. Dynamic reallocation 80 may use data generated by the trade-off balancer 78. The resource allocation may create synergies that lead to additional efficiency between the ecosystems and components of the system, which are detected and encouraged by a synergy detector 82. The data generated by the synergy detector 82 may be used by the holistic optimizer 70, the balanced allocation engine 74, and the trade-off balancer 78.

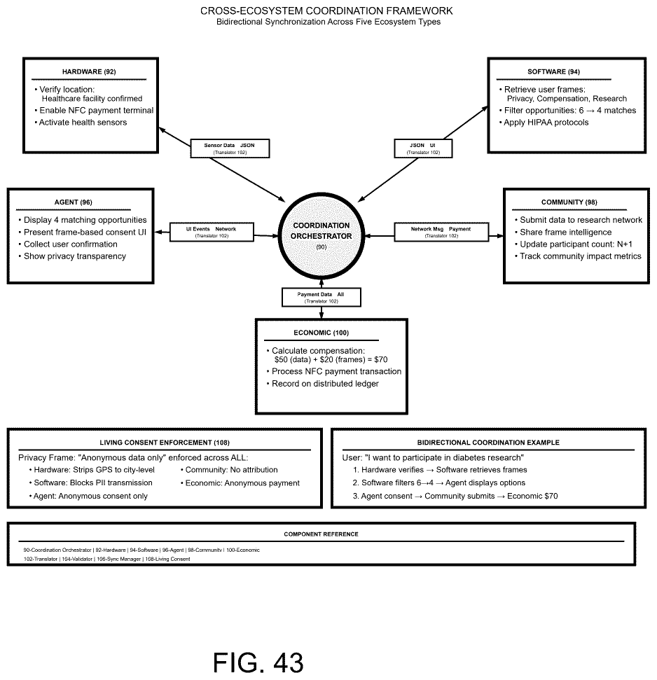

FIG. 43 is a block diagram of a cross-ecosystem coordination framework in an example healthcare setting, according to an embodiment of the present disclosure. The cross-ecosystem coordination framework coordinates actions of the system across all ecosystem boundaries with bidirectional data translation and living consent enforcement. A coordination orchestrator 90 connects the components of the framework. The hardware component 92 includes various healthcare related functions in an example configuration. The software component 94 includes user frames, privacy, compensation, research, and legal software in a healthcare configuration. The agent component 96 displays matching opportunities, creates a frame-based consent UI, collects user confirmation, and shows privacy transparency in the healthcare configuration. The community component 98 submits data to the research network, shares frame intelligence with attribution, updates participant count, and tracks community impact metrics in the healthcare configuration. The economic component 100 calculates compensation, processes payment, and records on a distributed ledger. The bidirectional translation system 102 allows for a bidirectional and comprehensive relationship between the systems of each of the components via the coordination orchestrator 90. The coordination orchestrator 90 may interface with each of the components of the system via the bidirectional translation system 102. The bidirectional translation system 102 translates inputs, data, and other materials from each component into a common intermediate translation. This common intermediate translation allows for direct comparison and interpretation of data from different components and ecosystems. For example, the bidirectional translation system 102 may translate hardware specifications from hardware component 92, code from software component 94, and economic data from economic component 100 to a common tokenized format to be read by an LLM of the coordination orchestrator 90. In some example embodiments, the coordination orchestrator 90 may generate instructions, input data, or other inputs to each component. These inputs may be formatted according to the common intermediate translation, and the inputs may be translated into the appropriate formats for each component via the bidirectional translation system 102. A living consent enforcement process 108 ensures that various values and frames are applied equally and correctly to all the ecosystems.

### Living Intelligence Networks

This section includes various configurations of certain alternative embodiments including Universal Gap Detection, Attention Networks, Community Collaboration, Seven-Dimensional Cultivation, and WONDER Track. The present embodiments disclosure features relating to how intelligence emerges from relationships between frames, not from individual agents. Certain configurations may include human, machine, and biological agents. For example, the present disclosure describes LLMs (Large Language Models), LCMs (Living Contextual Models), and LINs (Living Intelligence Networks).

In certain example embodiments, an Entity-Based Architecture is given.

The entity-based architecture may support Universal Gap Detection-multi-modal input, Cross-Entity Values, and Adaptive Authority.

Some example configurations include five entity types. All entity types may participate equally. No single type is privileged over the others.

Humans may be a first type of entity. Personal users, individual contributors have own values (P-tier), and may participate in communities (Q-tier). Multi-modal input capabilities allow humans to interact with the system.

Organization entities (Companies, Institutions) may be a second entity type. These include but are not limited to corporate participants and research institutions. Organizations may have organizational values (T-tier). Organizations may also be associated with structured data and knowledge systems.

Community entities (Groups, Collectives) may be a third entity type. Communities of practice, support groups, and other communities may have shared values (Q-tier) and be operated by collective governance. Community entities may also have democratic validation mechanisms.

AI system entities (Machine Agents) may be a fourth entity type. Language models, recommendation systems and other systems may be AI system entities. These entities may learn from interactions and improve over time. They may also use APIs to participate in other systems and with other entities.

Biological entities (Plants, Animals, Ecosystems) may be a fifth entity type. These include natural systems, organisms, and other living systems. Biological entities may use or be measured by environmental sensors as input mechanisms. they may have ecological values and needs. Universal treatment may be implemented according to the present disclosure. No entity type has special privileges. All types of entity may create frames and participate in governance. All entities may be subject to same three-tier values All entities may participate in Living Intelligence Networks

Five input modalities may be used by entities to participate in the systems disclosed herein. The system and methods herein may accept FIVE distinct input modalities and processes them through unified architecture. A single input mode or multiple modes with separate processing may be used by the systems and method disclosed herein. Five integrated modalities with unified generative multimodal AI processing may be used.

Text input may be a first modality. Direct text entry may be used for real-time frame generation. Text input allows for immediate validation and feedback. Text input may be used to allow for the quick expression of values and fast onboarding. For example, a user may use text input to say: “I value community health and environmental sustainability.” This text may be processed by the system quickly and integrated into its values.

Document uploading may be a second type of input. For example, PDF, Word (.docx), and text documents may be uploaded to the system. Batch processing may be used to extract values from existing documents. Document uploading may be used to import existing values statements, organizational policies, and other documents. For example, a user may upload company values document, and the system may use the methods disclosed herein to extract P/Q/T tier values from the uploaded document.

Audio recording may a third type of input. For example, voice recordings, podcasts, interviews, and other audio data may be uploaded to the system. Speech-to-text processing may be used to perform conversational value extraction. Audio recording input may allow for accessibility and natural expression while interacting with the system. For example a user may record a 5-minute voice memo about personal values. The system may extract the personal values of the user or related entities from the voice memo.

Web extraction may be a fourth type of input. For example, URL-based extraction may be used to scrape and analyze web content. This may allow for public profile analysis or other analysis. The systems and methods described herein may import data from from social media, websites, portfolios, and other web-based resources. For example the system may use web extraction to extract values from personal blog posts associated with a user or individual.

Real-time voice input may be a fifth type of input. Live voice interaction with the system may allow for conversational frame creation and interactive clarification. Real-time voice input may allow for guided onboarding and the navigation complex situations with a greater level of ease than other input methods. For example, a user may engage in voice-guided values exploration with AI assistance.

The systems, methods, and devices disclosed herein may implement a unified processing architecture. The unified processing architecture may allow for a processing time <2 seconds across all modalities. Other processing speeds may also be used by the systems, methods, and devices disclosed herein.

The systems, methods, and devices disclosed herein may use confidence scoring. A High/Medium/Low confidence may be associated with each extracted value.

The systems, methods, and devices disclosed herein may use automatic consent generation. In some example embodiments, frames automatically create consent rules. No manual coding is required when using automatic consent generation.

The systems, methods, and devices disclosed herein may use auto-approve/auto-block logic. For example, a user may indicate to the system via the example input methods that “I value privacy.” Based on the input and the extracted values, the system may auto-generate “block public data sharing” as logic for the system to follow.

Three-tier values may be used across all entities. The same three-tier values system applies to all entity types. The value types include, but are not limited to: individual (Human) values, organization (company) values, community (group) values, AI system values, and biological entity values.

The systems, methods, and devices disclosed herein may use cross-entity coordination. This integrates values horizontally across all entity types. This implements a bidirectional flow. For example, an individual may influence a healthcare organization such as a pharmacy, which influences the overall healthcare community, which influences AI models associated with healthcare, which influences biological monitoring used by healthcare providers.

The systems, methods, and devices disclosed herein may use four participation tracks. Four tracks may capture all possible ways entities engage with meaning-making and value creation.

One track is the CREATE Track. This track includes original contribution, initial creation, and bringing something new into existence. Its characteristics include origination, not response; individual or collaborative creation; novel contributions being valued; authorship attribution; and other concepts. Examples of operations included in the CREATE track are creating new frame categories, writing original content, developing new bias patterns, composing new WONDER lenses, and other operations. Compensation-related concepts are also included in the CREATE track. This includes ongoing royalties for frame reuse, attribution requirements, intellectual contribution recognition, and other concepts.

Another track is the CONTRIBUTE track. This track includes responding to explicit requests, filling identified gaps, and collaborative building. Its characteristics include responding to calls (data/frame/signature/model); gap-filling behavior; collaborative rather than solo work; and other concepts. Community-requested contributions may be included in the CONTRIBUTE track. Examples of operations included in the CONTRIBUTE track are responding to data calls with personal data, contributing to frame calls with perspectives, validating bias signatures, and participating in model calls. Compensation included in the CONTRIBUTE track are standard compensation rates, community-determined revenue share, multiple compensation forms (cash/gift/token), fair payment for time and effort, and other concepts.

Another track is the CULTIVATE Track. This track includes long-term flourishing through growth across seven dimensions of human/entity development. The seven dimensions are configurable, and each entity can determine its own set of dimension. An example set of seven dimensions follows.

BECOMING includes identity formation and evolution. For example, a user may ask “who am I becoming through this work?.” The BECOMING dimension includes self-discovery and transformation. For example, an individual may have an “individual health focus” during a first month, and a “systemic community advocate” during a twelfth month.

RELATING includes relationship building and maintenance. A user may ask “how am I connecting with others?” The RELATING dimension includes network formation and strengthening. For example, support group formation, peer mentorship, and other actions may be included in the RELATING dimension.

CREATING includes generative capacity development. A user may ask “what am I bringing into existence?” The CREATING dimension includes creative expression and innovation. For example, novel frame creation, artistic contributions, and other actions may be included in the RELATING dimension.

CONTRIBUTING includes service and giving back. A user may ask “how am I helping others and the community?” The CONTRIBUTING dimension includes collective benefit generation. For example, mentoring new members, creating public goods, and other actions may be included in the CONTRIBUTING dimension.

PURPOSE includes meaning-making and direction. A user may ask “what is my deeper purpose here?” The PURPOSE dimension includes alignment with values and mission. For example, the PURPOSE dimension includes “contributing to healthcare equity” as a driving purpose.

LEARNING includes knowledge acquisition and skill development. For example, a user may ask “what am I learning and how am I growing?” The LEARNING dimension includes continuous improvement. For example: learning new frameworks, developing expertise and other concepts may be included in the LEARNING dimension.

LIVING includes day-to-day embodiment and practice. A user may ask “how am I living these values daily?” The LIVING dimension includes integration into life or biological entities. For example, daily health practices, sustained behavior change, and other concepts may be included in the LIVING dimension.

The systems, methods, and devices disclosed herein may use cultivation tracking.

The systems, methods, and devices disclosed herein may use may also use configurable dimensions. While the default is seven dimensions, entities can define additional or alternative dimensions. For example, in a healthcare community, the community may add a “HEALING” dimension (physical/mental/community healing); a “REGENERATION” dimension (recovery and renewal), and other dimensions.

In an environmental community, the community may add a “RESTORATION” dimension (ecosystem restoration); a “RECIPROCITY” dimension (giving back to nature), and other dimensions.

In a developer community example, the community may add a “BUILDING” dimension (creating tools and systems); a “MENTORING” dimension (teaching and guidance); and other dimensions.

Compensation for the dimension configuration may include long-term value creation being recognized; sustained engagement bonuses; milestone-based rewards; community acknowledgment; and other compensation concepts.

The systems, methods, and devices disclosed herein may implement a WONDER Track. The WONDER track includes engaging with mystery, making meaning from the unknown, exploring multiple epistemologies and ways of knowing, and other concepts. Some understanding emerges from mystery, pattern recognition, intuition, synchronicity, and wonder. The WONDER track validates these epistemologies as equal to scientific/analytical approaches.

The WONDER track may include seven WONDER Sections. These include frames that support, material, social, functional, technical, guardrails, biological, epistemological, temporal, spatial, economic, affective, security, accessibility, and creative frame types, with extensibility enabling communities to create additional categories as needed.

The first WONDER section may be a HOROSCOPE section that defines certain astrological concepts. Celestial influences and patterns, archetypal energies, temporal cycles and rhythms, and other concepts may be included in the HOROSCOPE section. Frame creation for the HOROSCOPE section may involve the statement “what archetypal energy is present?”

The second WONDER section may be a TAROT section that defines symbolic meaning. Card-based insight, symbolic pattern recognition, intuitive knowing, and other concepts may be included in the TAROT section. Frame creation for the WONDER section may involve the statement “what symbol speaks to this situation?”

The third WONDER section may be an I-CHING section that defines hexagrammatic wisdom. The I-CHING is an ancient divination system. It may define change and transformation patterns based on complementary opposites. Frame creation for the I-CHING section may involve the statement “what is the pattern of change here?”

The fourth WONDER section may be a DREAMS section that defines subconscious meaning. Dream interpretation, symbolic understanding, unconscious processing, and other concepts may be included in the DREAMS section. Frame creation for the DREAMS section may involve the statement “what is my subconscious revealing?”

The fifth WONDER section may be a SYNCHRONICITY section that defines meaningful coincidences. Pattern recognition in events, meaningful timing, the emergence of connection, and other concepts may be included in the SYNCHRONICITY section. Frame creation for the synchronicity section may involve the statement “what patterns are appearing?”

The sixth WONDER section may be a CUSTOM DIVINATION section that defines community-created WONDER concepts. Community-specific practices, cultural divination systems, indigenous knowledge, and other community-created concepts may be included in the CUSTOM DIVINATION section. Frame creation for the CUSTOM DIVINATION section may involve the statement “community-defined.”

The seventh WONDER section may be a MULTI-LENS INTEGRATION section that allows for a constellation view of the other sections and related concepts. The MULTI-LENS INTEGRATION section may combine multiple perspectives, allow for holistic pattern emergence, and provide for meta-meaning from multiple lenses. Frame creation for the MULTI-LENS INTEGRATION section may involve the statement “What do all these perspectives together reveal?”

An example technical implementation of a WONDER Prototype is given. The prototype includes several complete sections with interactive UI. There is a constellation visualization algorithm, community framework creation system, a plurality of JavaScript functions, and other features. With the WONDER section experiential knowledge valued equally to analytical. WONDER contributions may be compensated fairly. The WONDER section may allow for community validation of meaning and attribution for WONDER frame creation.

The systems, methods, and devices of the present disclosure may implement a meaning-making system.

Entities may generate meaning from experience.

Creation operates as an experiential pipeline in which entities transform lived inputs into structured meaning through multiple, concurrent mechanisms. Creation Mechanisms include direct experience processing, pattern recognition from lived experience, intuitive understanding formation, and cultural lens application, each contributing distinct but complementary pathways for generating meaning from raw experience. Direct experience processing grounds meaning in firsthand interactions with environments and contexts, ensuring that the resulting representations remain tied to observable and felt reality. Pattern recognition from lived experience organizes recurring signals and structures across time, allowing entities to extract regularities and synthesize stable interpretive frames. Intuitive understanding formation captures pre-analytic, gestalt-level inferences that arise from tacit integration of signals, often preceding explicit articulation yet guiding subsequent reasoning. Cultural lens application situates creation within shared norms, symbols, and practices, shaping how experiences are interpreted, prioritized, and encoded as meaning.

The systems, methods, and devices of the present disclosure provide multi-modal input channels that enable diverse creation methods and expand the expressive bandwidth of experiential capture and synthesis. They may also specify distributed frame creation, ensuring that creation is decentralized and that meaning-making can occur across multiple agents and contexts without reliance on a single authority.

The WONDER track may validate experiential creation by instrumenting and corroborating lived inputs, thereby maintaining fidelity between experience and created meaning.

The systems, methods, and devices of the present disclosure may implement systems that allow for meaning to move between entities.

Communication propagates, transforms, and amplifies meaning as it moves among entities, serving not only as a transport layer but as a generative medium in which new meanings emerge. Communication characteristics define the channels and dynamics by which meaning flows and evolves across the system. The system is multi-modal, encompassing text, voice, visual, and biological signals so that meaning can be expressed and received through heterogeneous media. Communication may also be cross-species, enabling human-AI-biological communication and thereby extending meaning exchange beyond human-only interfaces. The exchange is bidirectional, with meaning transforming in both directions as senders and receivers co-adapt and co-interpret signals.

Communication may be generative, in that it creates new meaning rather than merely transferring preexisting content, with each exchange producing novel frames, associations, or commitments. Translation mechanisms operate across modalities, species, and contexts to preserve semantics while allowing forms to shift, thereby maintaining coherence without suppressing emergence.

The systems, methods, and devices of the present disclosure may implement emergence detection that identifies new meaning produced through communication dynamics and surfacing previously latent structures.

The systems, methods, and devices of the present disclosure may enable community collaboration via structured communication protocols that coordinate shared context, negotiation, and collective authorship.

The systems, methods, and devices of the present disclosure may implement attention networks in which meaning flows create and reshape networks of salience, routing focus and resources to the most consequential signals.

Meaning may be integrated into being. Embodied knowing occurs when meaning becomes integrated into an entity's being—lived and felt rather than merely intellectually represented—so that knowledge expresses through perception, action, and identity.

Embodiment advances through mechanisms that carry context, enact values, and reshape identity over time, converting information into durable, lived capability.

Embodiment Mechanisms include EKUs (Embodied Knowledge Units), daily practice, and identity evolution, which together secure persistence and depth of knowing.

EKUs (Embodied Knowledge Units) serve as portable carriers of context-rich knowledge.

Such knowledge carries its own context, enabling deployment without loss of situational meaning or dependency on external scaffolds.

EKUs integrate multiple sources, fusing experiential, social, and computational inputs into a coherent unit of lived competence.

EKUs are felt and lived, not just known, expressing as readiness-to-act and perceptual attunement rather than solely as propositional content.

Living modules carry embodied knowledge, operationalizing EKUs within the system's modular architecture for reuse and adaptation.

Daily Practice anchors embodiment by repeatedly enacting values in ordinary contexts.

Values are enacted in daily life, aligning intention with action across diverse situations.

Behavioral integration accrues over time, consolidating micro-adjustments into reliable habits.

Habit formation and transformation provide the substrate for durable change, enabling both consolidation and intentional reconfiguration.

The systems, methods, and devices of the present disclosure may specify cultivation processes that include a “living” dimension, ensuring practice-based consolidation of learning.

The systems, methods, and devices of the present disclosure may implement identity evolution. Identity evolution captures how the knower changes as knowing becomes embodied.

Embodiment concerns not just what an individual or entity knows, but what or who it becomes, establishing identity as an outcome of practice and perception.

The process is transformative, not merely informational, shifting dispositions, preferences, and affordances.

The systems, methods, and devices of the present disclosure may implement measurement instruments assess the durability and scope of embodiment across behavior, identity, and outcomes. Evidence demonstrates system-level efficacy and persistence of embodied knowing.

In an example embodiment, an individual after a year of using the systems, methods, and devices of the present disclosure indicates complete identity transformation, evidencing deep integration of values and capabilities.

The systems, methods, and devices of the present disclosure may implement Living Intelligence Networks (LINs)

Resilience arises from LINs because there is no single point of failure; functionality persists despite local disruptions. Scalability follows from the ability to add nodes without central coordination, allowing capacity and capability to increase organically. Emergence is a consequence of intelligence arising from relationships rather than centralized processing, with patterns and capabilities forming through interactions among nodes. Democracy is expressed by the absence of privileged nodes, so influence is earned through relational contributions rather than authority. The systems, methods, and devices of the present disclosure may implement distributed attention allocation in which attention is distributed, not centralized; distributed governance that is polycentric rather than hierarchical; and sympoietic governance under which networks collectively produce outcomes.

The systems, methods, and devices of the present disclosure may implement intelligence relationships between frames. Intelligence is not a property of individual agents but emerges from relationships between frames, with meaning and capability formed at the intersections and dynamics of those relationships. Examples and technical implementations instantiate these relationships in practice by operationalizing how frames connect, synchronize, and co-infer across contexts and time.

The systems, methods, and devices of the present disclosure may implement attention networks in which relationships create attention patterns that shape inference; multi-agent attention coordination, enabling coordination through relationships; and emergence detection that identifies intelligence emerging from relational dynamics.

The systems, methods, and devices of the present disclosure may implement a distributed multi-agent architecture that integrates human, machine, and biological agents.

Three agent types may work together. Human agents contribute lived experience and community knowledge, bring emotional intelligence and intuition, and shape values formation and ethical judgment; for example, an individual's diabetes management journey illustrates human-led framing and value alignment. Machine agents (AI) provide pattern recognition at scale, perform data processing and optimization, and learn from interactions; for example, AI learning yields a 2.3× outcome improvement derived from the individual's success. Biological agents contribute environmental sensing and ecological intelligence, perform natural pattern recognition, and exhibit ecosystem-level behavior; for example, plants, animals, and ecosystems participate through sensors to inform system state. Multi-agent coordination integrates these contributions in applied settings; for example, in a healthcare decision, human values and goals align with AI optimization and biological signals to produce context-appropriate action.

The systems, methods, and devices of the present disclosure may implement five ecosystems, with the agent ecosystem including all three types. For example, the ecosystems include multi-agent attention coordination and sympoietic governance under which agents collectively produce.

Living networks may evolve, grow, reproduce, and perform other functions of organic life.

Living Intelligence Networks are not static; they have lifecycles akin to living systems. Network lifecycle phases include evolve, as frames and relations reconfigure in response to learning and feedback; grow, as nodes and connections accrete to expand capability; adapt, as attention and practices shift to meet changing conditions; die, or reach completion, when purposes conclude and structures are responsibly retired; and regenerate, as resources and knowledge are recycled to seed new formations. Technical implementations support lifecycle transitions by instrumenting state, criteria, and processes for change, sunset, and renewal.

The systems, methods, and devices of the present disclosure may implement living module evolution so that networks operate as living modules; establish regenerative governance by which networks regenerate themselves and their ecosystems; manage frame lifecycles that enable network lifecycles; and support values evolution through experience so that networks evolve as values evolve.

LLMs and Living Contextual Models (LCMs) may implement Living Intelligence Networks.

The Evolution of Intelligence proceeds through three stages: Stage 1 involves LLMs (Large Language Models) that generate and generalize patterns from corpora; Stage 2 involves LCMs (Living Contextual Models) that maintain and act within situated, evolving contexts; and Stage 3 involves Living Intelligence Networks in which distributed, multi-agent, value-aligned networks produce intelligence through relationships. This evolution matters because capabilities move from static pattern generation to contextual, relational, and regenerative intelligence with higher robustness, alignment, and impact.

The systems, methods, and devices of the present disclosure may implement attention network formation so that networks form naturally; provide emergence detection such that intelligence emerges from networks; establish sympoietic governance so networks collectively produce intelligence; and define temporal attention evolution so networks evolve their attention over time.

### Bias Characteristic Shaping

Bias may be treated as intentional design material, not an error to eliminate. The approach is proactive shaping rather than reactive detection or mitigation, community-controlled rather than platform-controlled, and tuned to ecosystem-specific patterns.

Bias may be used as a design material.

Traditional bias handling follows a detect-then-mitigate paradigm. Examples of prior art include fairness constraints in ML models that detect then constrain outputs, debiasing algorithms that detect then remove targeted patterns, bias audits that detect then report issues, and fairness toolkits that detect then mitigate. This approach fails because bias cannot be eliminated—it's fundamental to learning systems. One community's bias is another's preference, yet platform-controlled regimes deny communities a voice. A reactive posture means always catching up, never leading, and universal definitions imposed from above ignore community values and context.

A bias characteristic shaping reframes the design problem from removal to intentional configuration. The key insight is that bias is not an error but an inevitable characteristic of any intelligent system. The question is not “how do we eliminate bias?” but “what bias characteristics do we want to shape?” Just as an architect shapes materials like wood, steel, and concrete to create buildings, communities can shape bias characteristics to create systems that serve their values.

In one example configuration of the present disclosure, a hiring system is implemented.

Reactive bias mitigation attempts to detect and constrain after the fact, auditing and patching outcomes without community-led design. According to the present disclosure, proactive bias shaping encodes desired bias characteristics up front, aligning selection frames, signals, and thresholds with community values and context. This works because the community gets what it wants rather than what a platform deems “fair”; the posture is proactive—designed in, not caught later; the shaped bias is transparent, known, and documented; the configuration is contextual so different communities can choose different characteristics; and the goals are achievable because shaping is easier and more reliable than eliminating.

Ecosystem-Specific bias patterns may also be used.

Different ecosystems need different bias characteristics. For example, a privacy bias illustrates how preferences vary across contexts yet can be coherently shaped. In the hardware ecosystem, edge devices bias toward local processing for privacy, cloud servers bias toward encryption for privacy in transit and at rest, and quantum systems bias toward quantum-resistant algorithms to safeguard future privacy. In the software ecosystem, open source biases toward transparency—privacy through visibility and scrutiny—while proprietary systems bias toward rigorous security audits—privacy through validation and attestations. In the agent ecosystem, humans bias toward explicit consent—privacy through choice; AI systems bias toward differential privacy—privacy through algorithms; and biological agents bias toward local sensing only—privacy through limitation. In the community ecosystem, privacy-focused groups bias toward maximum control—privacy through sovereignty—whereas transparency-focused groups bias toward disclosure—privacy through openness. In the economic ecosystem, free users bias toward limited data collection—privacy through constraint—while paid users bias toward premium privacy features—privacy through payment. The present disclosure enables shaping different bias patterns for each ecosystem simultaneously.

The systems, methods, and devices of the present disclosure include various tools. For example, a scanner and a sculptor tool may be defined.

The scanner tool may reveal existing bias patterns.

The scanner may make existing bias visible so it can be shaped. The Scanner operates at three levels—data, model, and system—so that bias can be observed at its sources, within learned representations, and across end-to-end behaviors.

The Scanner interprets inputs, learned parameters, and decision pathways to surface patterns of bias at each level and prepare them for intentional shaping rather than after-the-fact mitigation.

The Scanner can analyze through multiple community lenses so findings are contextualized rather than universalized. Under the Corpus Lens, the focus is on data representation, quantitative patterns, and statistical bias analysis. Under the Methodical Lens, the focus is on procedural bias, algorithmic fairness, and technical pattern analysis. Under the Stories Lens, the focus is on narrative impact, qualitative bias, and individual experience analysis. Under the Culture Lens, the focus is on community values alignment, cultural appropriateness, and intersectional bias analysis.

The Scanner may show multiple AI models side-by-side, enabling cross-model comparison of bias characteristics and attention patterns within a shared receptive field.

The Scanner may be controlled via voice so communities can articulate values and direct analysis in natural language, binding observed bias to declared priorities.

The Sculptor tool may enables intentional bias shaping.

The Sculptor may shape bias characteristics to match community values. The Sculptor operates at the same three levels. Data Level Shaping configures datasets, sampling, and representations to reflect community priorities. Model Level Shaping tunes objectives, constraints, and training dynamics to express desired bias characteristics. System Level Shaping adjusts workflows, thresholds, and governance interfaces so end-to-end behavior aligns with community values.

The Sculptor applies parameterization, policy configuration, and runtime controls that encode selected bias characteristics, making them explicit, testable, and auditable.

Scanner and Sculptor work together bidirectionally; findings from the Scanner guide Sculptor configurations, and Sculptor's changes are re-scanned to verify that shaped characteristics match community intent.

The systems, methods, and devices of the present disclosure may implement a community control mechanism that allows for the communities to be kept in the loop of the design process at all stages.

Community controls bias shaping at every stage, not just validation at the end. In prior art (platform-controlled), definitions, metrics, and interventions are imposed centrally and reviewed post hoc. According to the present disclosure (community-controlled), communities specify values, consent frames, and economic terms up front, co-govern shaping decisions throughout, and validate outcomes before, during, and after deployment.

The systems, methods, and devices of the present disclosure may implement the democratic validation of bias patterns.

Validation mechanisms include Community Frame Validation (Claim C2), in which proposed bias characteristics must satisfy community-defined frames; Multi-Stakeholder Validation, which incorporates perspectives from affected parties to prevent capture; and Graduated Validation Thresholds, which increase scrutiny as impact or risk grows to ensure proportional oversight.

The systems, methods, and devices of the present disclosure may implement a community design process that allows for community sovereignty over design.

Communities have final say over bias characteristics in their systems. Sovereignty mechanisms include Frame-Based Consent, ensuring participation and data use occur under explicit, revocable frames; Economic Sovereignty, aligning monetary flows with community decisions; Values Sovereignty, preserving local definitions of fairness and preference; and Governance Sovereignty, establishing community-led decision rights over configuration and change.

The systems, methods, and devices of the present disclosure may implement a community design process that allows for a community-determined revenue share.

The community decides revenue distribution, not the platform. Revenue sharing models include Contributor-Focused (default), prioritizing those who create data, models, and governance work; Commons-Focused, channeling proceeds to shared infrastructure and public goods; Balanced, combining contributor rewards with commons investment; and Custom, enabling communities to define bespoke allocations. Under Economic Transparency, all revenue flows are completely visible so stakeholders can audit sources, allocations, and outcomes.

Aspects of the present disclosure concern bidirectional signatures. Bidirectional signatures are compressed pattern representations that enable both detection (scanning) and transformation (sculpting) simultaneously, with material components-determined real-time performance. It provides dual functionality in a single compressed representation. As an example, the same signature may detect accessibility issues and guide accessibility improvements. In one example, the compression is a 100:1 ratio. The bidirectional signatures can be used to coordinate bias across all ecosystems simultaneously. In one aspect of the present disclosure, the bidirectional signatures may evolve over time as community values evolve.

### Implementation

The systems, devices, and methods of the present disclosure may implement technical mechanisms that enable the architecture described above.

The systems, devices, and methods of the present disclosure may implement a Material Components-Determined Architecture. Material components—frames, embodied knowledge units, bias characteristics, living signatures, living patterns, data, and values, individually or in combination—determine system decisions including, but not limited to, model selection and deployment; resource allocation across computational dimensions; optimization weight distribution; performance threshold requirements; augmentation frequency and scope; security and privacy policies; efficiency trade-off resolution; and timing strategies. The architecture allows one or more material components to dynamically determine optimal system behavior based on context, values, and community preferences. For example, a privacy frame alone may set community alignment weight to 0.5 and require a greater than 90% threshold, while an accuracy frame may set hardware efficiency weight to 0.4 and require a greater than 85% threshold; when multiple material components combine, they collectively determine the complete weight distribution and all threshold requirements.

The systems, methods, and devices disclosed herein may implement living patterns.

Living patterns are abstract, reusable solutions that generate new components and evolve through use. These solutions operate as higher-level patterns that can be applied across contexts, repeatedly instantiated, and refined through feedback and deployment.

Living patterns are abstract, capturing the essential structure of a solution independent of any single instance. They are reusable, enabling efficient application across multiple domains and problems. They are generative, producing new components, frames, and signatures when applied. They are evolving, changing in response to observed performance and community input over time.

Bidirectional components may be used by the systems, methods, and devices disclosed herein.

All components both generate and are generated by each other. Frames shape EKUs, which in turn produce living signatures; bias characteristics influence model behavior and are themselves updated by signature feedback; values guide system configurations and are refined by lived outcomes.

Bidrectional relationships may be established between components. Data informs models, and model outputs produce new data signatures; frames configure attention, and attention patterns surface new frame candidates; consent constraints shape data use, and usage outcomes update consent frames. At the architectural level, decisions propagate upward and downward—material components determine system behavior, and system behavior iteratively reshapes material components.

Four calls may be used by the systems, methods, and devices disclosed herein.

Four types of calls engage the community in co-creation, inviting contributions of data, frameworks, compressed patterns, and comprehensive capabilities, each with aligned compensation and governance.

Data calls may request data and generate frames.

Data calls may explicitly request data from the community and generate frames and signatures from discovered patterns. Data calls specify needs, provenance requirements, and consent frames; submitted data is validated, transformed into living signatures, and used to propose or refine frames. They may use structured submission pipelines, automated quality checks, and signature extraction link contributions to downstream use.

Frame calls request frameworks and implement collaborative creation.

Frame calls can request collaborative creation of frameworks, lenses, and interpretive structures. Communities may propose, debate, and iterate frames that guide attention and decision criteria. For example, example frame calls may specify scope, values, and evaluation thresholds. Frame calls may be implemented using versioned frame repositories, voting and validation workflows, and runtime binding of frames to operations.

Signature calls may request and validate compressed patterns.

Signature calls may request creation or validation of living signatures for bias patterns. Contributors may submit or test compressed representations against known thresholds; validated signatures become fast-check assets for real-time operations and audits.

Model calls implement comprehensive partnerships between the other calls and components of the systems, devices, and methods disclosed herein.

Model calls may establish comprehensive partnerships for complete architecture development. Model calls implement end-to-end collaborations integrate data, frames, signatures, and deployment agreements, aligning incentives, consent, and performance objectives.

The systems, methods, and devices of the present disclosure may implement governance and economy systems. The governance and economy systems include various value systems.

A sympoietic governance model may be used. In some example embodiments, it is a primary model used by the system.

Governance privileges collectively produce networks, distribute authority across communities, and embed iterative validation and regeneration cycles.

A Token Economy model may be used.

Multiple Compensation Forms support diverse contribution types, with Community-Determined Revenue Share (Claim E1) governing allocation. A default allocation may be 70% to contributors and 30% to the platform; this split is configurable by the community, and all flows are transparent so every transfer is visible and auditable.

A pre-consent data wallet may be established.

Individuals and communities register consent frames before contribution; the wallet enforces permitted uses at submission and runtime. The wallet is implemented using frame-bound tokens, policy checks at ingress and inference, and automatic revocation or escalation when conditions change.

A living consent model may be used.

Consent may be frame-based, not project-by-project, persisting across contexts while remaining adjustable. Traditional consent binds to a single project and requires repeated re-consenting; Living consent binds to frames that describe permissible use, enabling broad but controlled reuse. Frame evolution updates consent automatically, propagating new constraints or allowances to all linked assets.

Various intelligence systems may be implemented by aspects of the present disclosure.

Universal gap detection may be implemented.

Five types of gaps may be instrumented and addressed: Data Gaps, where inputs are missing or underrepresented; Knowledge Gaps, where understanding or models are insufficient; Framework Gaps, where interpretive structures are absent or misaligned; Pattern Gaps, where signals lack reliable signatures; and Capacity Gaps, where attention, governance, or compute is inadequate. Cross-Scale Gap Detection links local to global signals, and Temporal Gap Analysis tracks changes over time.

Values matching may be used by configurations of the present disclosure.

System choices may be optimized to align with declared values under active frames. Value matching may be implemented using value-weighted objectives, attention routing informed by frames, and continuous feedback loops that adjust weights as contexts evolve.

The systems, methods, and devices of the present disclosure may be environmentally-aware.

Environmental awareness includes biological and environmental systems as full participants. Three levels of integration ensure depth and breadth: Environmental Sensing captures real-world signals; Cross-Species Communication enables exchange among human, AI, and biological agents; and Ecological Intelligence elevates decisions to ecosystem-level considerations so outcomes remain sustainable and contextually attuned.

### EXAMPLES

The following example implementations are merely exemplary, and may integrate at least a portion of the example operations outlined above.

A hospital kiosk/market access system is given.

A system for notifying users of data contribution opportunities that match their frame-based consent preferences includes ush notifications when matching opportunities arise, frame-based filtering ensures only consented opportunities shown, dynamic valuation display shows potential compensation and multi-modal notification (app, email, SMS, kiosk display).

The system may use retail touchscreens, dedicated collection devices, and a unified consent framework across all sites. Local processing with cloud aggregation may implement the features above.

Frames for the hospital kiosk system include hospital compliance templates, medical technology organization presets, research institution frameworks, industry-specific configurations, community customization of templates, and more.

The system may implement cryptographic separation of data from identity using blockchain technology for provenance verification. Blockchain-based data tracking, cryptographic identity separation, immutable provenance records, material components-determined disclosure, cross-chain compatibility, and other features may be implemented by the systems, methods, and devices of the present disclosure.

The system may allow contributors to choose between anonymous and attributed contributions with frame-based control, an anonymous contribution option, attributed contribution with identity, frame-based attribution rules, dynamic attribution changes, community validation of attribution claims, and other features.

The system may implement a real-time display of potential compensation for data contributions based on current market demand and user frames.

To implement the real-time display, dynamic price calculation, frame-based valuation adjustment, multi-modal compensation display (cash, tokens, attribution, community benefit), material components-determined pricing, market-responsive updates and more may be used.

The systems, devices, and methods of the present disclosure may implement a professional services platform.

An AI ethics assessment service may be implemented. Bias characteristic shaping methodology applied as professional service for AI ethics assessment.

The AI ethics assessment service may be implemented using risk assessment with a Scanner-Sculptor-Community framework, ethics reports for regulatory compliance, bias detection across five ecosystems, community validation of ethical claims, ongoing monitoring and adjustment, and more.

A universal evaluation framework for interventions affecting communities with community sovereignty over assessment criteria may be implemented.

The evaluation framework comprises: a) a community-defined evaluation criteria for any intervention, project, or program affecting said community, wherein communities determine what constitutes success, harm, or meaningful impact; (b) a multi-modal evidence collection process of community-defined impacts (both positive and negative) including but not limited to:
creative portfolios, narrative documentation, observed outcomes, community testimony, harm assessment, benefit distribution analysis, and real-world application measurement; (c) a collaborative review processes integrating feedback from multiple stakeholders including affected community members, families, peers, community leaders, and direct participants; (d) a gap detection integration process identifying community-defined gaps in wellbeing, resources, protection, community preservation, or systems functioning; (e) frame-based assessment filtering wherein community frames (privacy, values, community protocols) determine what gets measured and how; (f) consent-based data governance with participant control over information collection, storage, and sharing; (g) strengths-based indicator systems measuring both community assets growth and harm mitigation rather than external deficit metrics; (h) real-world impact measurement through actual community outcomes rather than artificial proxies or external metrics; (i) signature generation from assessment data enabling pattern recognition across communities while preserving privacy; (j) net impact calculation balancing community-defined benefits against community-defined harms to support informed decision-making; (k) wherein said system serves both community empowerment and external accountability requirements without compromising community sovereignty. Example applications include: artist programs assessment, data center community impact, infrastructure project evaluation, research study assessment, corporate community initiatives, government program evaluation, and other evaluation tasks.

AI-assisted content sculpting may be implemented. Humans may sculpt creative content (video, music, social media, art) using AI as tool with bias characteristic shaping applied.

AI may assists human creativity through bias shaping applied to creative tools. Frame-based content filtering, material components-determined tool behavior, community governance of creative AI, and more may be used by the systems disclosed herein.

Temporal frame language incorporating multiple futures methodologies and diverse time concepts across communities for temporal framing may be implemented.

Futures methodologies include scenario planning, predictive modeling, theory of change, back casting, weak signals, horizon scanning, strategic foresight,

Temporal frame activation may also be used, wherein frames activate based on time conditions, anticipated events, trend detection, planned transitions, and other triggers. Multiple time concepts may be used: linear (Western), cyclical (seasonal/Indigenous), spiral (African), eternal present (Buddhist), Dreamtime (Aboriginal), Kairos (qualitative), and other diverse temporal frameworks from different communities.

Various technical infrastructure systems may be implemented according to the present disclosure.

Heterogeneous Computational Deployment may be implemented according to the present disclosure.

For example, a system for deploying across any processing architecture with material components-determined optimization includes CPU, GPU, TPU, NPU deployment; edge computing optimization; cloud processing coordination; material components-determined architecture selection; heterogeneous resource orchestration, and other components.

A Universal Pattern Shaper System may be implemented.

For example, a system for shaping signatures and patterns to adapt to ANY format or pipeline while preserving semantic meaning includes signature format adaptation; pattern shaping for different pipelines; semantic preservation during adaptation; material components-determined shaping rules; and cross-platform pattern compatibility.

A Cross-Domain Deployment Protocol may be implemented.

For example, a standardized protocol including rules and standards for deploying across all domains with material components-determined behavior includes domain-agnostic deployment rules; standardized communication protocols; material components-determined domain adaptation; and cross-domain coordination mechanisms

A Material Components-Determined Federated Learning System may be implemented. For example, on-device optimization with cloud augmentation and bidirectional learning of frames, signatures, and models for maximum efficiency can be implemented. The system comprises (a) on-device capability detection identifying computational resources, memory constraints, network availability, power limitations, and current device load; (b) material components-determined model selection wherein one or more material components that determine system decisions including but not limited to: model size and complexity selection, deployment location (edge, cloud, hybrid), resource allocation across computational dimensions, and efficiency trade-off resolution; (c) efficiency-optimized deployment wherein system maximizes device efficiency by selecting minimal viable model that satisfies material components requirements rather than maximal possible model; (d) cloud-based model augmentation wherein cloud infrastructure augments (not replaces) on-device models with additional intelligence when connectivity permits, subject to material components-based permission; (e) upstream learning transmission wherein on-device models send learned signatures, trained frames, and model improvements back to cloud for collective learning across device network; (f) federated learning of frames, signatures, and models wherein cloud aggregates upstream data from multiple devices to improve global system while preserving individual device privacy through material components-based filtering; (g) community-driven model shaping wherein cloud applies community-defined bias characteristics to augment local model behavior without requiring full model replacement; (h) graceful degradation ensuring system functionality even when cloud augmentation unavailable, with automatic detection and adaptation to network state changes; (i) continuous efficiency optimization monitoring device resource usage and adjusting model deployment to maintain optimal performance across battery, memory, compute, and network dimensions, all determined by material components requirements without hardcoded thresholds; (j) wherein ALL system decisions including but not limited to deployment strategies, model augmentation, upstream sharing policies, efficiency trade-offs, resource allocation, security policies, performance thresholds, and optimization weights are determined by one or more material components (frames, EKUs, bias characteristics, signatures, patterns, data, values, individually or in combination) and wherein on-device models are continuously shaped and augmented by cloud intelligence while maintaining local autonomy and maximizing device efficiency.

A Living Pattern Multi-Modal Rendering System includes systems for rendering living patterns across all sensory modalities with material components-determined presentation. The system includes multi-modal rendering (Audio FIRST, then Visual, Haptic, Spatial); visual techniques: Tessellation, Transparency, Pointillism, Cubism, Gradient, Particle; material components-determined modality selection; cross-modal pattern consistency; accessible presentation adaptation; and other concepts.

Pattern signature recursivity may allow for patterns and signatures interact recursively with all system components (frames, values, models, data) creating emergent intelligence.

The systems, methods, and devices of the present disclosure may implement recursive interaction between patterns and signatures; pattern-frame interaction creates new patterns; signature-value interaction shapes compression; pattern-model interaction generates variations; and emergent intelligence from recursive relationships.

Model Shaping Pattern Generation includes different AI models shaping patterns differently based on their inherent characteristics, creating model-specific pattern variations.

Model-specific pattern shaping includes each model contributing a unique perspective; pattern diversity from model diversity; material components-determined model selection; and cross-model pattern comparison.

An Object-Responsive Sound Generation System includes a system extending instrumental capacity to any physical object via computer vision and sound training with multi-object orchestration. The system includes computer vision detecting object interactions; sound training learning object acoustics; allowing any physical object to become an instrument. Multi-object orchestration allows for material components-determined sound mapping

For example, the system can train a guitar to make traditional sounds; train a table to produce percussion; train a cup to generate tones

The systems, devices, and methods of the present disclosure may implement a Secure Data Room Architecture.

A secure collaborative computation environment distinct from individual data wallets, enabling multi-party secure analysis with material components-determined access. The environment includes a secure multi-party computation; encrypted collaborative analysis; material components-determined access control; and zero-knowledge proof integration.

Federated Pattern Learning may be implemented. A privacy-preserving distributed learning system using data rooms and wallets together with material components-determined learning rules. The system includes federated learning framework; privacy-preserving aggregation; and material components-determined learning participation

Material Components-Determined Cookie & Browser Storage Management may be implemented.

A system for managing cookies and browser storage with material components-determined retention, sharing, and cross-domain policies includes material components determine cookie lifespan; frame-based cookie permissions; living signatures stored without cookie fragility; cross-domain coordination without third-party tracking cookies; and automatic cleanup based on material components requirements.

Values-Aligned Advertising with Community Revenue Sharing may be implemented.

An advertising system where material components determine ad relevance, presentation, and revenue distribution, with community governance of advertising policies and benefit sharing. The system includes material components that determine which ads are relevant (not surveillance tracking); values frames that check alignment before showing ad (e.g., Climate-Action only sees sustainable products); community governance of ad categories; revenue split; alignment thresholds; default revenue distribution: 40% user, 50% community, 10% platform (material components-determined); frame-based ad permissions (complete opt-out per category).

A Universal Material Components Integration Layer may be implemented.

For example, a system providing integration layer that enables material components (values, patterns, frames) to flow through any combination of tools, AI models, and systems, where the systems and methods disclosed herein act as the universal adapter ensuring value persistence across heterogeneous pipelines.

A Values Policy Builder Tool may be implemented. An Interactive tool for users to define, visualize, and refine their values hierarchy (P/Q/T tiers) which then generates material components (frames, patterns, signatures) for system-wide application includes a user Interface. An exemplary process for using the tool includes the user setting values in Builder; the system generating frames (Privacy frame, Community frame); patterns (Consent-first, Transparency); signatures (Compressed value hierarchy); policies (Automatic rules from P/Q/T tiers); and material components that flow through entire system.

One or more elements or aspects or steps, or any portion(s) thereof, from one or more of any of the claims below can be combined with one or more elements or aspects or steps, or any portion(s) thereof, from one or more of any of the other claims or combinations thereof, to form one or more additional implementations and/or claims of the present disclosure.

While the present disclosure has been described with reference to one or more particular embodiments or implementations, those skilled in the art will recognize that many changes may be made thereto without departing from the spirit and scope of the present disclosure. Each of these implementations and obvious variations thereof is contemplated as falling within the spirit and scope of the present disclosure. It is also contemplated that additional implementations according to aspects of the present disclosure may combine any number of features from any of the implementations described herein.

What is claimed is:

1. A system for ecosystem-aware relational intelligence architecture with hardware-induced bias detection, the system comprising:
a hardware bias detection subsystem executed by one or more processors configured to:
identify, using a bias detection framework, bias characteristics present in an artificial intelligence (AI) model deployed on at least one hardware device;
determine a plurality of hardware components contributing to the identified bias characteristics;
generate a set of hardware-specific compensation strategies to shape the identified bias characteristics;
integrate the set of hardware-specific compensation strategies into a set of hardware-software integrated compensation strategies;
apply the set of hardware-software integrated compensation strategies to the AI model;
store, in an audit log, records of the application of the set of hardware-software integrated compensation strategies;
analyze interactions between software intermediate representations and the plurality of hardware components; and
adapt normalization and regularization techniques based on hardware characteristics of the at least one hardware device;
an ecosystem detection module configured to identify a plurality of ecosystem types, the plurality of ecosystems comprising: a hardware ecosystem, software ecosystem, agent ecosystem including artificial intelligence models, community ecosystem, and economic ecosystem;
an ecosystem discovery protocol configured to:
identify available resources within each of the plurality of ecosystem types;
map relationships between ecosystem boundaries;
detect integration capabilities between each of the plurality of ecosystem types;
maintain a registry that tracks ecosystem resource availability in real-time and updates automatically;
an adaptive assembly framework configured to:
dynamically allocate components across the plurality of ecosystem types based on identified contextual requirements;
assess hardware capabilities of a connected device;
redistribute computational workload in response to the assessed capabilities and contextual requirements; and
implement adaptive module loading based on ecosystem availability and resource constraints;
a cross-ecosystem coordination framework configured to:
synchronize actions of the system across the plurality of ecosystem types;
implement living consent that operates across ecosystem boundaries through frame-based permission management;
a holistic optimization engine configured to:
evaluate performance metrics across each of the plurality of ecosystem types simultaneously;
balance competing constraints from different ecosystem types;
adjust operations of the system based on real-time ecosystem conditions;
and, apply automatic consent enforcement that applies privacy constraints
during cross-ecosystem optimization;
a bias characteristic shaping module configured to:
shape bias characteristics as intentional design material based on community-defined aspirational parameters; and
a multi-modal input processing system configured to:
accept user input via modalities including one or more selected from the group consisting of typing, speaking, drawing, file uploading, and gesturing;
translate inputs from each modality into a unified internal representation; and
apply bias characteristic shaping to each input modality.

2. The system of claim 1, wherein the ecosystem detection module further comprises sensor-specific bias detection configured to identify biases arising from limitations of hardware sensors.

3. The system of claim 1, wherein the adaptive assembly framework comprises a hardware capability assessment module configured to determine processing power, memory capacity, sensor constraints, and power constraints of connected devices.

4. The system of claim 1, wherein the ecosystem discovery protocol maintains a registry that tracks ecosystem resource availability in real-time and updates automatically as resources become available or unavailable.

5. The system of claim 1, wherein the cross-ecosystem coordination framework translates data formats between different ecosystem types to enable communication across ecosystem boundaries.

6. The system of claim 1, wherein the holistic optimization engine implements material components-determined parameters that adapt based on detected ecosystem conditions.

7. The system of claim 1, further comprising a three-tier values hierarchy system comprising: P-tier values representing non-negotiable requirements that system must follow, Q-tier values representing priorities that system should optimize for when possible, and T-tier values representing aspirational goals that system works toward.

8. The system of claim 7, wherein values dynamically change based on community use, changing contexts, and emerging requirements.

9. The system of claim 1, wherein the hardware bias detection subsystem identifies the bias characteristics by analyzing sensor characteristics for limitations.

10. The system of claim 1, wherein the hardware bias detection subsystem identifies the bias characteristics by analyzing computational architecture limitations.

11. The system of claim 1, wherein the hardware bias detection subsystem generates the set of hardware-specific compensation strategies by generating hardware-specific calibration procedures.

12. The system of claim 1, wherein the hardware bias detection subsystem maintains a blockchain-based audit log documenting applications of sets of hardware-software integrated compensation strategies.

13. The system of claim 1, wherein the hardware bias detection subsystem adapts normalization and regularization techniques based on hardware characteristics of the at least one hardware device.

14. The system of claim 1, wherein the hardware bias detection subsystem analyzes an interaction between software intermediate representations and the plurality of hardware components.

15. The system of claim 1, further comprising a frames module configured to work with the hardware bias detection subsystem, wherein the frames module: identifies frames characterizing the AI model, wherein the frames comprise data relating to the AI model and the at least one hardware device and perspective data that specify a perspective; stores the identified frames; and enables the hardware bias detection subsystem to generate the set of hardware-specific compensation strategies based on at least a subset of the identified frames.

16. The system of claim 15, wherein the frames module further modifies at least a portion of the identified frames based on a subset of frames stored in the frames module.

17. The system of claim 1, wherein the hardware bias detection subsystem applies corrective transformations to input data before feeding data into AI models, including color correction, normalization, or preprocessing techniques to neutralize biases introduced by data capture.

18. The system of claim 1, wherein the hardware bias detection subsystem comprises a compensation module configured to calculate corrective transformations for sensor biases based on known characteristics of hardware sensors.

19. The system of claim 1, wherein the hardware bias detection subsystem comprises an architecture adapter configured to calculate adaptation profiles that account for computational architecture limitations of different hardware platforms.

20. The system of claim 1, wherein the hardware bias detection subsystem performs normalization using (i) z-score normalization, (ii) min-max scaling, or (iii) any combination of (i)-(ii) to ensure features are scaled consistently across different hardware platforms.

21. The system of claim 1, wherein the hardware bias detection subsystem applies batch normalization during training.

22. The system of claim 1, wherein the hardware bias detection subsystem adapts normalization to quantized model formats using range-aware batch normalization.

23. The system of claim 1, wherein the hardware bias detection subsystem uses (i) incremental learning, (ii) transfer learning, or (iii) any combination of (i)-(ii) to adjust bias weights or decision thresholds without fully retraining AI models.

24. The system of claim 1, wherein the hardware bias detection subsystem comprises a hardware profile registry maintaining profiles for various hardware environments with known bias characteristics for reference during detection and mitigation operations.

25. The system of claim 26, wherein hardware profiles include similarity measurements that identify hardware similar to other hardware associated with the system to inform generation of corrective transformations for similar biases.

26. The system of claim 1, wherein the hardware bias detection subsystem comprises a bias verification framework configured to verify effectiveness of bias mitigation measures through comparison testing and validation metrics.

27. The system of claim 1, wherein the hardware bias detection subsystem generates test suites that compare known sets of inputs and outputs with observed outputs of AI systems subjected to bias mitigation measures.

28. The system of claim 1, wherein the hardware bias detection subsystem calculates adaptation profiles that account for power consumption requirements, form factors, and environmental operating conditions of different hardware platforms.

29. The system of claim 15, further comprising a distributed frame creation system configured to create frames as material components for bias shaping, wherein said system implements categorization with bounded types including computational perspectives, social perspectives, material perspectives, functional perspectives, and governance perspectives.

30. The system of claim 15, wherein frames have lifecycles comprising creation, activation, evolution, archival, retirement, and resurrection states, wherein frames evolve based on use and experience.

31. The system of claim 15, wherein frame categories emerge through community-driven creation with emergent categorization.

32. The system of claim 15, further comprising a frame shift system configured to detect context changes, and wherein the frame-shift system performs frame shifts that enable dynamic adaptation of bias characteristics to changing contexts.

33. The system of claim 15, wherein frames generate guardrails, wherein said system extracts constraints from frames, implements guardrail enforcement mechanisms, detects conflicts between guardrails, and evolves guardrails as frames evolve with complete audit trail of guardrail decisions.

34. The system of claim 7, wherein values operate at multiple entity levels including individual agent values, organizational values, and community values.

35. The system of claim 7, further comprising a value-frame translation system configured to automatically generate frames from P/Q/T values, wherein P-tier values generate non-negotiable constraint frames, Q-tier values generate optimization priority frames, and T-tier values generate aspirational goal frames for bias shaping.

36. The system of claim 7, further comprising a priority-based conflict resolution system configured to resolve competing bias shaping priorities using P/Q/T hierarchy.

37. The system of claim 7, wherein values enforcement is applied frame-by-frame to bias shaping decisions, wherein said system validates each bias characteristic modification against active P/Q/T values before application, and rejects modifications violating P-tier constraints.

38. The system of claim 7, further comprising a community values validation system configured to enable communities to validate the operations of the system.

39. The system of claim 7, wherein cross-scale value coordination resolves value conflicts between values using priority hierarchies and community governance.

40. The system of claim 7, wherein resource allocation for bias shaping is determined by P/Q/T values, wherein P-tier bias corrections receive priority resource allocation, Q-tier optimizations receive balanced resources, and T-tier aspirations receive available surplus resources.

41. The system of claim 7, wherein performance metrics for bias shaping success are determined by P/Q/T values, wherein P-tier compliance is measured as pass or fail, Q-tier achievement is measured on continuous scales, and T-tier progress is measured directionally.

42. The system of claim 2, wherein the bidirectional bias signature system implements pattern spaces that identify bias patterns across components, define which bias characteristics can be shaped through material components, and encode essential community values for efficient bias shaping operations.

43. The system of claim 1, further comprising an Embodied Knowledge Unit (EKU) system configured to: perform initial quantification by assigning numerical measurements to qualitative inputs, enable community adjustment of the quantified measurements to establish aspirational targets, calculate gaps between identified functional measurements and community-adjusted aspirational targets, and shape system behavior to address the calculated gaps.

44. The system of claim 43, further comprising a gap detection system configured to calculate transformation distances between functional quantifications and community-adjusted aspirational quantifications.

45. The system of claim 43, wherein the system implements progressive bias shaping from functional quantifications toward aspirational quantifications.

46. The system of claim 43, wherein a plurality of EKUs are composed via (i) algebraic combination of quantified values of each of the plurality of EKUs, (ii) semantic integration, (iii) contextual merging, (iv) hierarchical nesting of EKUs that create parent-child relationships between at least two of the plurality of EKUs, (v) knowledge graphs, or (vi) temporal evolution combining historical and current states of each of the plurality of EKUs, or (vii) any combination of (i)-(vi).

47. The system of claim 46, wherein EKU composition further comprises: (i) community-weighted combination according to community-defined importance values, (ii) priority-based combination according to a P/Q/T values hierarchy, (ii) consensus-based combination through democratic community voting processes, (iv) adaptive composition responsive changing environmental conditions, or (v) symbiotic composition between EKUs, or (vi) any combination of (i)-(v).

48. The system of claim 43, wherein EKUs include quantified measurements and community adjustments and wherein EKUs are executed by heterogeneous computational systems.

49. The system of claim 1, wherein the multi-modal input processing system accepts input via text interfaces.

50. The system of claim 1, wherein the multi-modal input processing system accepts input via voice.

51. The system of claim 1, wherein the multi-modal input processing system accepts input via graphical interfaces.

52. The system of claim 1, wherein the multi-modal input processing system accepts input via file transfer interfaces.

53. The system of claim 1, wherein the multi-modal input processing system accepts input via motion tracking interfaces.

54. The system of claim 1, wherein the multi-modal input processing system translates inputs from each of the input modalities into a unified internal representation for consistent processing.

55. The system of claim 1, wherein the multi-modal input processing system applies bias characteristic shaping to each input modality.

56. The system of claim 1, wherein the multi-modal input processing preserves context across each input modality.

57. The system of claim 1, wherein the multi-modal input processing system supports simultaneous input from multiple modalities.

58. The system of claim 1, further comprising inter-module communication configured to enable data exchange and coordination.

59. The system of claim 1, wherein the adaptive assembly framework enables module independence and implements coordinated resource sharing.

60. The system of claim 1, wherein the adaptive assembly framework implements adaptive module loading based on ecosystem resources.

61. The system of claim 1, wherein the cross-ecosystem coordination framework implements frame-based permission management.

62. The system of claim 1, wherein the holistic optimization engine implements automatic consent enforcement that applies privacy constraints during cross-ecosystem optimization.

63. The system of claim 1, wherein the bias characteristic shaping module implements community frame validation.

64. The system of claim 1, wherein aspirational bias parameters for the bias characteristic shaping module are created by communities.

65. A material components-based bias shaping system for artificial intelligence comprising:
a scanner component configured to identify bias characteristics present in an AI system;
a sculptor component configured to shape of bias characteristics based on community-defined aspirational parameters;
a community interface configured to receive community-defined aspirational bias parameters that specify target bias characteristics;
a bias shaping engine configured to: detect changes in contextual conditions; identify affected material components including bias characteristics; determine shift triggers based on the contextual conditions; and shape bias according to the contextual conditions and the determined shift triggers;
a shift orchestration framework configured to manage applied shifts; and
a bidirectional bias signature system.

66. The system of claim 65, wherein the scanner component identifies bias patterns across a plurality of hardware components.

67. The system of claim 65, wherein the sculptor component performs bias shaping based on community-defined aspirational parameters.

68. The system of claim 65, wherein the bias shaping engine classifies bias shaping actions as either a reactive detection of existing bias characteristics or a proactive shaping of intentional bias characteristics.

69. The system of claim 65, wherein the community interface receives community-defined aspirational bias parameters that specify target bias characteristics for specific community contexts.

70. The system of claim 65, wherein the bias shaping engine detects changes in contextual conditions, identifies affected material components including bias characteristics, and determines shift triggers based on the identified material components.

71. The system of claim 65, wherein the dynamic shift mechanism transitions bias characteristics between states in response to contextual changes.

72. The system of claim 65, wherein the shift orchestration framework coordinates shifts across multiple identified material components.

73. A computer-implemented method for ecosystem-aware relational intelligence with material components-based bias shaping, the method comprising:
assessing, by one or more processors, capabilities of at least one hardware device;
defining a project comprising one or more AI models executed by one or more processors of the at least one hardware device;
identifying a plurality of ecosystem types including hardware ecosystems, software ecosystems, agent ecosystems, community ecosystems, and economic ecosystems;
discovering available resources within each of the plurality of ecosystem types;
executing adaptive assembly by dynamically allocating components across the plurality of ecosystem types;
performing holistic optimization across each of the plurality of ecosystem types simultaneously using material components-determined parameters;
identifying, using a bias detection framework, bias characteristics present in the project deployed on the at least one hardware device;
determining a plurality of hardware components contributing to the identified bias characteristics;
shaping bias characteristics based on community-defined aspirational parameters; and
applying bias characteristic shaping.

74. The method of claim 73, further comprising detecting sensor-specific bias by analyzing one or more limitations of hardware sensors.

75. The method of claim 73, wherein discovering ecosystem resources comprises building reference profiles for each detected device based on specifications and metadata.

76. The method of claim 73, wherein executing adaptive assembly comprises redistributing computational workload based on real-time assessment of ecosystem resource availability.

77. The method of claim 73, wherein performing holistic optimization comprises generating expected values and thresholds for data associated with devices and sensors based on reference profiles.

78. The method of claim 73, wherein shaping bias characteristics comprises receiving community-defined aspirational parameters.

79. The method of claim 73, further comprising maintaining a registry that tracks ecosystem resource availability in real-time.

80. The method of claim 73, further comprising translating data formats between each of the plurality of ecosystem types.

81. The method of claim 73, wherein shaping bias characteristics comprises distinguishing between reactive detection of existing bias and proactive shaping of intentional bias characteristics.

82. The method of claim 73, wherein shaping bias characteristics comprises applying calibration procedures to the hardware devices.

83. The method of claim 73, further comprising comparing a measured performance of the hardware devices to baseline or reference measurements.

84. The method of claim 73, wherein shaping bias characteristics comprises applying corrective transformations to input data.

85. The method of claim 73, further comprising calculating corrective transformations for sensor biases based on known characteristics of hardware sensors.

86. The method of claim 73, further comprising calculating adaptation profiles that account for computational architecture limitations of different hardware platforms.

87. The method of claim 73, wherein shaping bias characteristics comprises performing normalization using (i) z-score normalization, (ii) min-max scaling, or (iii) any combination of (i)-(ii).

88. The method of claim 10, wherein shaping bias characteristics comprises applying batch normalization during training.

89. The method of claim 73, wherein shaping bias characteristics comprises adapting normalization to quantized model formats using range-aware batch normalization.

90. The method of claim 73, wherein shaping bias characteristics comprises using incremental learning or transfer learning to adjust bias weights of the one or more AI models.

91. The method of claim 73, further comprising maintaining hardware profiles with known bias characteristics.

92. The method of claim 73, further comprising verifying effectiveness of bias mitigation measures through comparison testing of the one or more AI models.

93. The method of claim 73, further comprising: identifying, by the one or more processors, frames characterizing the project, wherein the frames comprise data relating to the project and the at least one hardware device and perspective data that specify a perspective; storing the identified frames in a frames module; and generating hardware-specific compensation strategies based on at least a subset of the identified frames.

94. The method of claim 93, further comprising modifying at least a portion of the identified frames based on a subset of frames stored in the frames module.

95. The method of claim 73, wherein processing multi-modal input comprises translating inputs from each of the input modalities into a unified internal representation.

96. The method of claim 73, wherein processing multi-modal input comprises applying bias characteristic shaping to each of the input modalities.

97. The method of claim 73, wherein processing multi-modal input comprises preserving of context across inputs from each of the input modalities.

98. A system for hardware-software integrated bias characteristic shaping in artificial intelligence (AI) systems, the system comprising:
storage storing hardware profiles for a plurality of device types;
a memory storing instructions; and
one or more processors configured to execute the instructions and perform operations comprising:
identifying, using a bias detection framework, bias characteristics present in an AI model deployed on at least one hardware device;
determining a plurality of hardware components contributing to the identified bias characteristics;
generating a set of hardware-specific compensation strategies to shape the identified bias characteristics;
integrating the set of hardware-specific compensation strategies into a set of hardware-software integrated compensation strategies;
applying the set of hardware-software integrated compensation strategies to the AI model; and
storing, in an audit log, records of the application of the set of hardware-software integrated compensation strategies.

99. The system of claim 98, wherein identifying the bias characteristics includes analyzing sensor characteristics for limitations.

100. The system of claim 98, wherein identifying the bias characteristics includes analyzing computational architecture limitations.

101. The system of claim 98, wherein generating the set of hardware-specific compensation strategies includes generating hardware-specific calibration procedures.

102. The system of claim 98, wherein the operations further comprise maintaining a blockchain-based audit log documenting applications of sets of hardware-software integrated compensation strategies.

103. The system of claim 98, wherein the operations further comprise adapting normalization and regularization techniques based on hardware characteristics of the at least one hardware device.

104. The system of claim 98, wherein the operations further comprise analyzing an interaction between software intermediate representations and the plurality of hardware components.

105. The system of claim 98, further comprising a frames module, and wherein the operations further comprise:
identifying frames characterizing the AI model, wherein the frames comprise data relating to the AI model and the at least one hardware device and perspective data that specify a perspective;
storing the identified frames in the frames module; and
generating the set of hardware-specific compensation strategies based on at least a subset of the identified frames.

106. The system of claim 105, wherein the operations further comprise:
modifying at least a portion of the identified frames based on a subset of frames stored in the frames module.
